(19) United States
(12) Patent Application Publication
(10) Pub. No.: US 2013/0312012 A1
(43) Pub. Date: Nov. 21, 2013

(54) Updating and Consolidating Events in Computer Systems

(71) Applicants: Michael Bovich, Chandler, AZ (US); Daymion Reynolds, Phoenix, AZ (US); Erskine Thompson, Apache Junction, AZ (US)

(72) Inventors: Michael Bovich, Chandler, AZ (US); Daymion Reynolds, Phoenix, AZ (US); Erskine Thompson, Apache Junction, AZ (US)

(73) Assignee: Go Daddy Operating Company, LLC., Scottsdale, AZ (US)

(21) Appl. No.: 13/474,702

(22) Filed: May 17, 2012

(51) Int. Cl. G06F 9/46

(52) U.S. Cl. 719/318

(57) ABSTRACT

One embodiment of a method of the present invention provides for obtaining from one or more event generators a first event for one or more hosting accounts with a first content and a second event for the one or more hosting accounts with a second content, changing the second content of the second event for the one or more hosting accounts as a function of the first content of the first event for the one or more hosting accounts, and executing the first event and the second event.

### CROSS REFERENCE TO RELATED PATENT APPLICATIONS

This patent application is related to U.S. patent application Ser. No. ______ (Docket 0276) entitled “Event Precedence and Exclusivity in Computer Systems” concurrently filed herewith and also assigned to Go Daddy Operating Company, LLC.

This patent application is related to U.S. patent application Ser. No. ______ (Docket 0277) entitled “Suspending and Terminating Events in Computer Systems” concurrently filed herewith and also assigned to Go Daddy Operating Company, LLC.

This patent application is related to U.S. patent application Ser. No. ______ (Docket 0279) entitled “Grouping and Throttling Events in Computer Systems” concurrently filed herewith and also assigned to Go Daddy Operating Company, LLC.

### FIELD OF THE INVENTION

The present invention relates in general to handling events in computer systems and computer networks.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be more and more valuable. People are increasingly using the Web for everyday tasks such as social networking, shopping, banking, paying bills, and consuming media and entertainment. E-commerce is growing, with businesses delivering more services and content across the Internet, communicating and collaborating online, and inventing new ways to connect with each other.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER, MOZILLA FIREFOX, or GOOGLE CHROME. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

An individual or entity's domain name is increasingly the anchor around which their online presence is maintained. For example, a company's website (www.companyname.com) and email system (john.doe@companyname.com) utilize the company's domain name as an integral part of their architecture. Similarly, many Internet users use their email address, and therefore their domain name, as a means of identification on social websites, which have proliferated in recent years. Social websites are social networking services that focus on building and verifying online social networks for communities of people who share interests and activities, or who are interested in exploring the interests and activities of others, and which necessitates the use of software. Most social websites are Internet based and provide a collection of various ways for users to interact, such as chat, messaging, email, video, voice chat, personal information sharing, image sharing, video sharing, file sharing, status updates, blogging, discussion groups, commentary, etc. The main types of social networking services are those which contain directories of some categories (such as former classmates), means to connect with friends (usually with self-description pages), and/or recommendation systems linked to trust. Popular methods now combine many of these, with FACEBOOK, TWITTER, YOUTUBE, LINKEDIN, MYSPACE, BEBO, PHOTOBUCKET, SNAPFISH, WINDOWS LIVE PHOTOS, WEBSHOTS, and FLICKR being but a few examples.

Such social websites often post their members' public webpages for all Internet users to view, without authentication or login. Conversely, members' private webpages may only be accessed and viewed by the member. The private webpages generally require member authentication and provide the member with tools to manage his public webpage, communicate with other members, and/or otherwise manage his social website membership.

Many social websites, typically those that receive or share sensitive information (as well as websites associated with banks, credit card companies, and online businesses), may require Internet users to login to the website with a secure username and password before accessing the website's content.

The username/password system is a common form of secret authentication data used to control website access. The username/password is kept secret from those not allowed access. Those wishing to gain access are tested on whether or not they have a valid (recognized) username and whether they know the associated password. Internet users are granted or denied access to websites accordingly.

Many social websites have different rules governing the creation of usernames and passwords. Some require passwords that include a complex combination of letters, numbers, and other characters. Others have no restrictions whatsoever. With the proliferation of login-access websites, Internet users often must remember dozens (or more) different username/password combinations, one for each secure website they wish to access. This has resulted in what has come to be known as “password fatigue.”

Partly in response to these issues, the concept of the “digital identity” has evolved. A digital identity is a set of characteristics by which a person or thing is recognizable or distinguished in the digital realm. Digital identity allows for the electronic recognition of an individual or thing without confusing it for someone or something else.

There are many applications for an Internet user's digital identity, including authenticating the user before permitting access to a website. One method for such authentication includes the use of a URL. URL-based digital identity systems (such as OPENID) utilize a framework based on the concept that any individual or entity can identify themselves on the Internet with a URL provided by a Digital Identity Provider (e.g., johndoe.openid.com). The Digital Identity Provider maintains an Identity Server on which a Digital Identity Database (a database of provided digital identity URLs and the corresponding authentication passwords) is stored.

Once obtained, the Internet user may utilize their digital identity URL to access various websites. For example, to login to an OpenID-enabled website, the user enters their OpenID (e.g., johndoe.openid.com) in the username box. The user is then momentarily redirected to the user's Digital Identity Provider's website (or an authentication window appears) to login using whatever password they have set up with their Digital Identity Provider. Once authenticated, the Digital Identity Provider sends the participating website an encrypted message (a token) confirming the identity of the person logging in. There are currently numerous Digital Identity Providers offering URL-based (OpenID) digital identity services, meaning they offer digital identity URLs and servers to authenticate them.

Many computer systems utilize event queues and event handling. In systems with a large amount of events needed to be handled it is important that events handling is done in fast and efficient matter. Applicant hereby proposes novel systems and methods for event handling.

### BRIEF DESCRIPTION OF THE DRAWINGS

FIGS. 1 and 2 are block diagrams illustrating embodiments of a system of the present invention.

FIGS. 3-26 are flowcharts illustrating embodiments of a method of the present invention.

FIGS. 27-40 are flowcharts illustrating Applicant's best mode implementation of the present invention. In the implementation Applicant uses the term “Orion” to refer to the database containing incoming events (an incoming events queue) and the term “Workflow” (WF) to refer an event consumer or executor.

FIGS. 41a-4lhhh represent a copy of Applicant's description of a best mode implementation of the present invention. In the implementation Applicant uses the term “Orion” to refer to the database containing incoming events (an incoming events queue) and the term “Workflow” (WF) to refer an event consumer or executor.

6

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

Event processing is generally queue based. Traditional queues work on a first in/first out (FIFO) method. In the traditional event processing systems if an event A is requested before an event B, then event A executed before event B. If event A fails, then event B will be attempted, regardless of the results of event A. In some cases, a failure of one event will stop the traditional event processing system completely, but generally not in an intelligent manner.

The event handling systems and methods of the present invention apply intelligence to the event processing to allow for customizable optimization. Events become aware of one another and can adjust their behavior based on both preconfigured rules and the current status of the event queue and the environment.

The systems and methods of the present invention may utilize one or more of the following techniques:

Situational Exclusivity: Allows events to run parallel to some events, but not others. Also allows events to become serial or parallel based off of success or failure of prior events.

Out of Order Processing: Event executing order is not tied explicitly to the order the events were requested. The system can reorganize the queue to handle required events first. This can be done at both optimization and at run time.

Execution Blocking (Prevention, Suspension): If certain configurable conditions occur, the system can prevent execution of all or a subset of events that are expected to fail. These will be held until the offending conditions are remedied.

Event Updates: Based on current conditions, events can be modified by the rules engine to reflect the current situation.

Event Termination/Consolidation: The system may support canceling events that do not make sense and/or consolidating similar events. For example, if multiple requests are received to backup a specific database, the rules can be setup to process the first and terminate all other requests as redundant. If three events are received in succession to migrate an account from Server A to B, from B to C, and from C to D, the system can consolidate the events into a single request to migrate from A to D.

Event Segmentation/Multiple Active Queues: The system may support multiple queues based on arbitrary criteria. This allows rules to be processed against related events. In hosting, this grouping may be accomplished by customer accounts. It does not make sense to block events for customer A when an error occurs for customer B. This segmentation can be done on configurable criteria specific to the functional area.

Event Throttling/Batching: The system may regulate flow of events. The large set of events may be “throttled” (i.e., subdivided into smaller sets of events) for optimal use of computer resources and improved performance.

The discussed techniques produce an event management system that is dynamic and responsive to changes in the environment. The system's functionality is configurable though rules.

The systems and methods of the present invention are intended as add-ons to an existing event handling systems and methods. The present invention does not implement event executors; rather it manages event queues. It plugs in to an existing event pipeline and inspects the messages in flow. When it is determined that an event can execute, the request is forwarded on to the event executors. This model provides very little overhead to the existing applications. In general, no changes are required to the event executors (or event consumers).

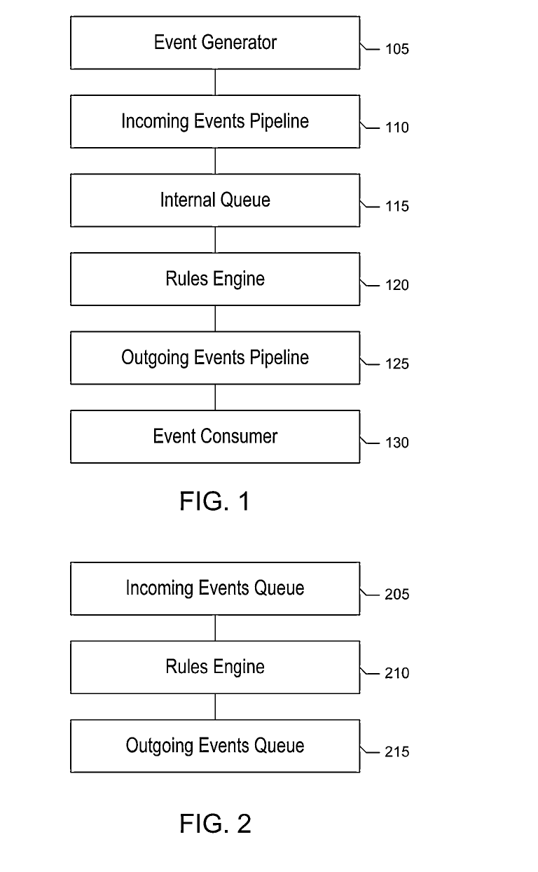

Referring to FIG. 1, the system of the present invention comprises an Event Generator 105. The Event Generator 105 is one or more computing devices, which produce (create, generate) events. The events from the Event Generator 105 are entered into an Incoming Events Pipeline 110, which is typically designed on another computing device. The events from the Incoming Events Pipeline 110 are retrieved into an Internal Queue 115. The events in the Internal Queue 115 are processed by a Rules Engine 120. The Rules Engine 120 inspects the Internal Queue 115, applies the rules, and determines what events will process next. Rules may be applied to the Internal Queue 115 every time new events are retrieved from the Incoming Events Pipeline 110. This allows the system to constantly update and manage events. During each evaluation, events may be updated, repositioned within the queue, postponed, or aborted.

The rules may be configured in a database or in the programming code and may provide both standard processing and extension points. The standard rules may include priority and/or general exclusivity requirements among others. The extension points may allow the rules to be extended to cover more custom and specialized conditions.

If an event is ready for execution, it is placed into an Outgoing Events Pipeline 125, where it is picked up by an Event Consumer (or Executor) 130. In some embodiments the systems and methods of the present invention do not complete the events; they determine whether an event should be executed and when it should be executed. Events are forwarded on to other systems for execution (e.g., Event Consumer 130).

The systems and methods of the present invention may be applied to hosting environment. The hosting environment may include data hosting, website hosting, application hosting, database hosting, email hosting, shared hosting, dedicated hosting, virtual dedicated hosting, virtual hosting, grid hosting, cloud hosting, and other types of hosting.

The events in the hosting environment may include creating a hosting account, removing a hosting account, adding a feature to a hosting account, removing a feature from a hosting account, changing parameters, options, or settings of a hosting account or its features, etc. The feature of a hosting account may include a domain name, a subdomain name, a database, an email address, an SSL certificate, an allocated space, etc.

Referring to FIG. 2, an alternative embodiment of a system of the present invention comprises an Incoming Events Queue 205. The events from the Incoming Events Queue 205 are processed by a Rules Engine 210. If an event is ready for execution, it is placed into an Outgoing Events Queue 215.

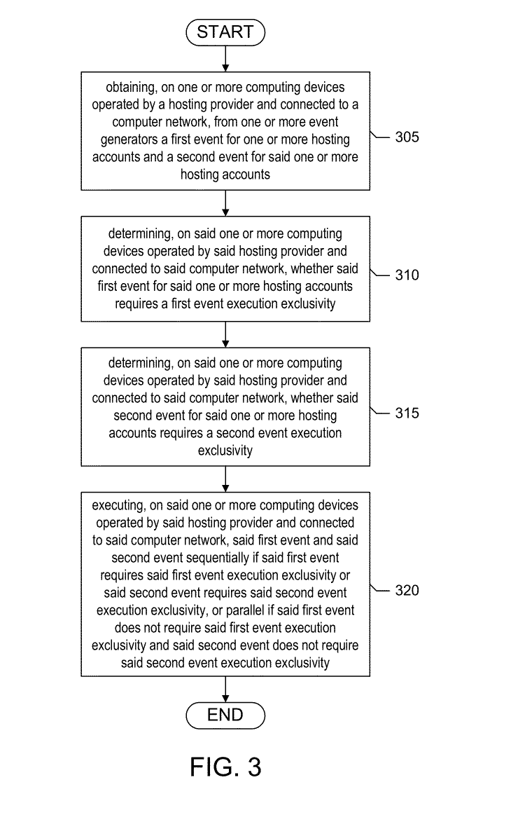

A method for determining event exclusivity for sequential or parallel execution is shown in FIG. 3. The method comprises the steps of: obtaining, on one or more computing devices operated by a hosting provider and connected to a computer network, from one or more event generators a first event for one or more hosting accounts and a second event for the one or more hosting accounts (Step 305), determining, on the one or more computing devices operated by the hosting provider and connected to the computer network, whether the first event for the one or more hosting accounts requires a first event execution exclusivity (Step 310), determining, on the one or more computing devices operated by the hosting provider and connected to the computer network, whether the second event for the one or more hosting accounts requires a second event execution exclusivity (Step 315), and executing, on the one or more computing devices operated by the hosting provider and connected to the computer network, the first event and the second event sequentially if the first event requires the first event execution exclusivity or the second event requires the second event execution exclusivity, or parallel if the first event does not require the first event execution exclusivity and the second event does not require the second event execution exclusivity (Step 320).

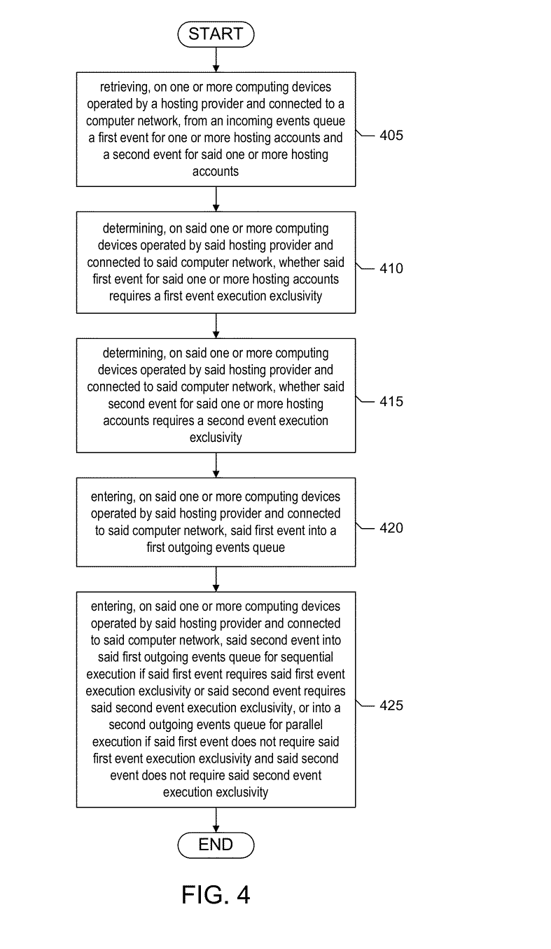

An alternative method for determining event exclusivity for sequential or parallel execution is shown in FIG. 4. The method comprises the steps of: retrieving, on one or more computing devices operated by a hosting provider and connected to a computer network, from an incoming events queue a first event for one or more hosting accounts and a second event for the one or more hosting accounts (Step 405), determining, on the one or more computing devices operated by the hosting provider and connected to the computer network, whether the first event for the one or more hosting accounts requires a first event execution exclusivity (Step 410), determining, on the one or more computing devices operated by the hosting provider and connected to the computer network, whether the second event for the one or more hosting accounts requires a second event execution exclusivity (Step 415), and entering, on the one or more computing devices operated by the hosting provider and connected to the computer network, the first event into a first outgoing events queue (Step 420), and entering, on the one or more computing devices operated by the hosting provider and connected to the computer network, the second event into the first outgoing events queue for sequential execution if the first event requires the first event execution exclusivity or the second event requires the second event execution exclusivity, or into a second outgoing events queue for parallel execution if the first event does not require the first event execution exclusivity and the second event does not require the second event execution exclusivity (Step 425).

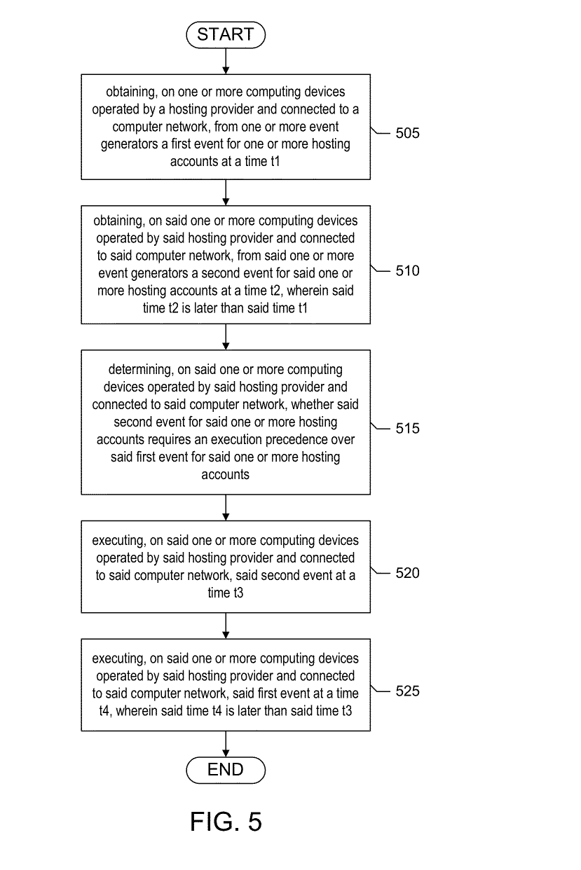

A method for out-of-order event execution is shown in FIG. 5. The method comprises the steps of: obtaining, on one or more computing devices operated by a hosting provider and connected to a computer network, from one or more event generators a first event for one or more hosting accounts at a time t1 (Step 505), obtaining, on the one or more computing devices operated by the hosting provider and connected to the computer network, from the one or more event generators a second event for the one or more hosting accounts at a time t2, wherein the time t2 is later than the time t1 (Step 510), determining, on the one or more computing devices operated by the hosting provider and connected to the computer network, whether the second event for the one or more hosting accounts requires an execution precedence over the first event for the one or more hosting accounts (Step 515), executing, on the one or more computing devices operated by the hosting provider and connected to the computer network, the second event at a time t3 (Step 520), and executing, on the one or more computing devices operated by the hosting provider and connected to the computer network, the first event at a time t4, wherein the time t4 is later than the time t3 (Step 525).

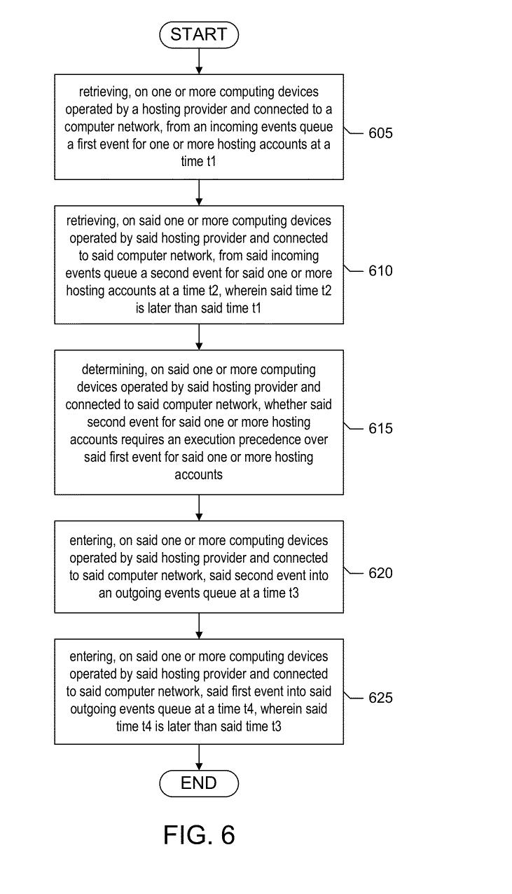

An alternative method for out-of-order event execution is shown in FIG. 6. The method comprises the steps of: retrieving, on one or more computing devices operated by a hosting provider and connected to a computer network, from an incoming events queue a first event for one or more hosting accounts at a time t1 (Step 605), retrieving, on the one or more computing devices operated by the hosting provider and connected to the computer network, from the incoming events queue a second event for the one or more hosting accounts at a time t2, wherein the time t2 is later than the time t1 (Step 610), determining, on the one or more computing devices operated by the hosting provider and connected to the computer network, whether the second event for the one or more hosting accounts requires an execution precedence over the first event for the one or more hosting accounts (Step 615), entering, on the one or more computing devices operated by the hosting provider and connected to the computer network, the second event into an outgoing events queue at a time t3 (Step 620), and entering, on the one or more computing devices operated by the hosting provider and connected to the computer network, the first event into the outgoing events queue at a time t4, wherein the time t4 is later than the time t3 (Step 625).

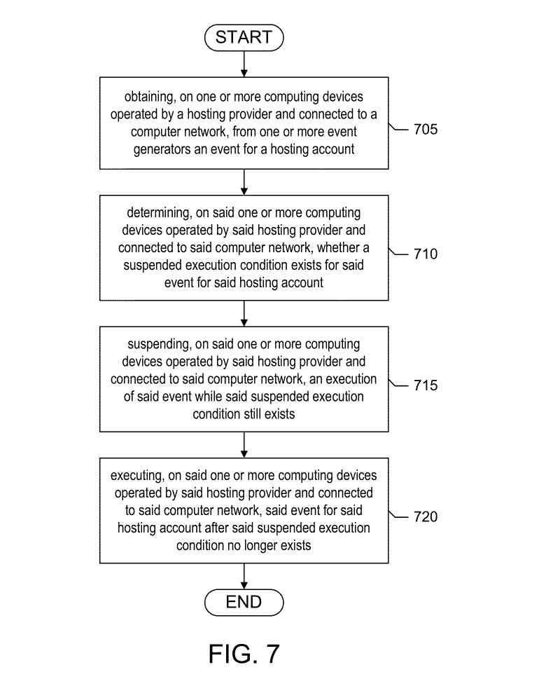

A method for suspending event execution is shown in FIG. 7. The method comprises the steps of: obtaining, on one or more computing devices operated by a hosting provider and connected to a computer network, from one or more event generators an event for a hosting account (Step 705), determining, on the one or more computing devices operated by the hosting provider and connected to the computer network, whether a suspended execution condition exists for the event for the hosting account (Step 710), suspending, on the one or more computing devices operated by the hosting provider and connected to the computer network, an execution of the event while the suspended execution condition still exists (Step 715), and executing, on the one or more computing devices operated by the hosting provider and connected to the computer network, the event for the hosting account after the suspended execution condition no longer exists (Step 720).

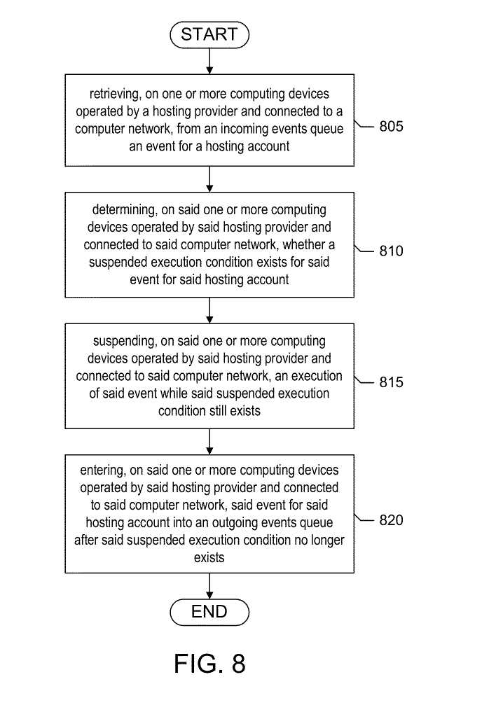

An alternative method for suspending event execution is shown in FIG. 8. The method comprises the steps of: retrieving, on one or more computing devices operated by a hosting provider and connected to a computer network, from an incoming events queue an event for a hosting account (Step 805), determining, on the one or more computing devices operated by the hosting provider and connected to the computer network, whether a suspended execution condition exists for the event for the hosting account (Step 810), suspending, on the one or more computing devices operated by the hosting provider and connected to the computer network, an execution of the event while the suspended execution condition still exists (Step 815), and entering, on the one or more computing devices operated by the hosting provider and connected to the computer network, the event for the hosting account into an outgoing events queue after the suspended execution condition no longer exists (Step 820).

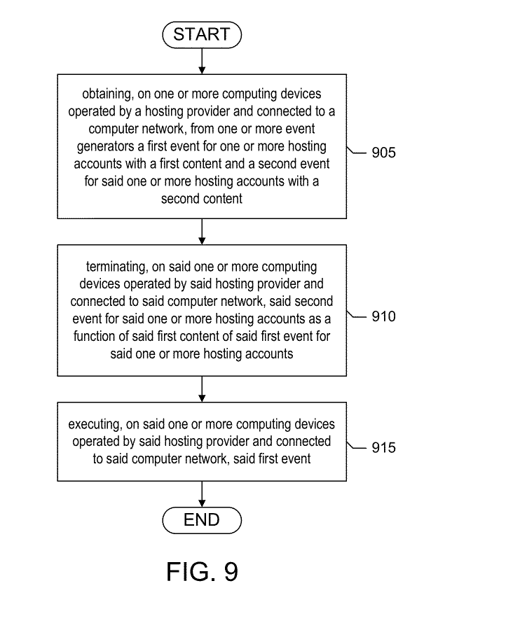

A method for terminating events is shown in FIG. 9. The method comprises the steps of: obtaining, on one or more computing devices operated by a hosting provider and connected to a computer network, from one or more event generators a first event for one or more hosting accounts with a first content and a second event for the one or more hosting accounts with a second content (Step 905), terminating, on the one or more computing devices operated by the hosting provider and connected to the computer network, the second event for the one or more hosting accounts as a function of the first content of the first event for the one or more hosting accounts (Step 910), and executing, on the one or more computing devices operated by the hosting provider and connected to the computer network, the first event (Step 915).

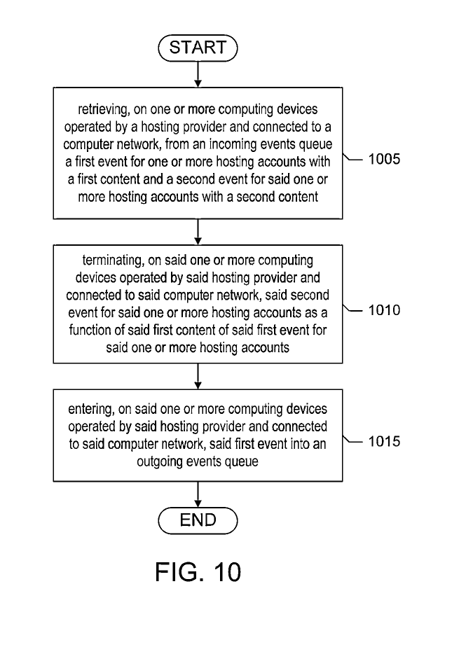

An alternative method for terminating events is shown in FIG. 10. The method comprises the steps of: retrieving, on one or more computing devices operated by a hosting provider and connected to a computer network, from an incoming events queue a first event for one or more hosting accounts with a first content and a second event for the one or more hosting accounts with a second content (Step 1005), terminating, on the one or more computing devices operated by the hosting provider and connected to the computer network, the second event for the one or more hosting accounts as a function of the first content of the first event for the one or more hosting accounts (Step 1010), and entering, on the one or more computing devices operated by the hosting provider and connected to the computer network, the first event into an outgoing events queue (Step 1015).

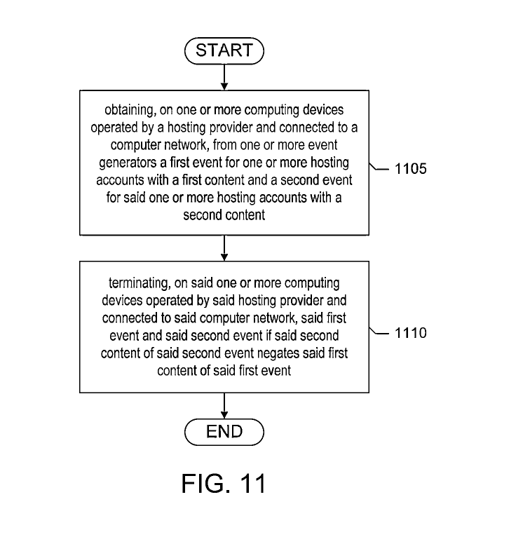

An alternative method for terminating events is shown in FIG. 11. The method comprises the steps of: obtaining, on one or more computing devices operated by a hosting provider and connected to a computer network, from one or more event generators a first event for one or more hosting accounts with a first content and a second event for the one or more hosting accounts with a second content (Step 1105), and terminating, on the one or more computing devices operated by the hosting provider and connected to the computer network, the first event and the second event if the second content of the second event negates the first content of the first event (Step 1110).

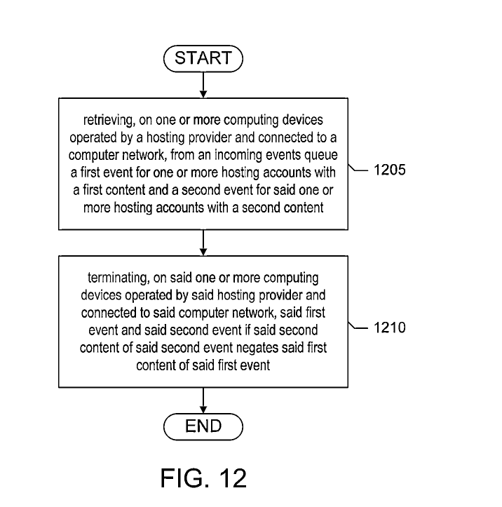

An alternative method for terminating events is shown in FIG. 12. The method comprises the steps of: retrieving, on one or more computing devices operated by a hosting provider and connected to a computer network, from an incoming events queue a first event for one or more hosting accounts with a first content and a second event for the one or more hosting accounts with a second content (Step 1205), and terminating, on the one or more computing devices operated by the hosting provider and connected to the computer network, the first event and the second event if the second content of the second event negates the first content of the first event (Step 1210).

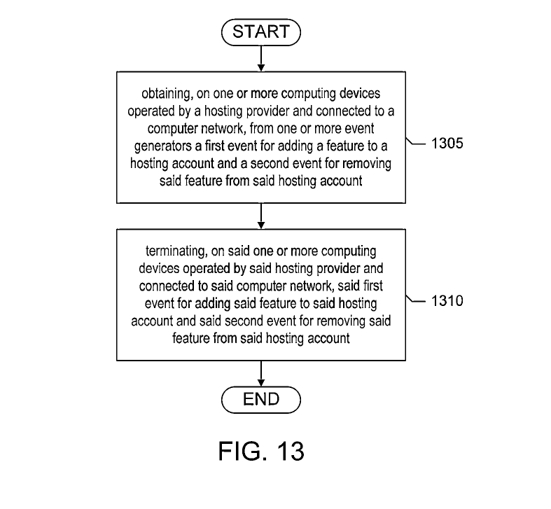

An alternative method for terminating events is shown in FIG. 13. The method comprises the steps of: obtaining, on one or more computing devices operated by a hosting provider and connected to a computer network, from one or more event generators a first event for adding a feature to a hosting account and a second event for removing the feature from the hosting account (Step 1305), and terminating, on the one or more computing devices operated by the hosting provider and connected to the computer network, the first event for adding the feature to the hosting account and the second event for removing the feature from the hosting account (Step 1310).

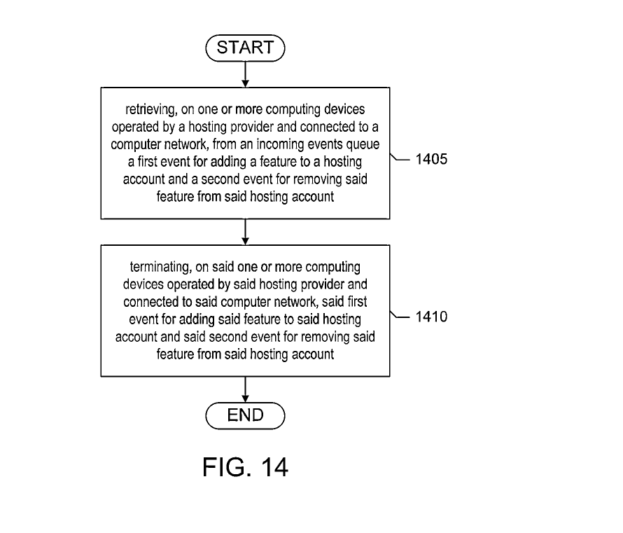

An alternative method for terminating events is shown in FIG. 14. The method comprises the steps of: retrieving, on one or more computing devices operated by a hosting provider and connected to a computer network, from an incoming events queue a first event for adding a feature to a hosting account and a second event for removing the feature from the hosting account (Step 1405), and terminating, on the one or more computing devices operated by the hosting provider and connected to the computer network, the first event for adding the feature to the hosting account and the second event for removing the feature from the hosting account (Step 1410).

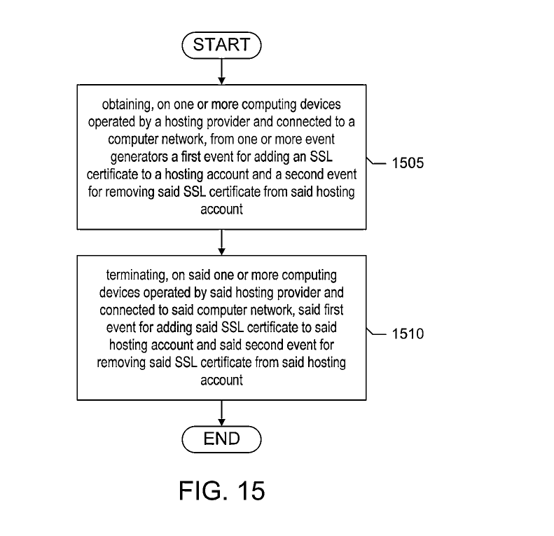

An alternative method for terminating events is shown in FIG. 15. The method comprises the steps of: obtaining, on one or more computing devices operated by a hosting provider and connected to a computer network, from one or more event generators a first event for adding an SSL certificate to a hosting account and a second event for removing the SSL certificate from the hosting account (Step 1505), and terminating, on the one or more computing devices operated by the hosting provider and connected to the computer network, the first event for adding the SSL certificate to the hosting account and the second event for removing the SSL certificate from the hosting account (Step 1510).

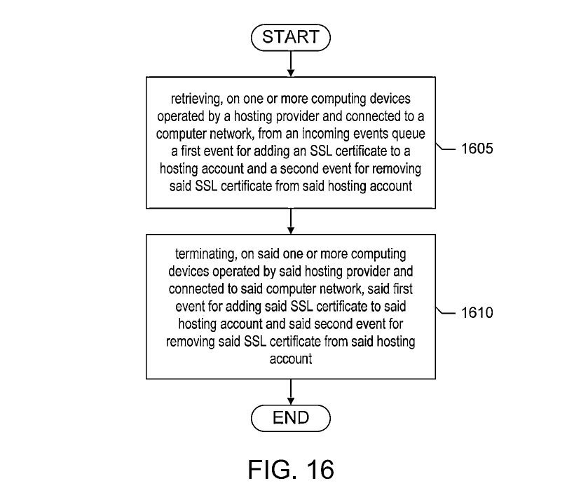

An alternative method for terminating events is shown in FIG. 16. The method comprises the steps of: retrieving, on one or more computing devices operated by a hosting provider and connected to a computer network, from an incoming events queue a first event for adding an SSL certificate to a hosting account and a second event for removing the SSL certificate from the hosting account (Step 1605), and terminating, on the one or more computing devices operated by the hosting provider and connected to the computer network, the first event for adding the SSL certificate to the hosting account and the second event for removing the SSL certificate from the hosting account (Step 1610).

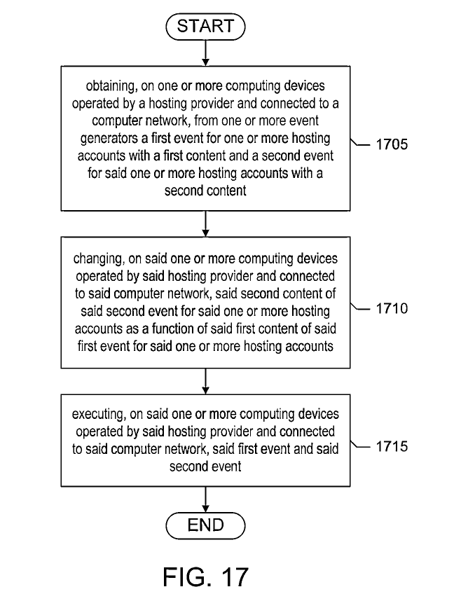

A method for updating events is shown in FIG. 17. The method comprises the steps of: obtaining, on one or more computing devices operated by a hosting provider and connected to a computer network, from one or more event generators a first event for one or more hosting accounts with a first content and a second event for the one or more hosting accounts with a second content (Step 1705), changing, on the one or more computing devices operated by the hosting provider and connected to the computer network, the second content of the second event for the one or more hosting accounts as a function of the first content of the first event for the one or more hosting accounts (Step 1710), and executing, on the one or more computing devices operated by the hosting provider and connected to the computer network, the first event and the second event (Step 1715).

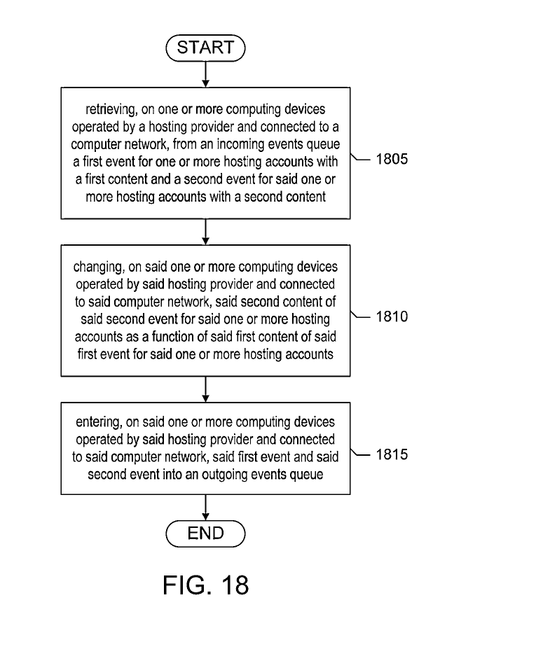

An alternative method for updating events is shown in FIG. 18. The method comprises the steps of: retrieving, on one or more computing devices operated by a hosting provider and connected to a computer network, from an incoming events queue a first event for one or more hosting accounts with a first content and a second event for the one or more hosting accounts with a second content (Step 1805), changing, on the one or more computing devices operated by the hosting provider and connected to the computer network, the second content of the second event for the one or more hosting accounts as a function of the first content of the first event for the one or more hosting accounts (Step 1810), and entering, on the one or more computing devices operated by the hosting provider and connected to the computer network, the first event and the second event into an outgoing events queue (Step 1815).

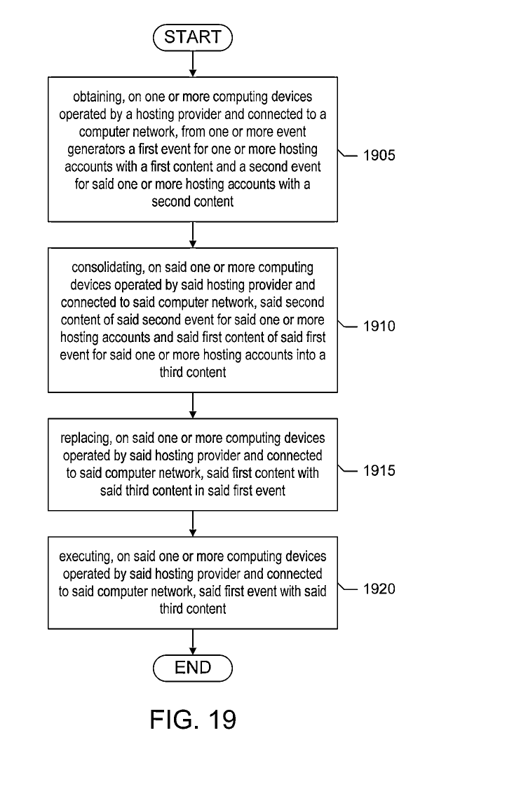

A method for consolidating events is shown in FIG. 19. The method comprises the steps of: obtaining, on one or more computing devices operated by a hosting provider and connected to a computer network, from one or more event generators a first event for one or more hosting accounts with a first content and a second event for the one or more hosting accounts with a second content (Step 1905), consolidating, on the one or more computing devices operated by the hosting provider and connected to the computer network, the second content of the second event for the one or more hosting accounts and the first content of the first event for the one or more hosting accounts into a third content (Step 1910), replacing, on the one or more computing devices operated by the hosting provider and connected to the computer network, the first content with the third content in the first event (Step 1915), and executing, on the one or more computing devices operated by the hosting provider and connected to the computer network, the first event with the third content (Step 1920).

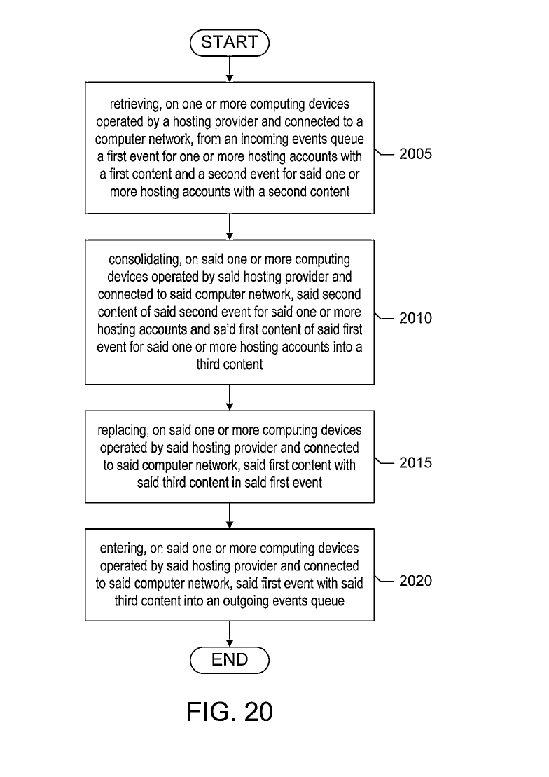

An alternative method for consolidating events is shown in FIG. 20. The method comprises the steps of: retrieving, on one or more computing devices operated by a hosting provider and connected to a computer network, from an incoming events queue a first event for one or more hosting accounts with a first content and a second event for the one or more hosting accounts with a second content (Step 2005), consolidating, on the one or more computing devices operated by the hosting provider and connected to the computer network, the second content of the second event for the one or more hosting accounts and the first content of the first event for the one or more hosting accounts into a third content (Step 2010), replacing, on the one or more computing devices operated by the hosting provider and connected to the computer network, the first content with the third content in the first event (Step 2015), and entering, on the one or more computing devices operated by the hosting provider and connected to the computer network, the first event with the third content into an outgoing events queue (Step 2020).

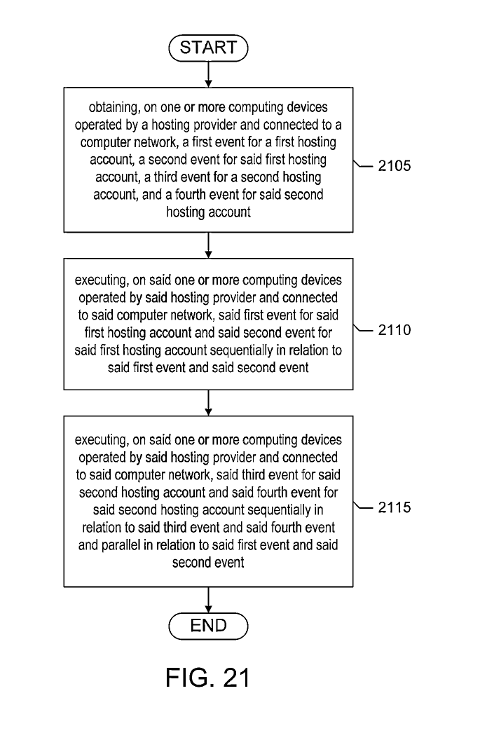

A method for event grouping for parallel execution is shown in FIG. 21. The method comprises the steps of: obtaining, on one or more computing devices operated by a hosting provider and connected to a computer network, a first event for a first hosting account, a second event for the first hosting account, a third event for a second hosting account, and a fourth event for the second hosting account (Step 2105), executing, on the one or more computing devices operated by the hosting provider and connected to the computer network, the first event for the first hosting account and the second event for the first hosting account sequentially in relation to the first event and the second event (Step 2110), and executing, on the one or more computing devices operated by the hosting provider and connected to the computer network, the third event for the second hosting account and the fourth event for the second hosting account sequentially in relation to the third event and the fourth event and parallel in relation to the first event and the second event (Step 2115).

The first and the second events for the first hosting account may be executed sequentially in the order events were obtained.

Similarly, the third and fourth events for the second hosting account are executed sequentially in the order the third event and the fourth event were obtained.

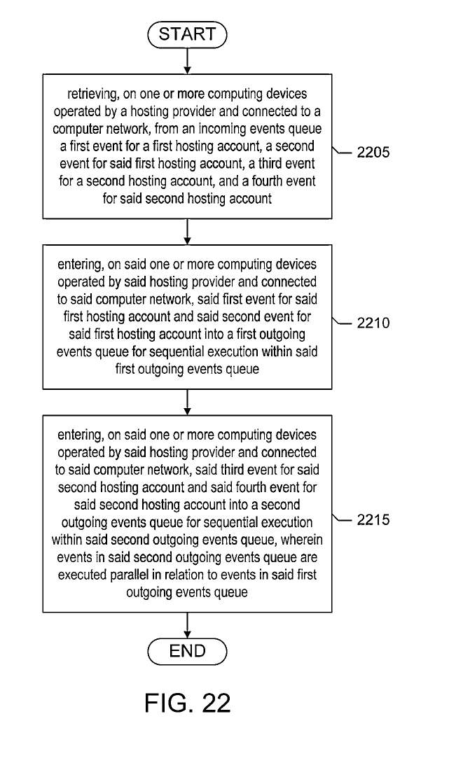

An alternative method for event grouping for parallel execution is shown in FIG. 22. The method comprises the steps of: retrieving, on one or more computing devices operated by a hosting provider and connected to a computer network, from an incoming events queue a first event for a first hosting account, a second event for the first hosting account, a third event for a second hosting account, and a fourth event for the second hosting account (Step 2205), entering, on the one or more computing devices operated by the hosting provider and connected to the computer network, the first event for the first hosting account and the second event for the first hosting account into a first outgoing events queue for sequential execution within the first outgoing events queue (Step 2210), and entering, on the one or more computing devices operated by the hosting provider and connected to the computer network, the third event for the second hosting account and the fourth event for the second hosting account into a second outgoing events queue for sequential execution within the second outgoing events queue, wherein events in the second outgoing events queue are executed parallel in relation to events in the first outgoing events queue (Step 2215).

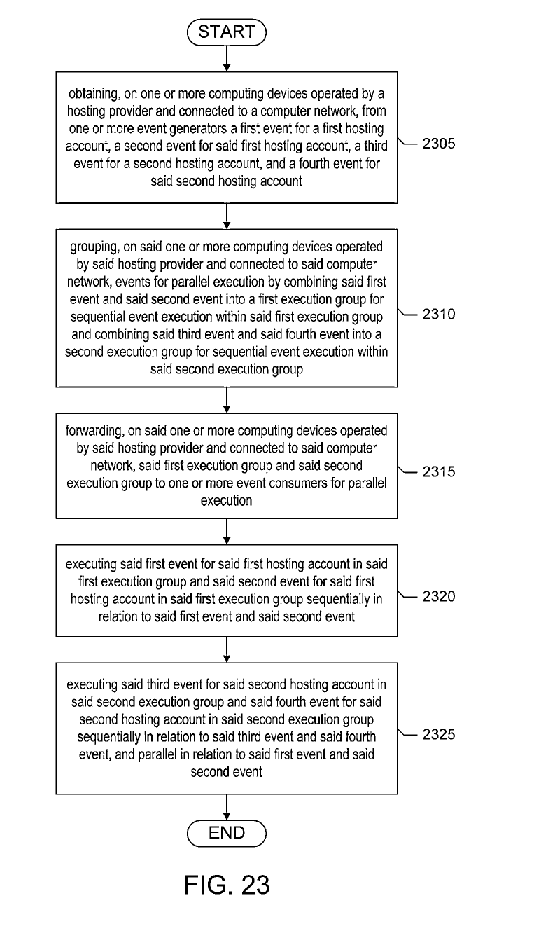

An alternative method for event grouping for parallel execution is shown in FIG. 23. The method comprises the steps of: obtaining, on one or more computing devices operated by a hosting provider and connected to a computer network, from one or more event generators a first event for a first hosting account, a second event for the first hosting account, a third event for a second hosting account, and a fourth event for the second hosting account (Step 2305), grouping, on the one or more computing devices operated by the hosting provider and connected to the computer network, events for parallel execution by combining the first event and the second event into a first execution group for sequential event execution within the first execution group and combining the third event and the fourth event into a second execution group for sequential event execution within the second execution group (Step 2310), and forwarding, on the one or more computing devices operated by the hosting provider and connected to the computer network, the first execution group and the second execution group to one or more event consumers for parallel execution (Step 2315), executing the first event for the first hosting account in the first execution group and the second event for the first hosting account in the first execution group sequentially in relation to the first event and the second event (Step 2320), and executing the third event for the second hosting account in the second execution group and the fourth event for the second hosting account in the second execution group sequentially in relation to the third event and the fourth event, and parallel in relation to the first event and the second event (Step 2325).

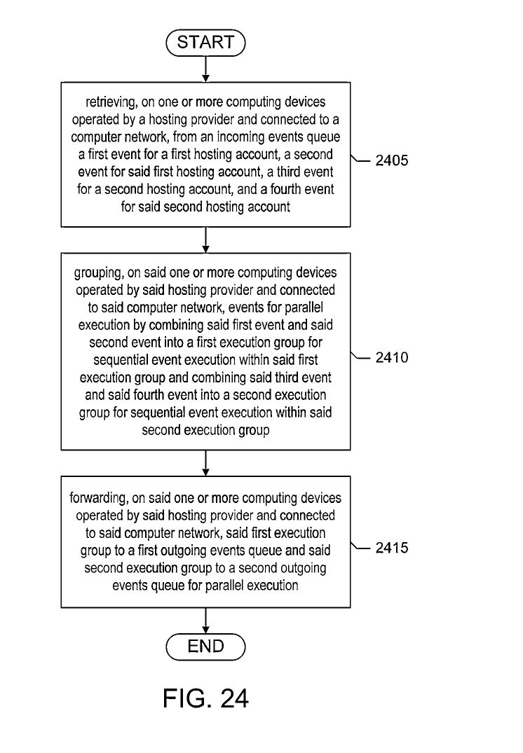

An alternative method for event grouping for parallel execution is shown in FIG. 24. The method comprises the steps of: retrieving, on one or more computing devices operated by a hosting provider and connected to a computer network, from an incoming events queue a first event for a first hosting account, a second event for the first hosting account, a third event for a second hosting account, and a fourth event for the second hosting account (Step 2405), grouping, on the one or more computing devices operated by the hosting provider and connected to the computer network, events for parallel execution by combining the first event and the second event into a first execution group for sequential event execution within the first execution group and combining the third event and the fourth event into a second execution group for sequential event execution within the second execution group (Step 2410), and forwarding, on the one or more computing devices operated by the hosting provider and connected to the computer network, the first execution group to a first outgoing events queue and the second execution group to a second outgoing events queue for parallel execution (Step 2415).

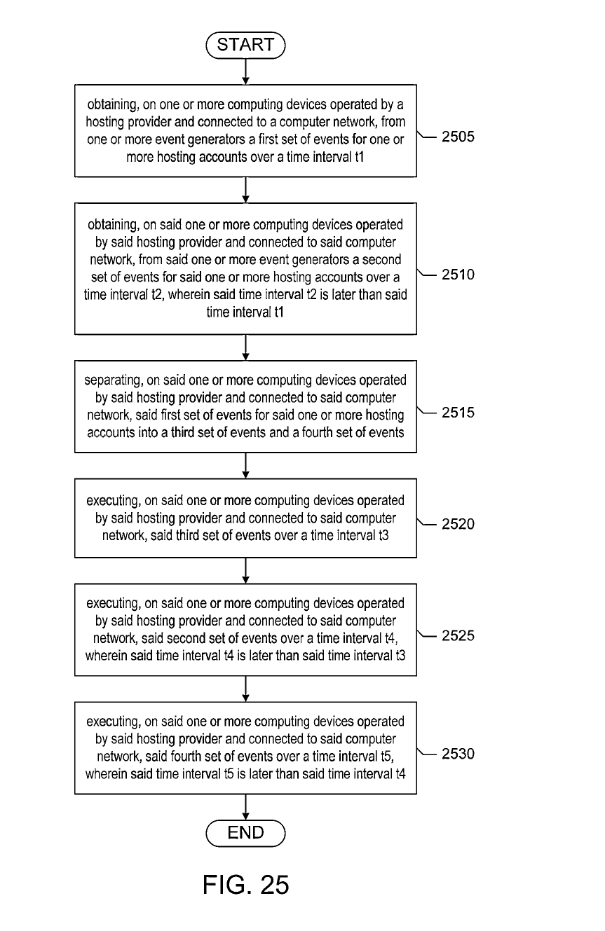

A method for throttling event execution is shown in FIG. 25. The method comprises the steps of: obtaining, on one or more computing devices operated by a hosting provider and connected to a computer network, from one or more event generators a first set of events for one or more hosting accounts over a time interval t1 (Step 2505), obtaining, on the one or more computing devices operated by the hosting provider and connected to the computer network, from the one or more event generators a second set of events for the one or more hosting accounts over a time interval t2, wherein the time interval t2 is later than the time interval t1 (Step 2510), separating, on the one or more computing devices operated by the hosting provider and connected to the computer network, the first set of events for the one or more hosting accounts into a third set of events and a fourth set of events (Step 2515), executing, on the one or more computing devices operated by the hosting provider and connected to the computer network, the third set of events over a time interval t3 (Step 2520), executing, on the one or more computing devices operated by the hosting provider and connected to the computer network, the second set of events over a time interval t4, wherein the time interval t4 is later than the time interval t3 (Step 2525), and executing, on the one or more computing devices operated by the hosting provider and connected to the computer network, the fourth set of events over a time interval t5, wherein the time interval t5 is later than the time interval t4 (Step 2530).

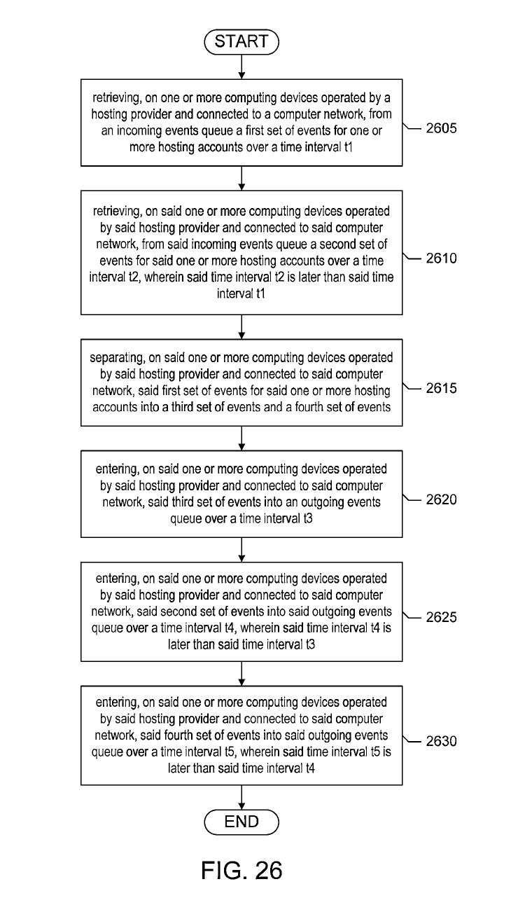

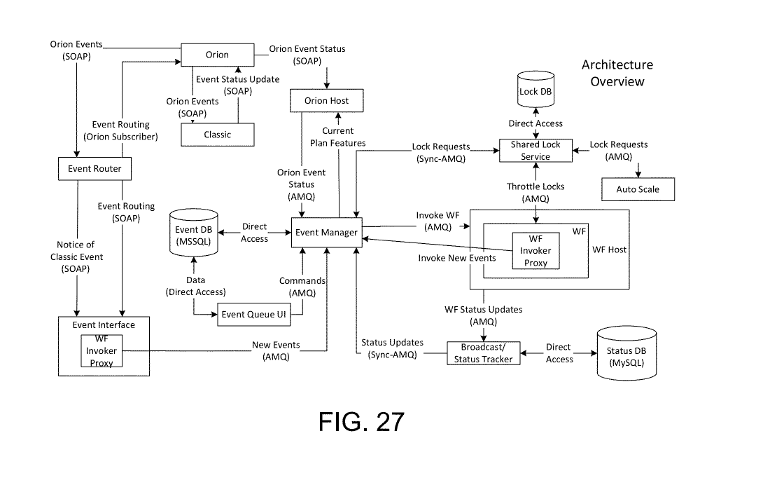

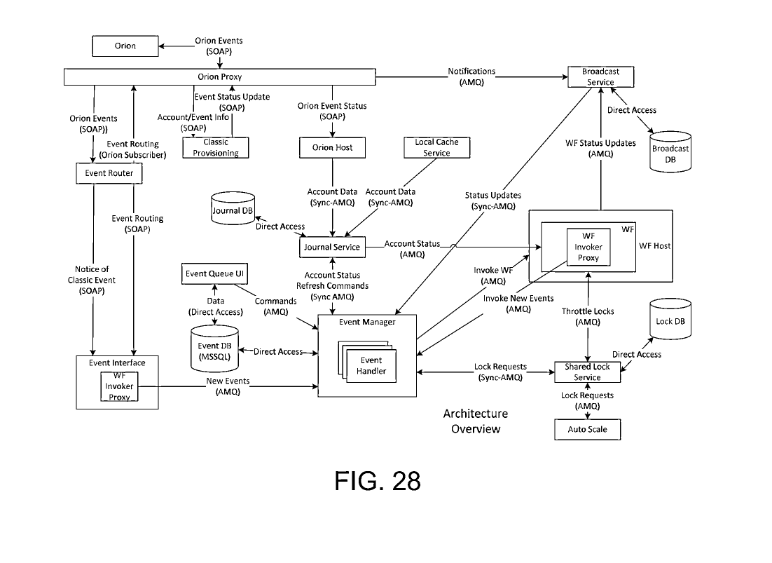

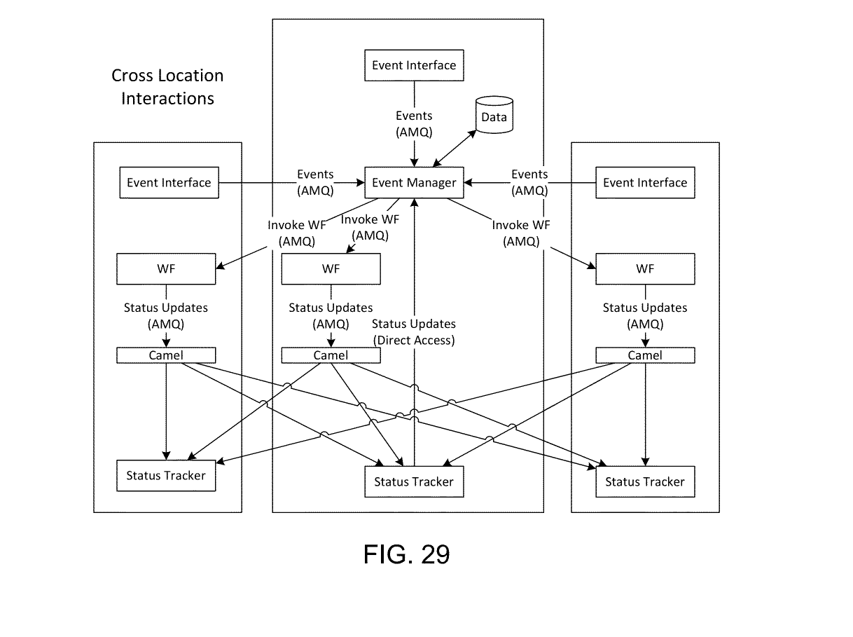

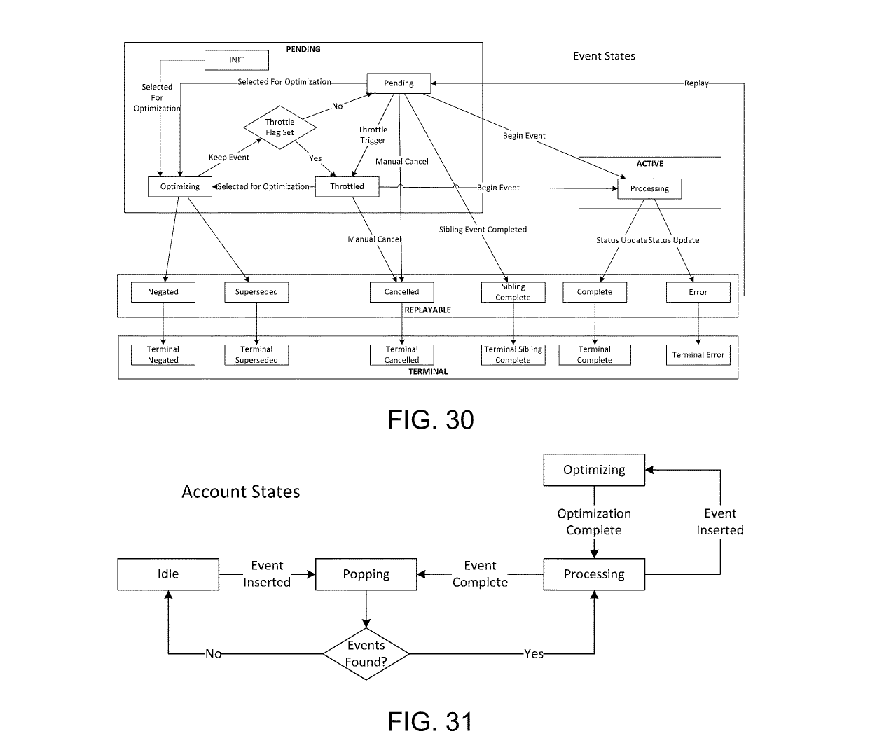

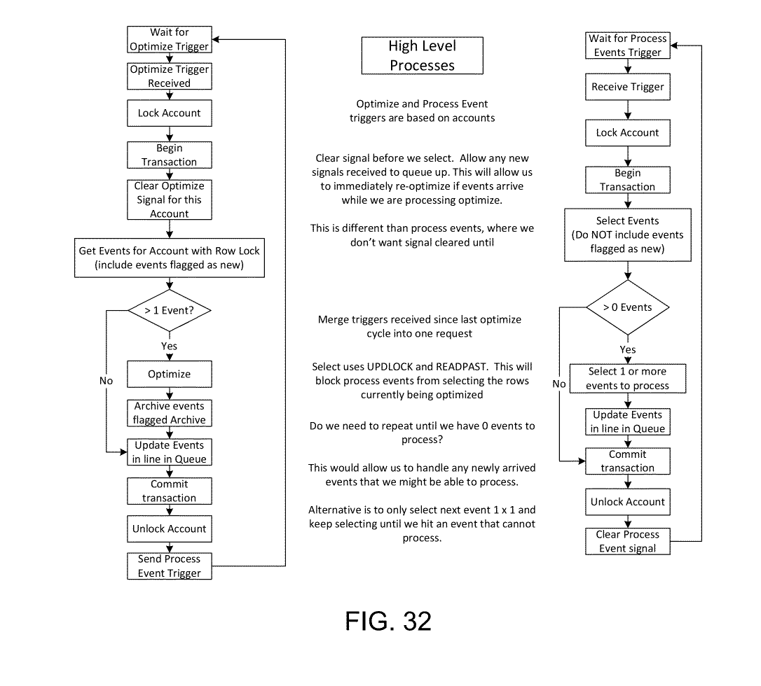

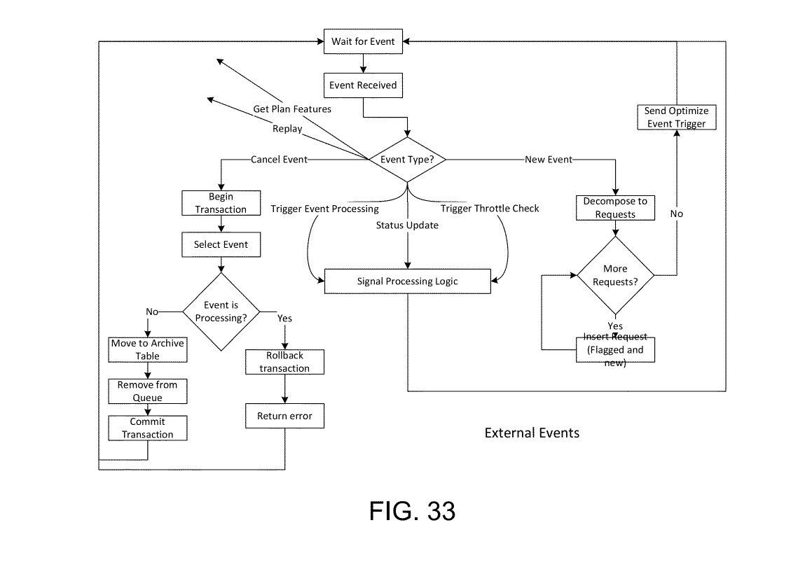

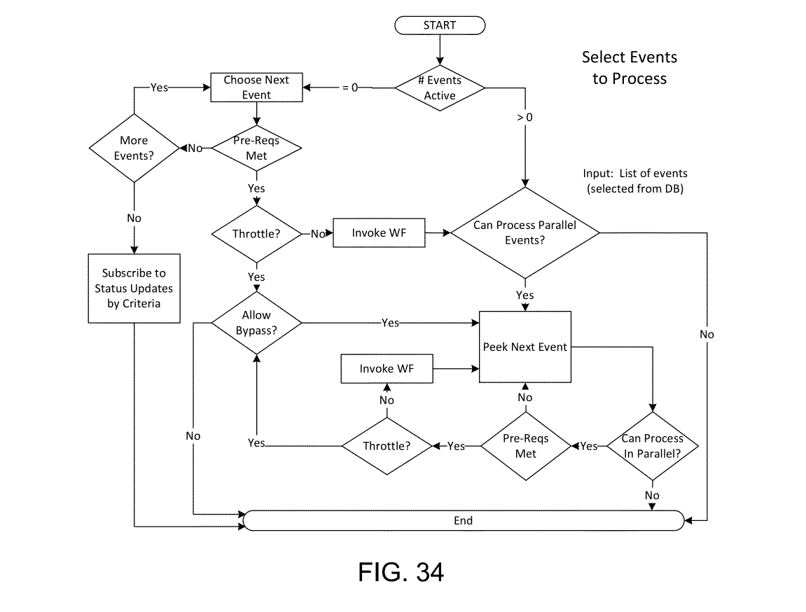

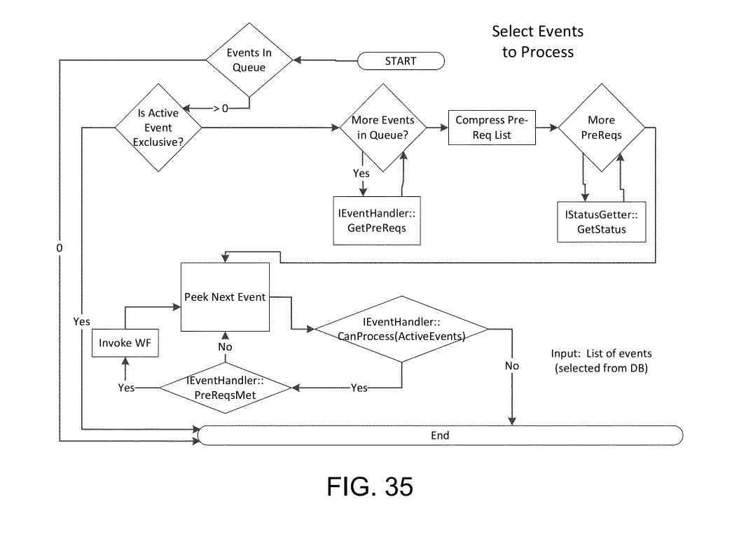

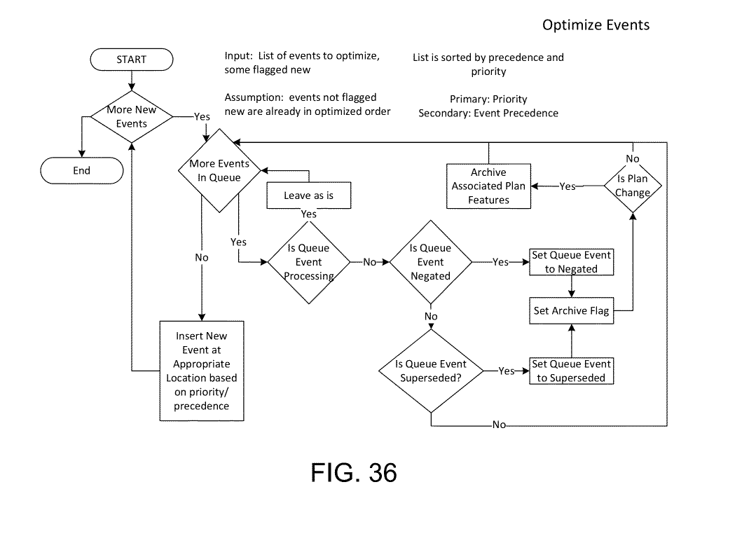

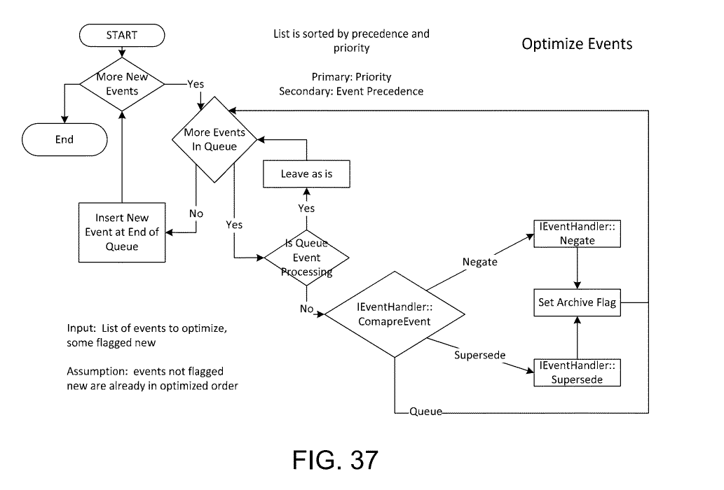

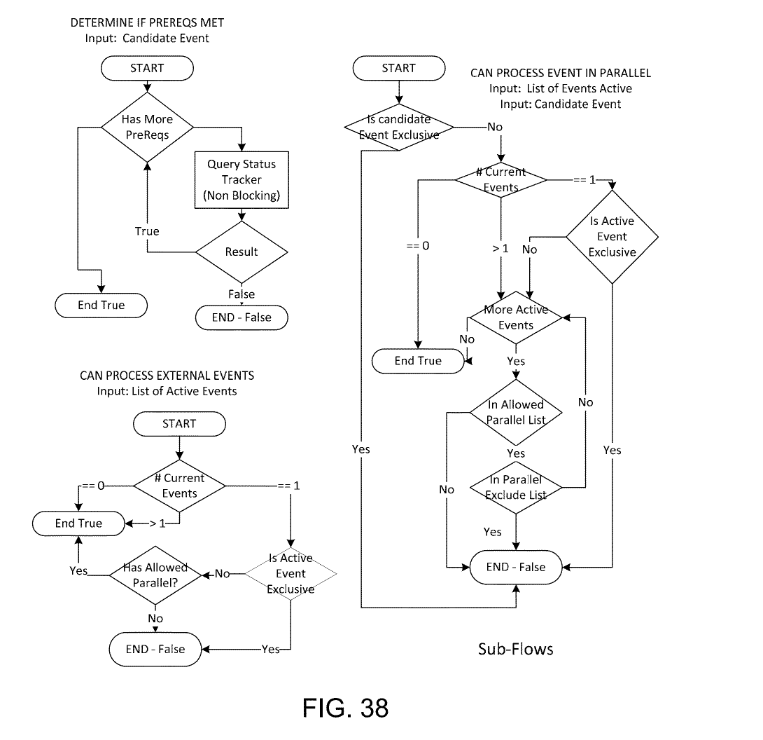

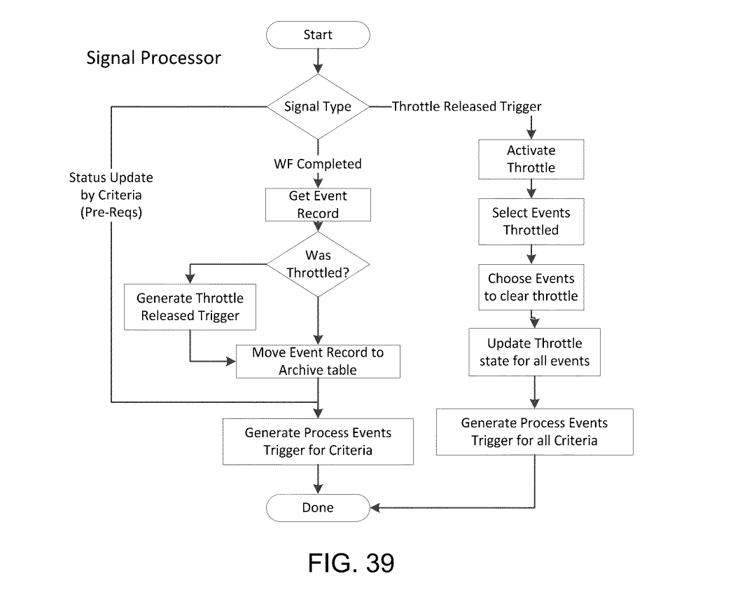

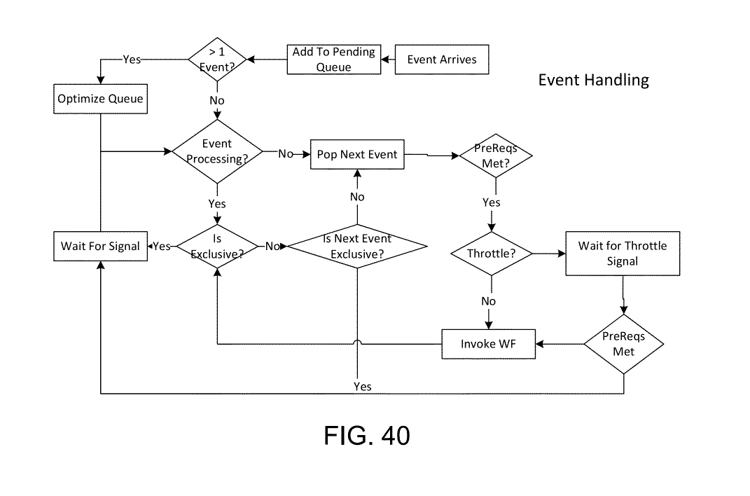

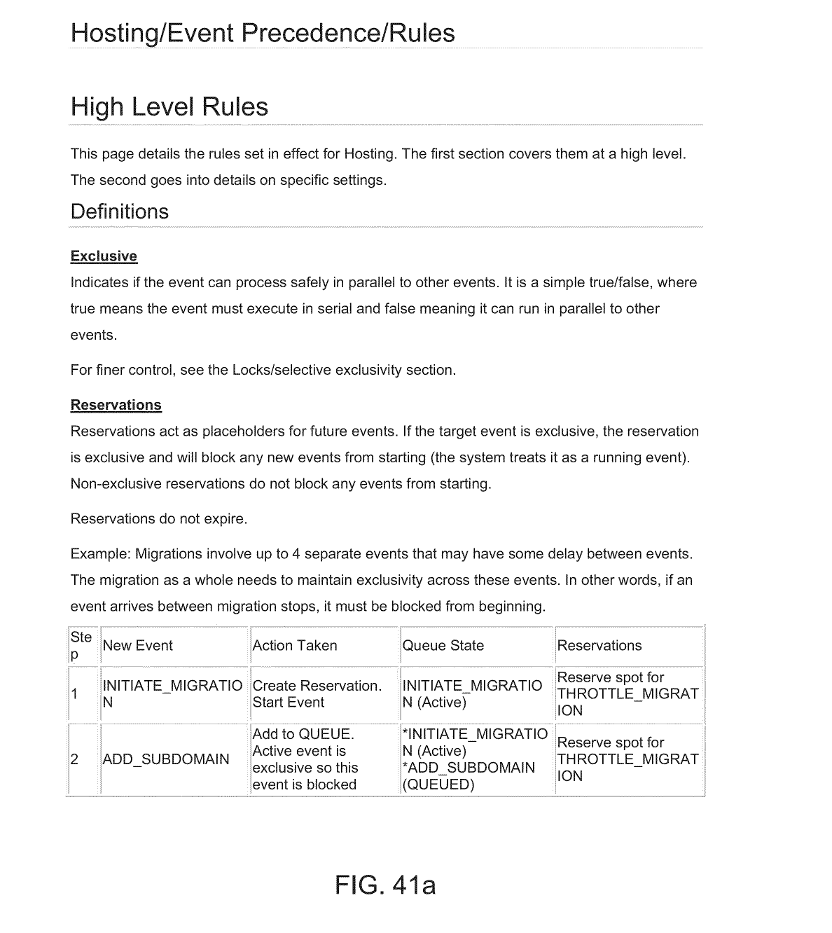

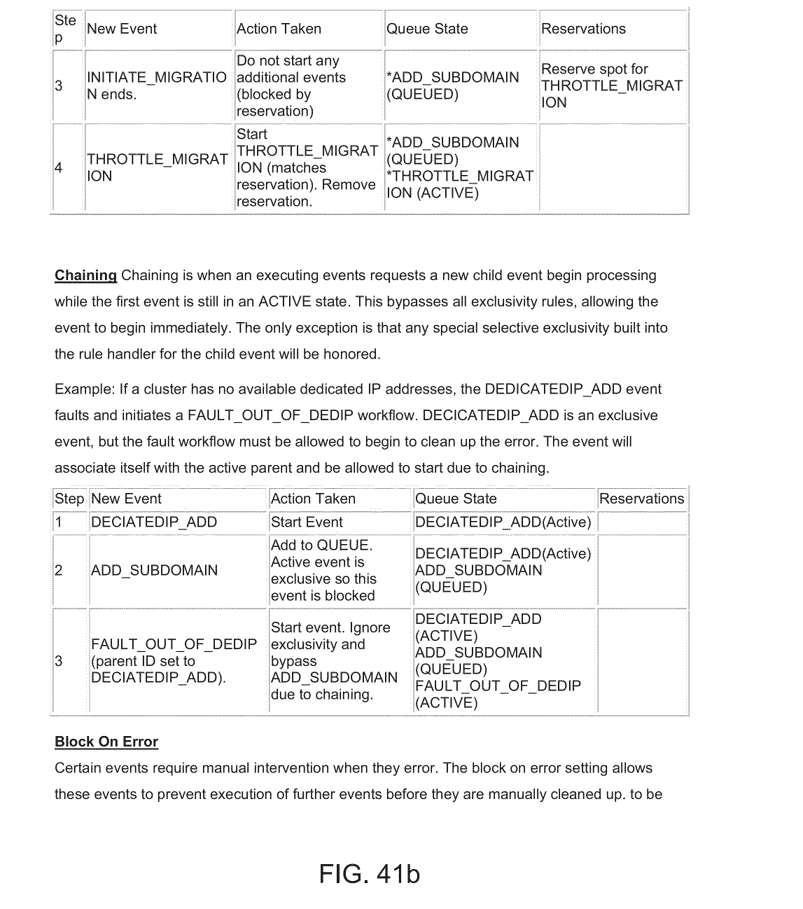

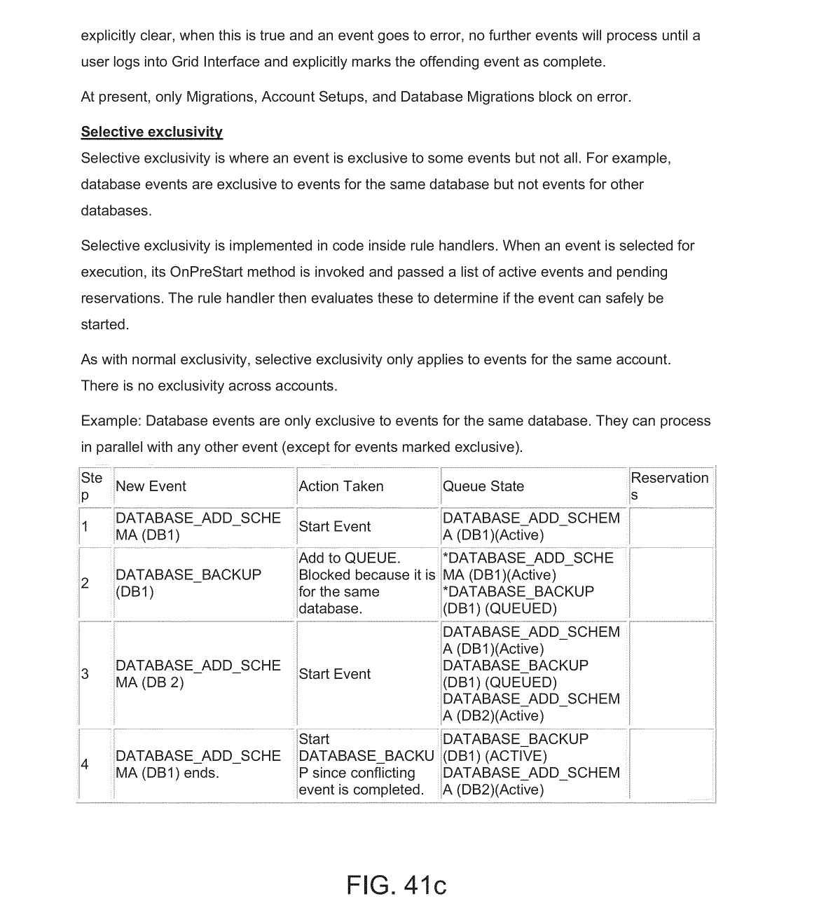

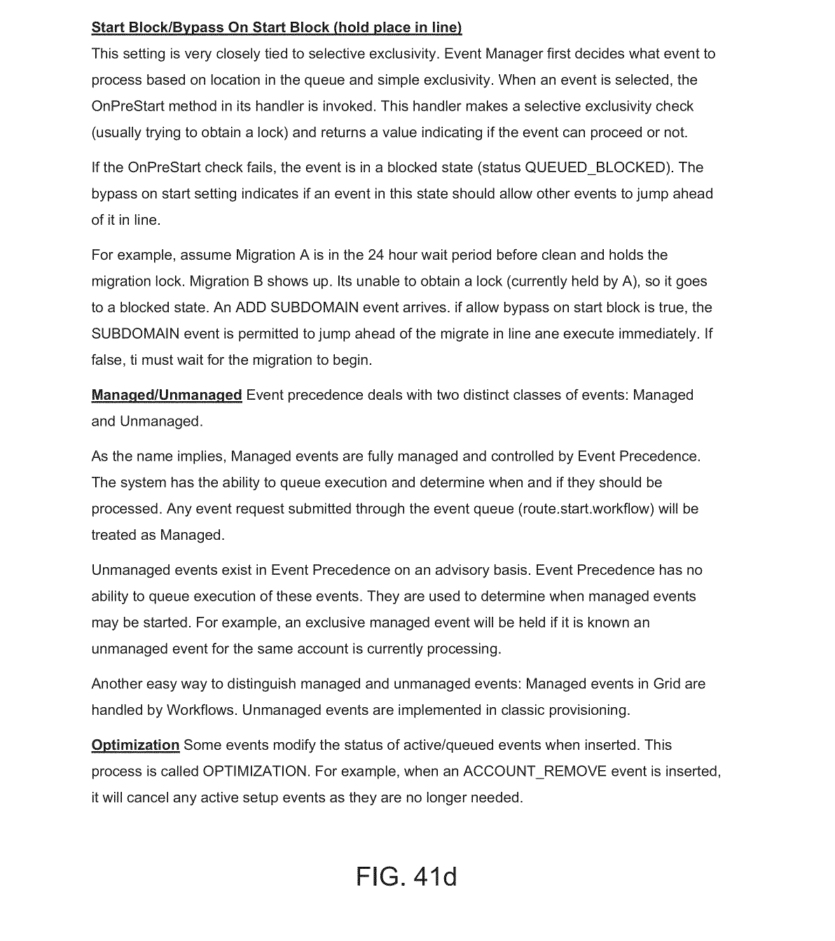

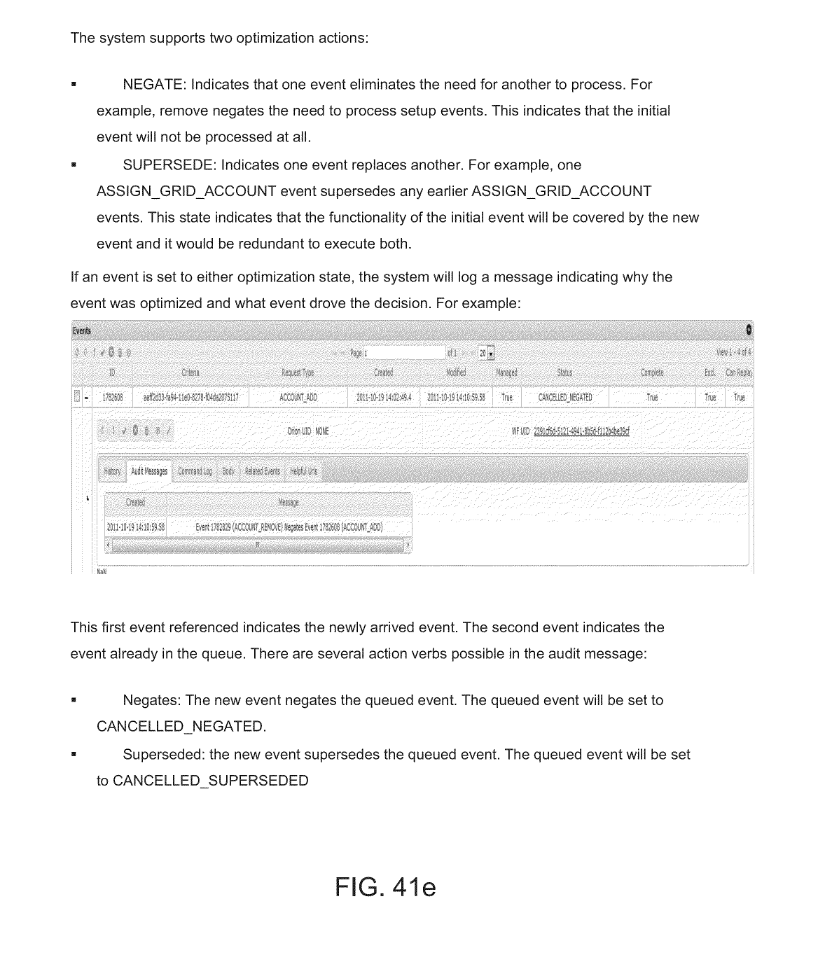

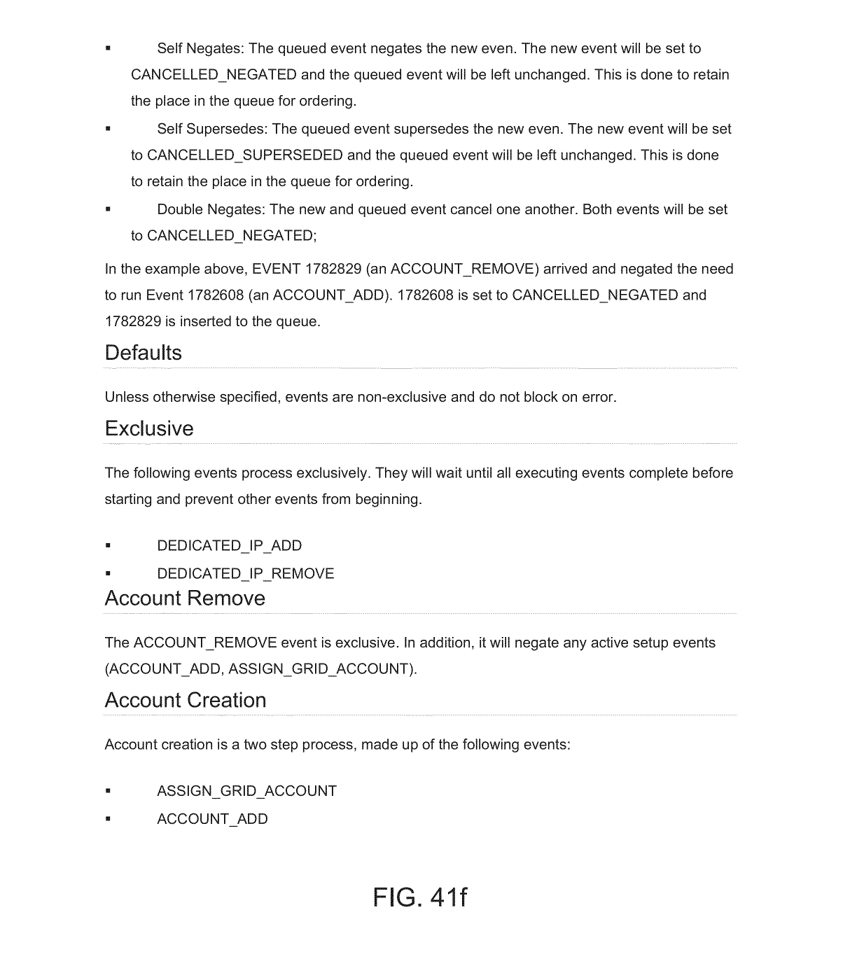

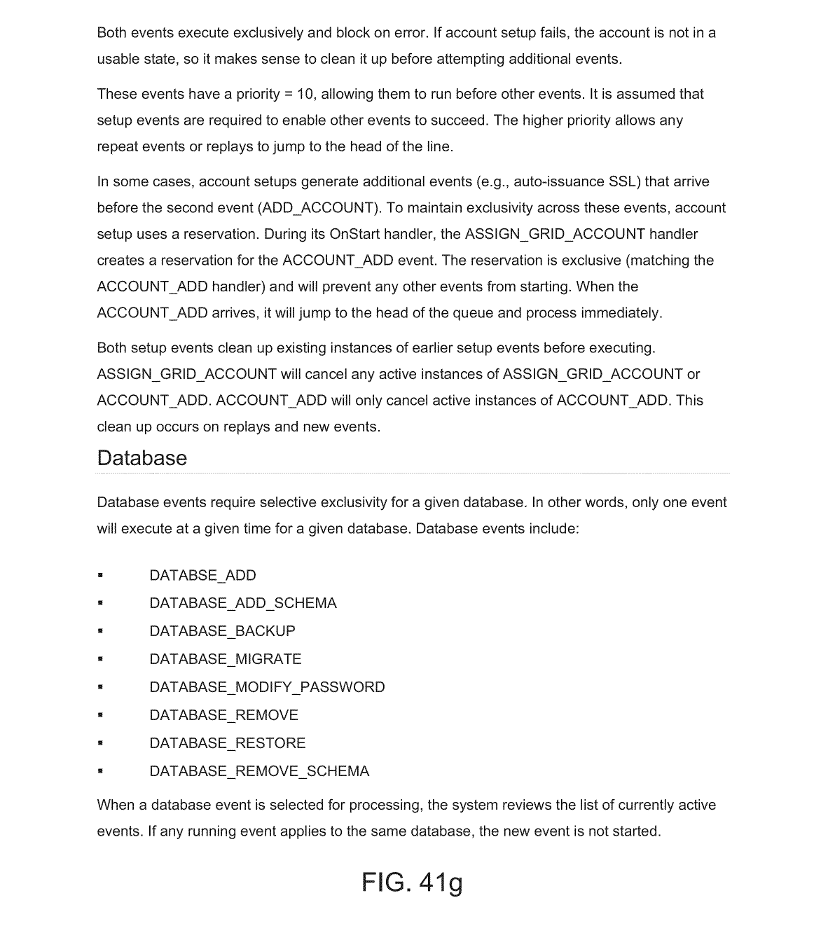

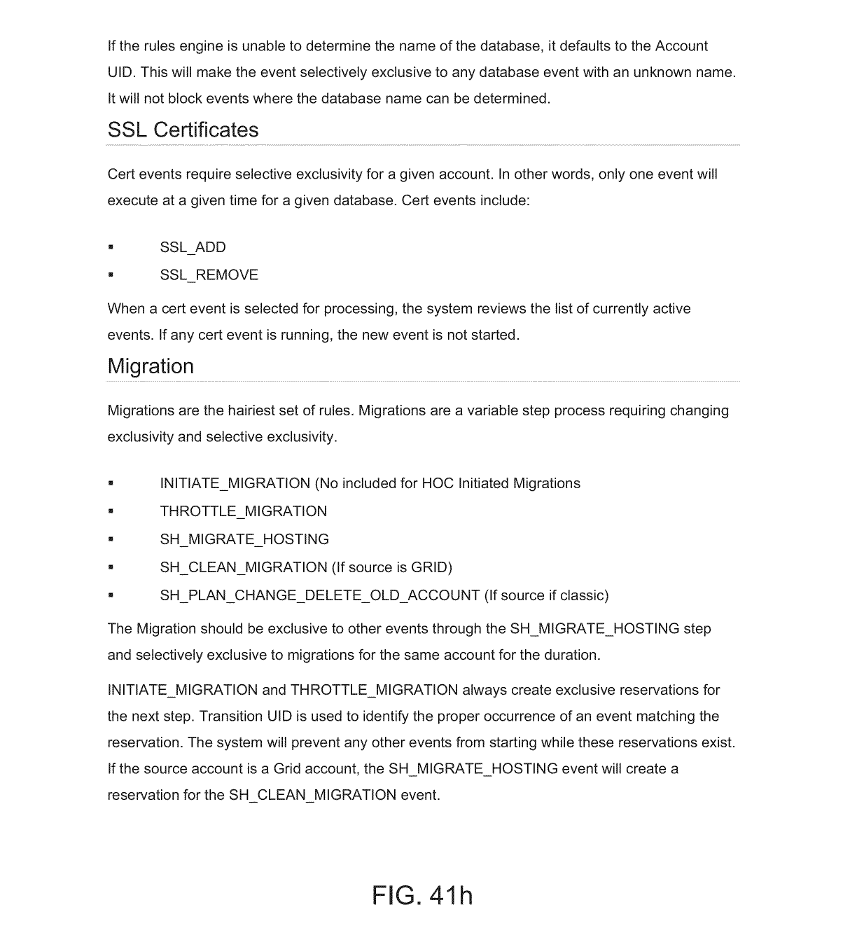

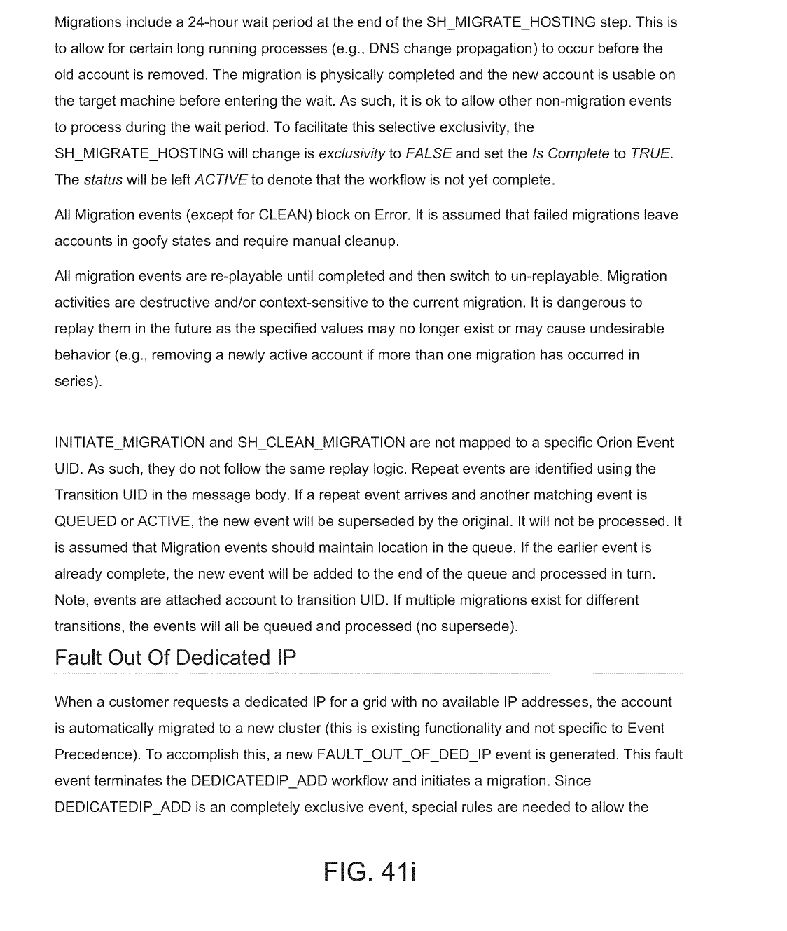

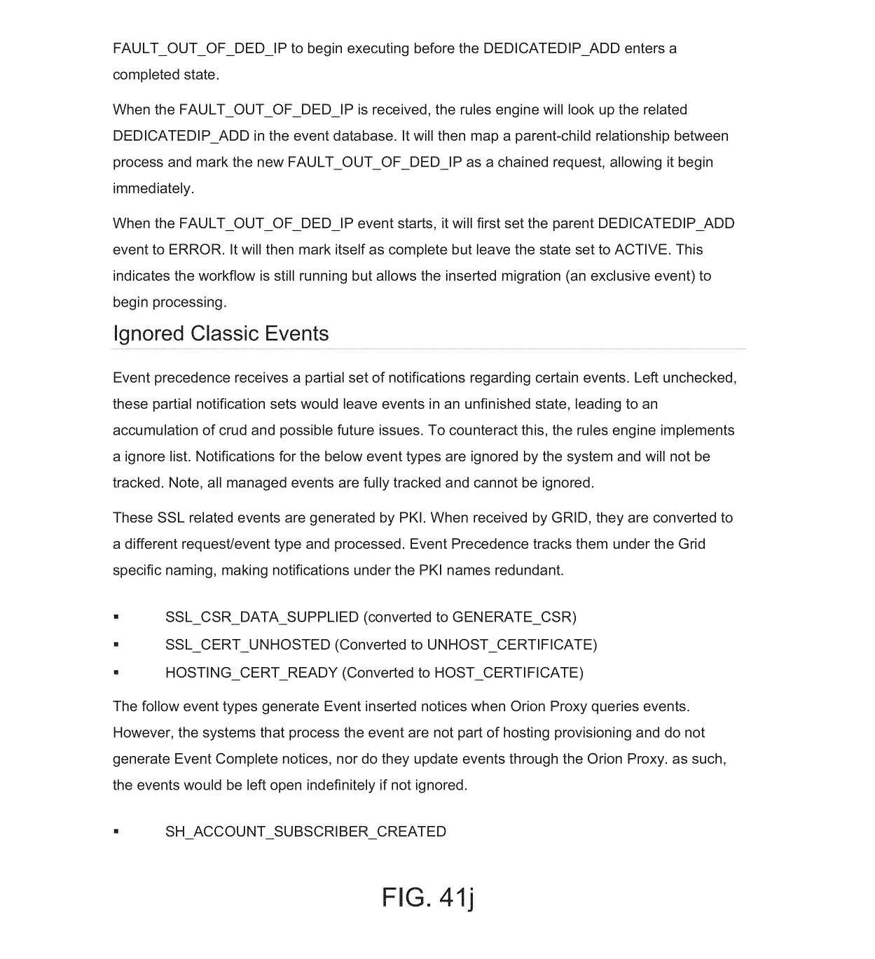

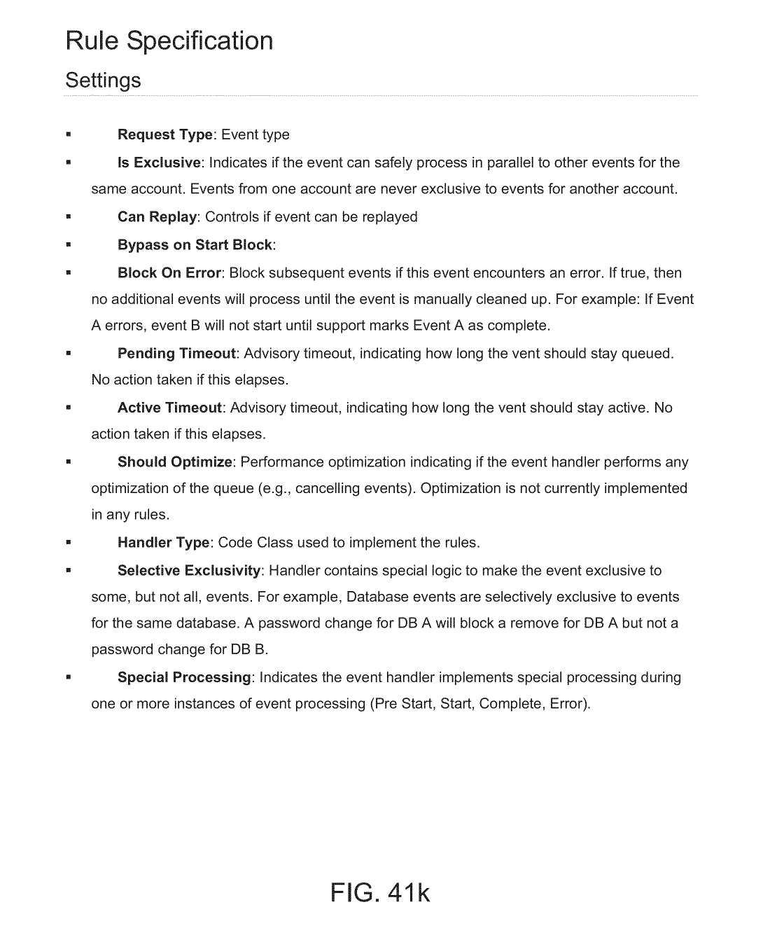

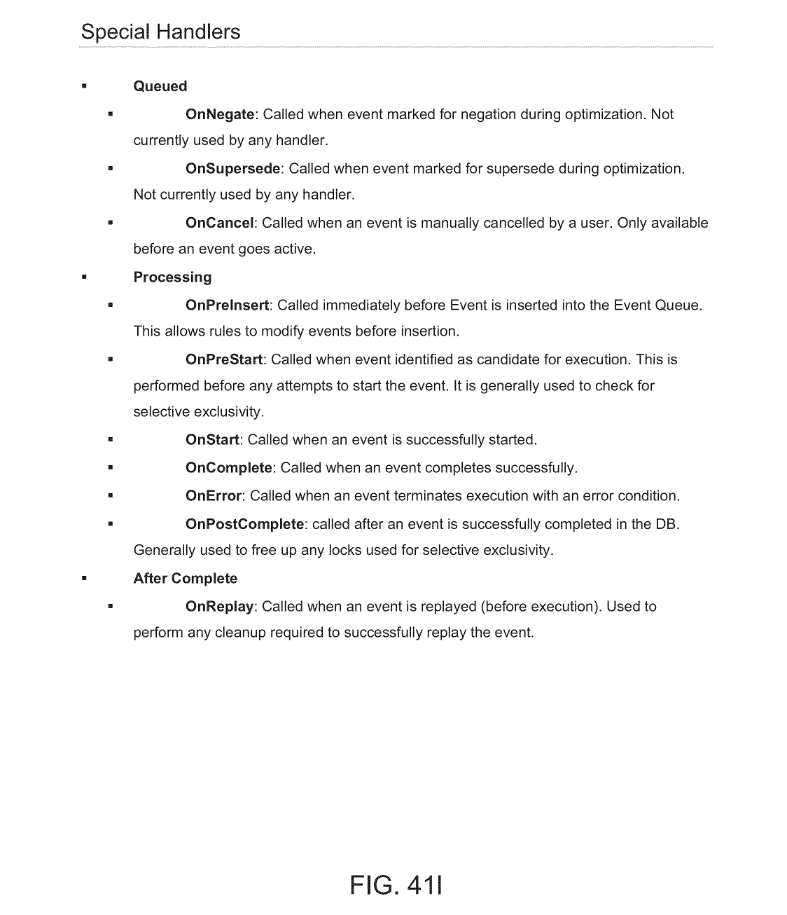

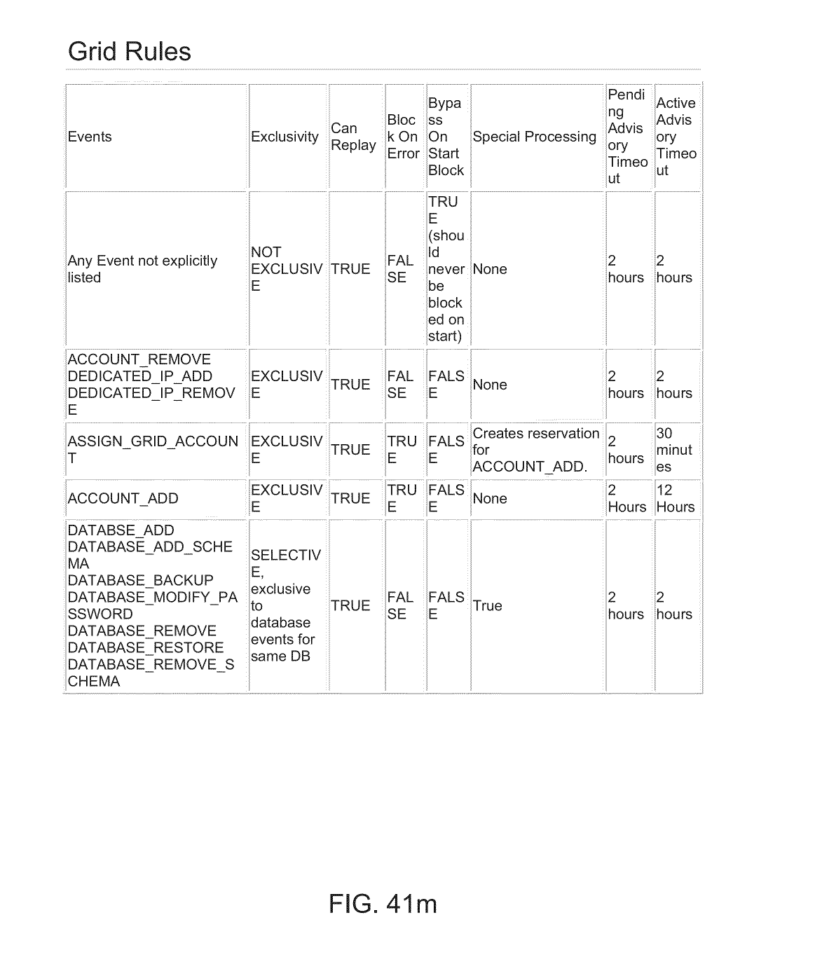

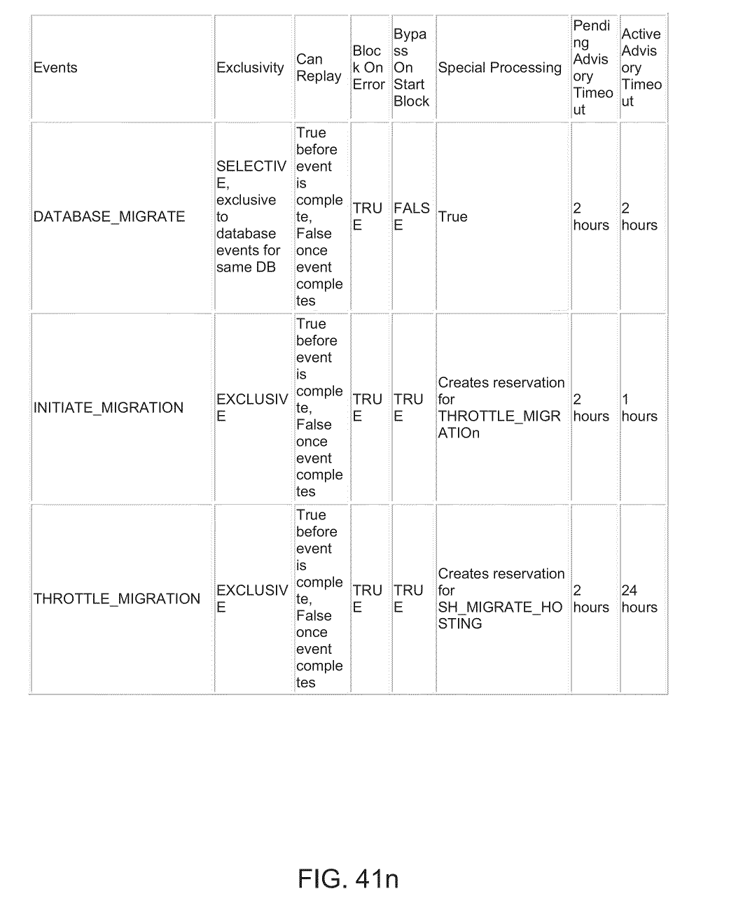

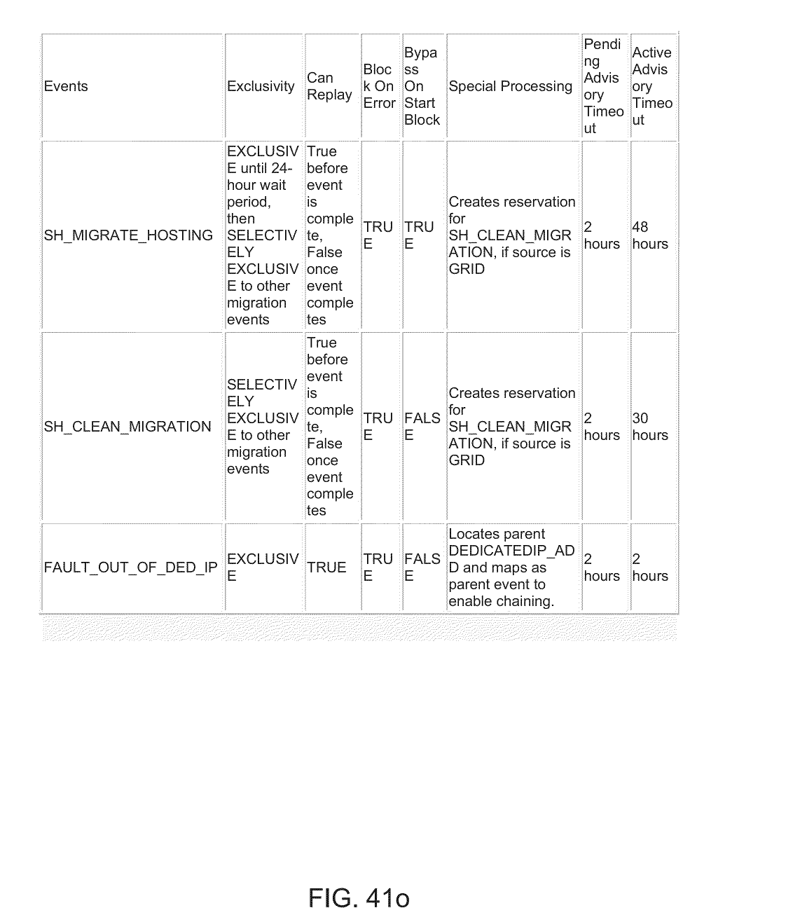

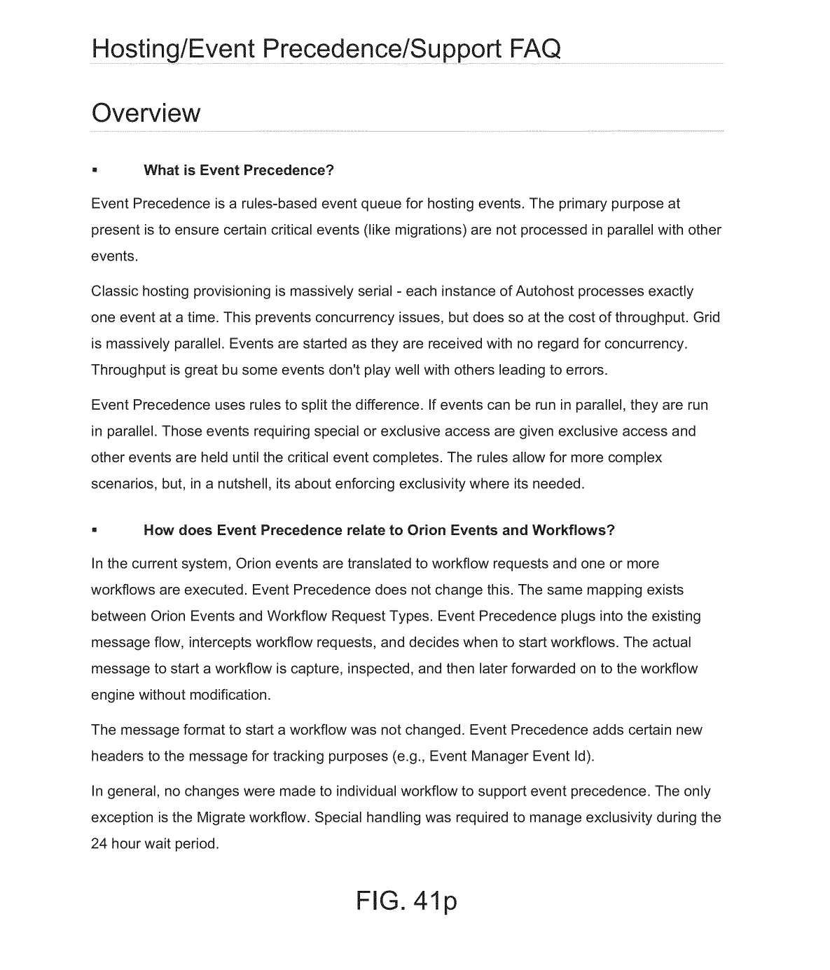

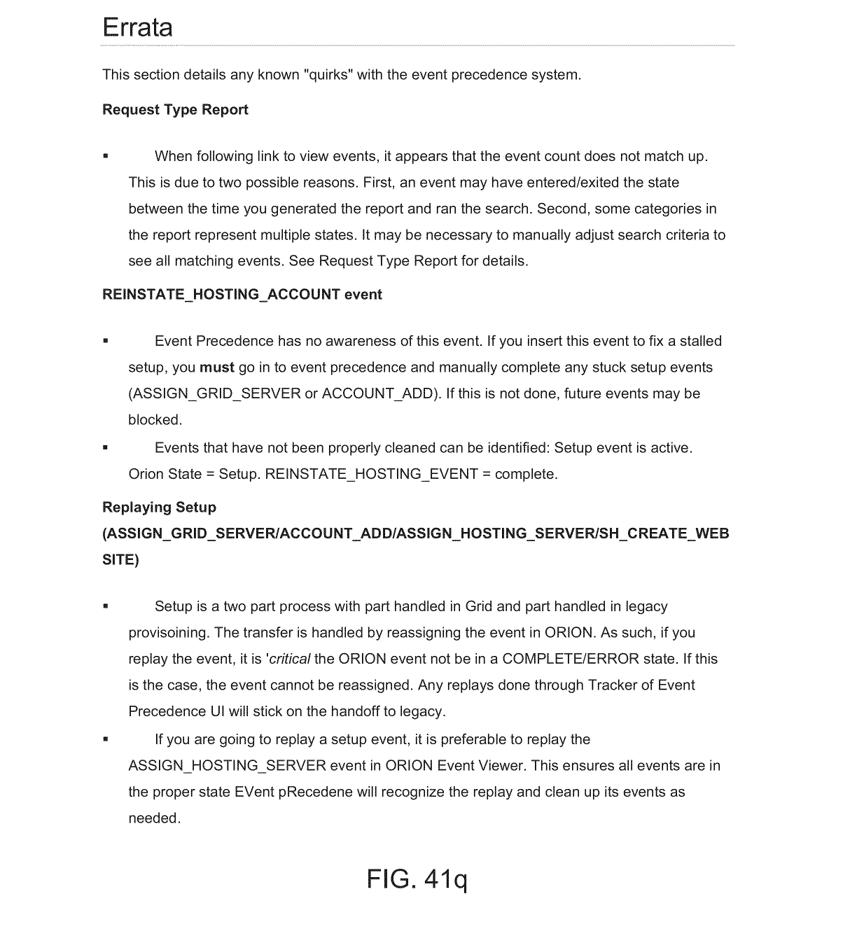

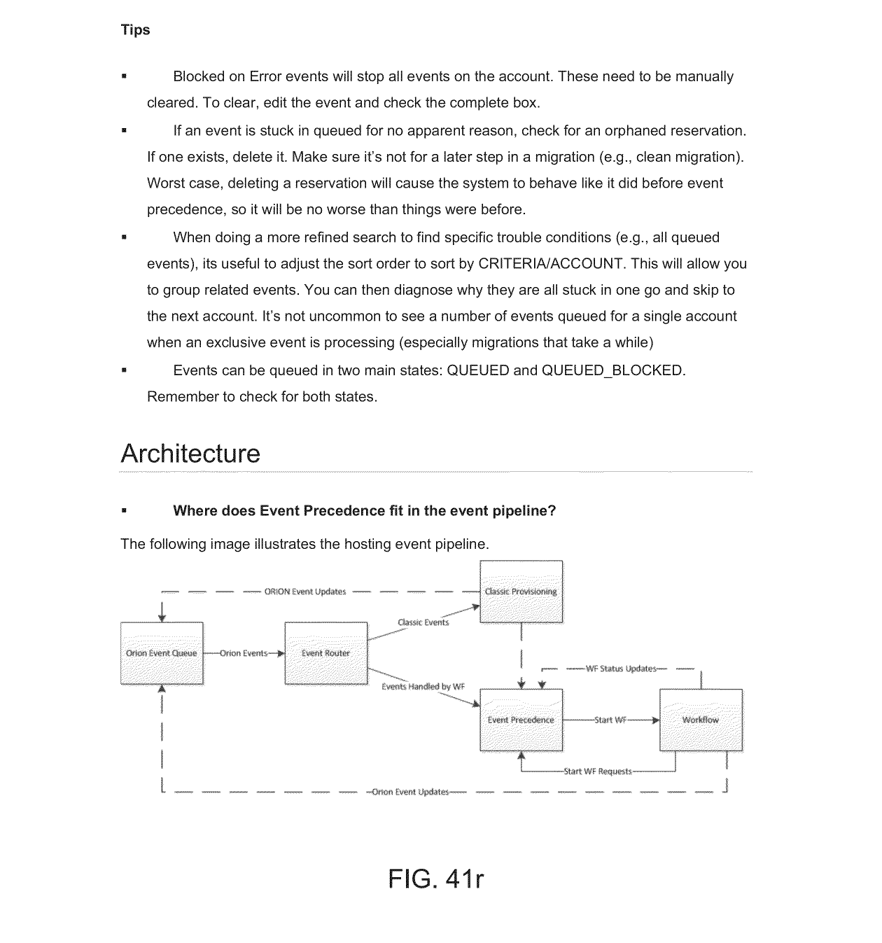

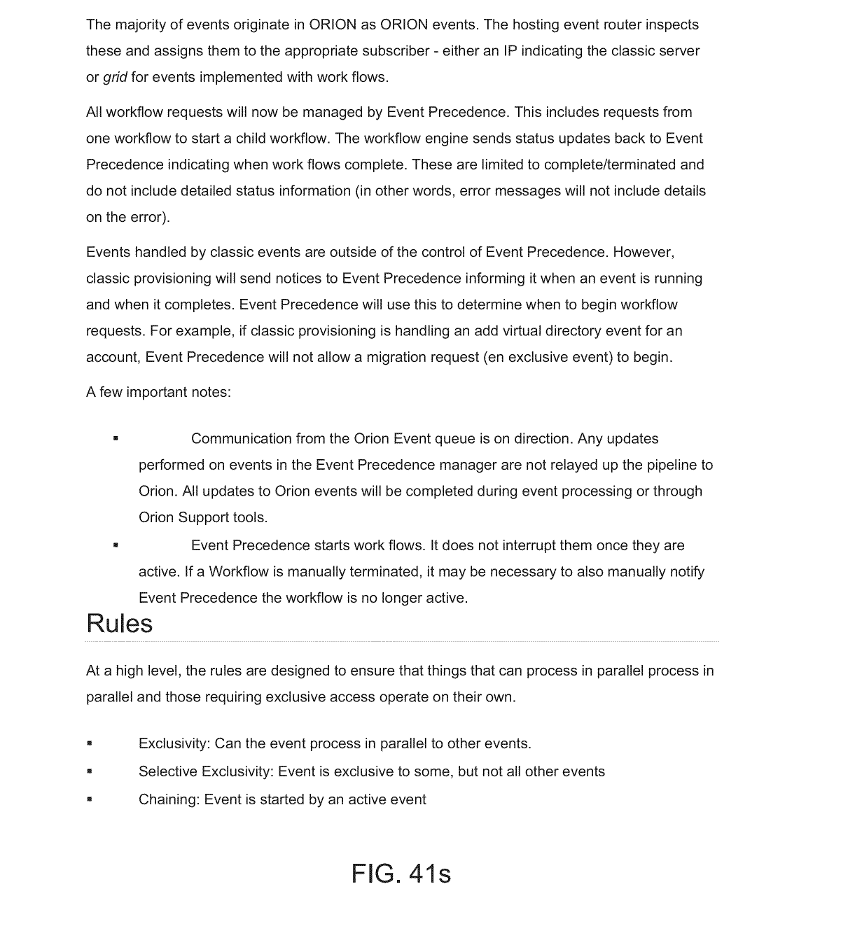

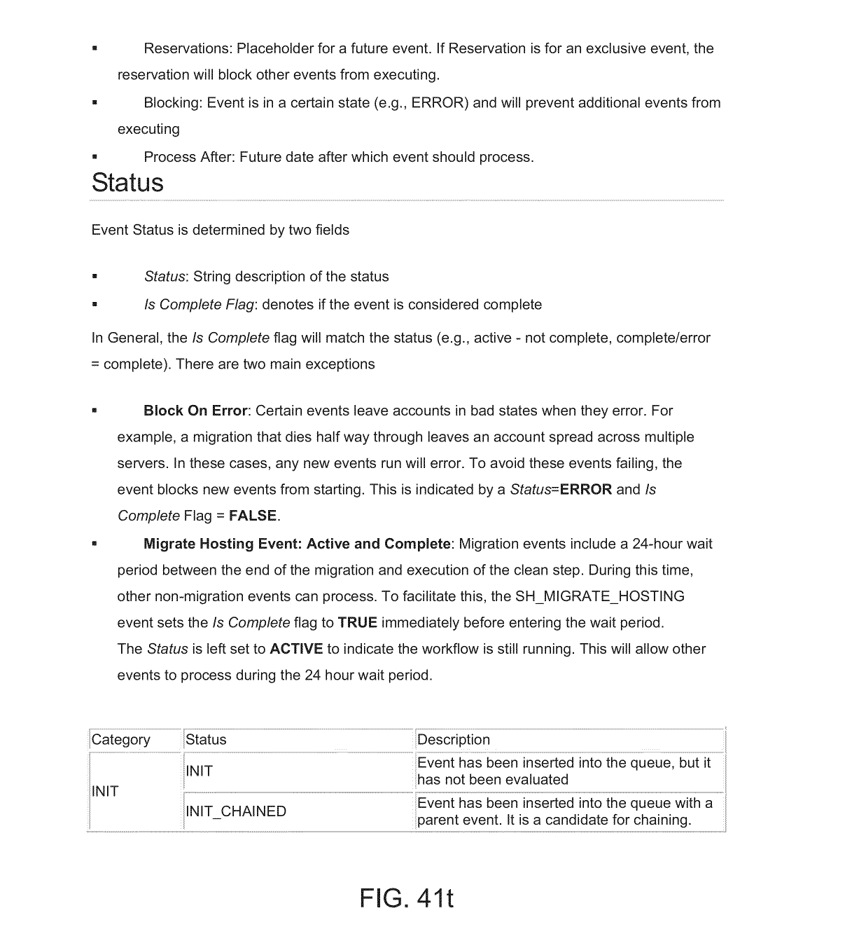

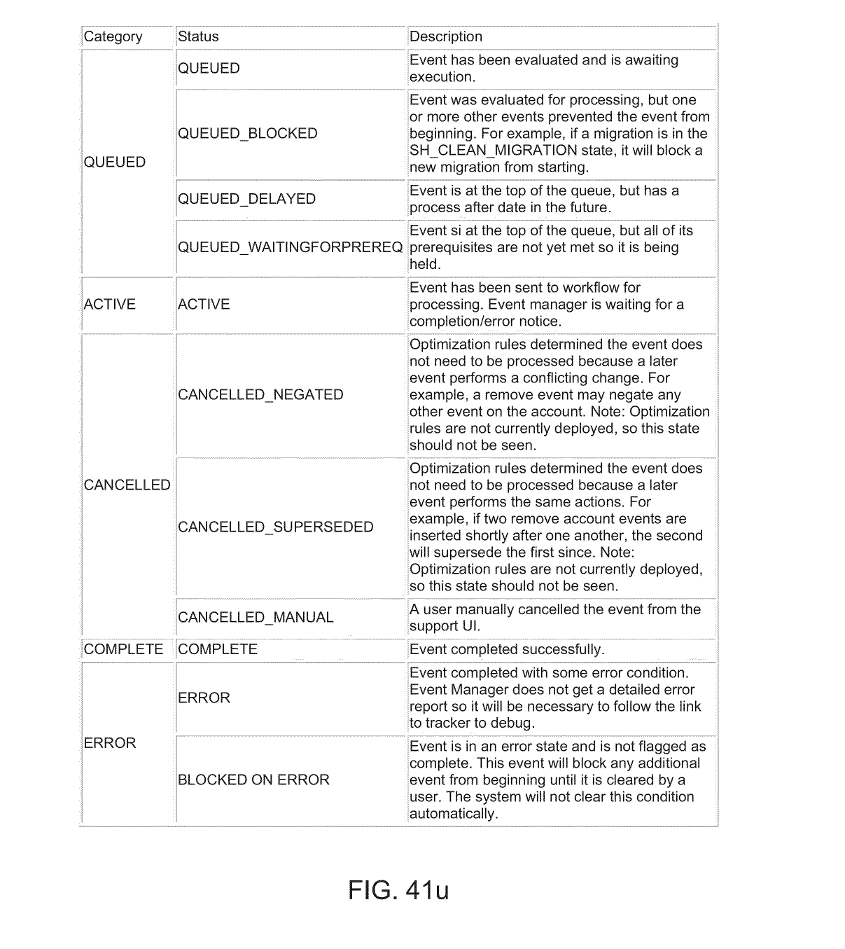

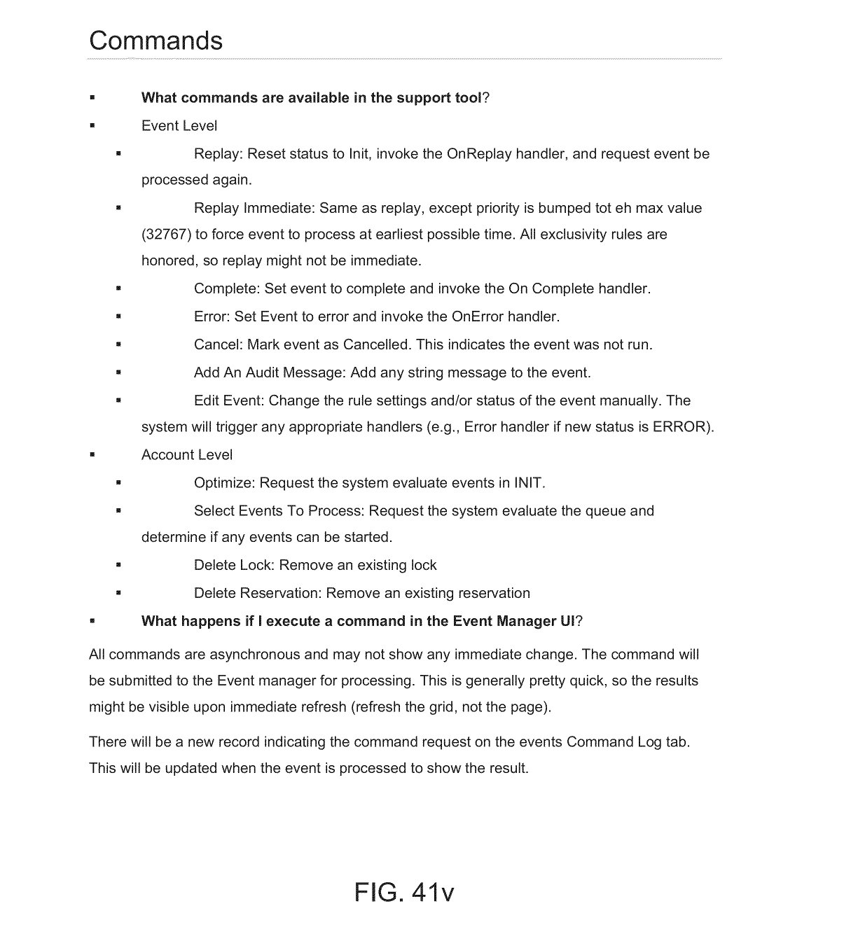

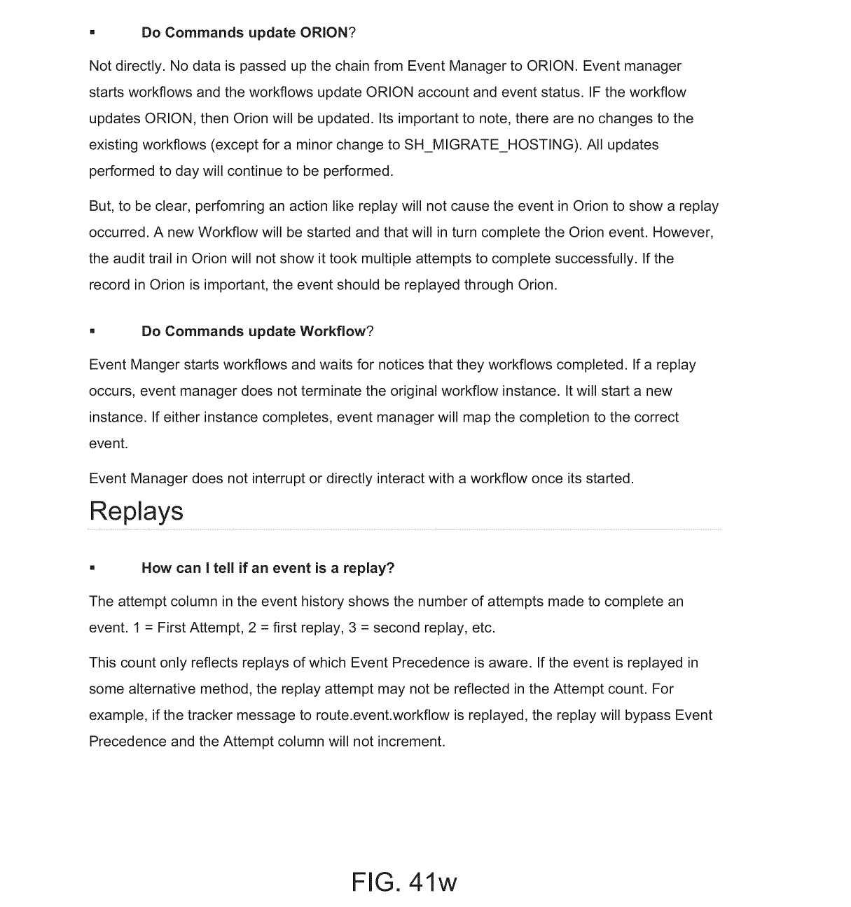

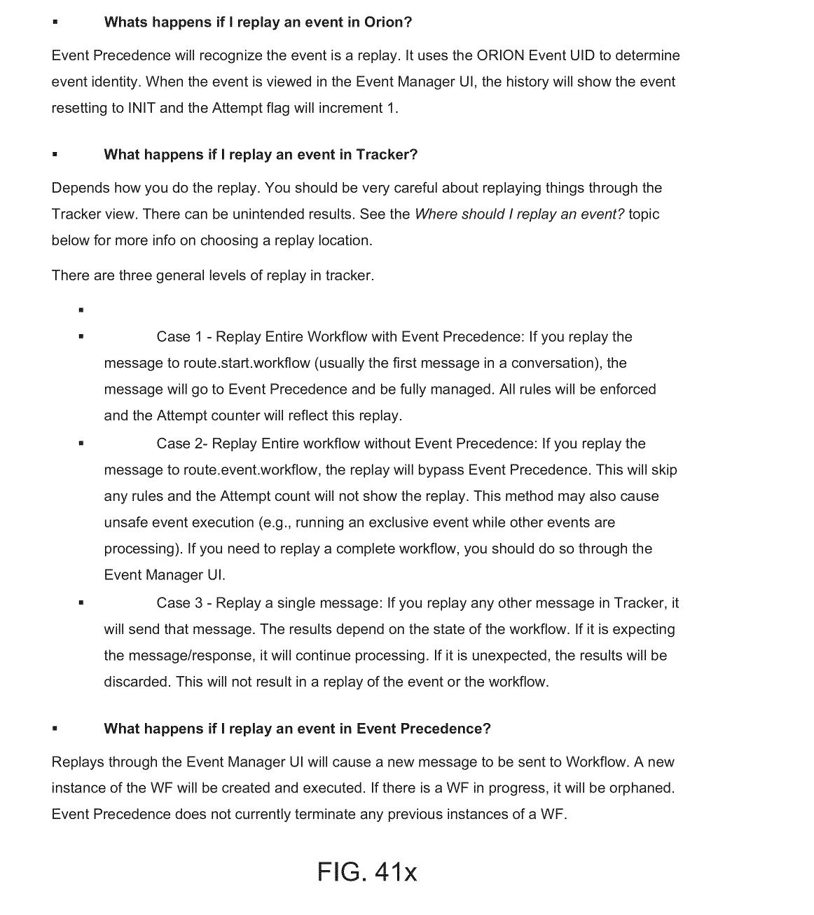

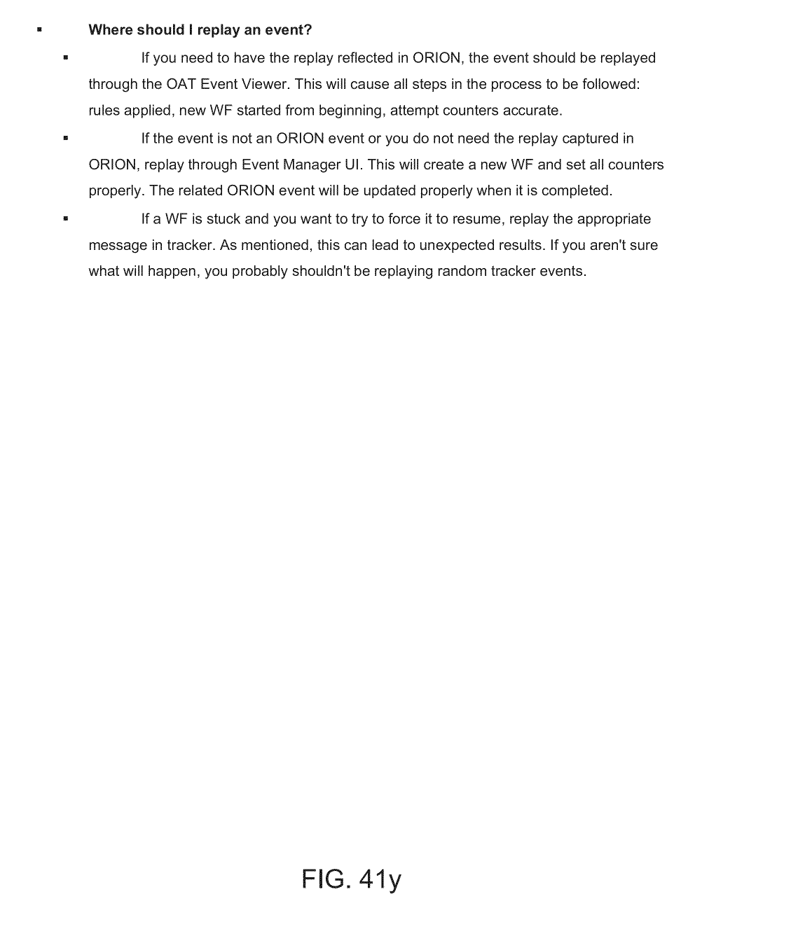

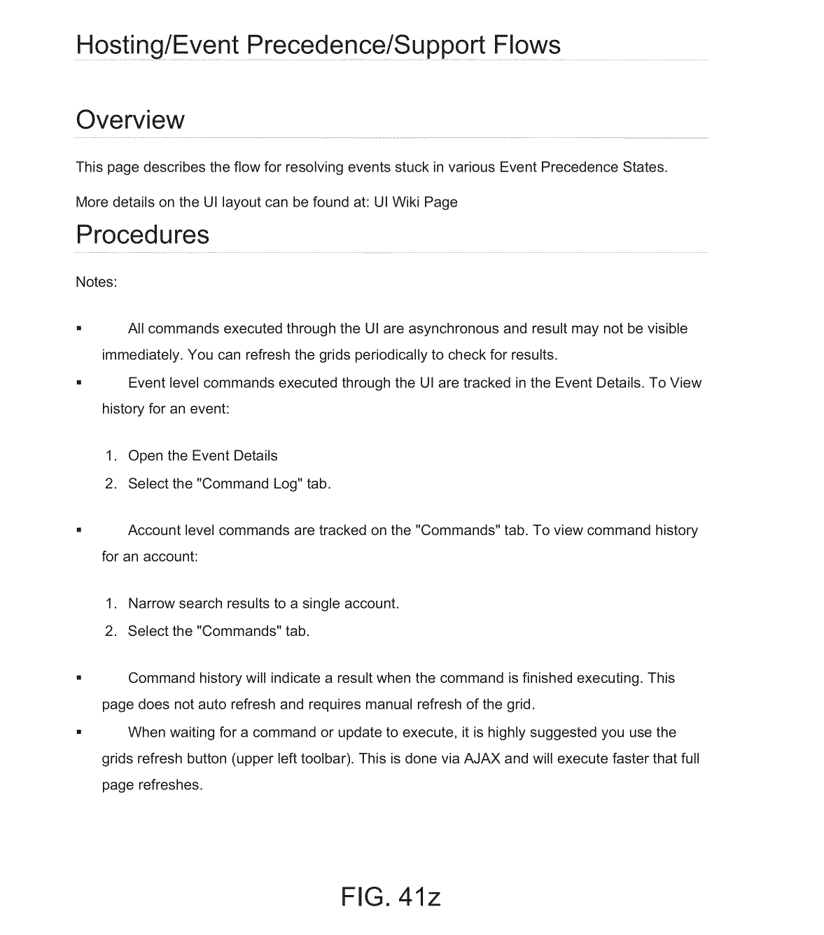

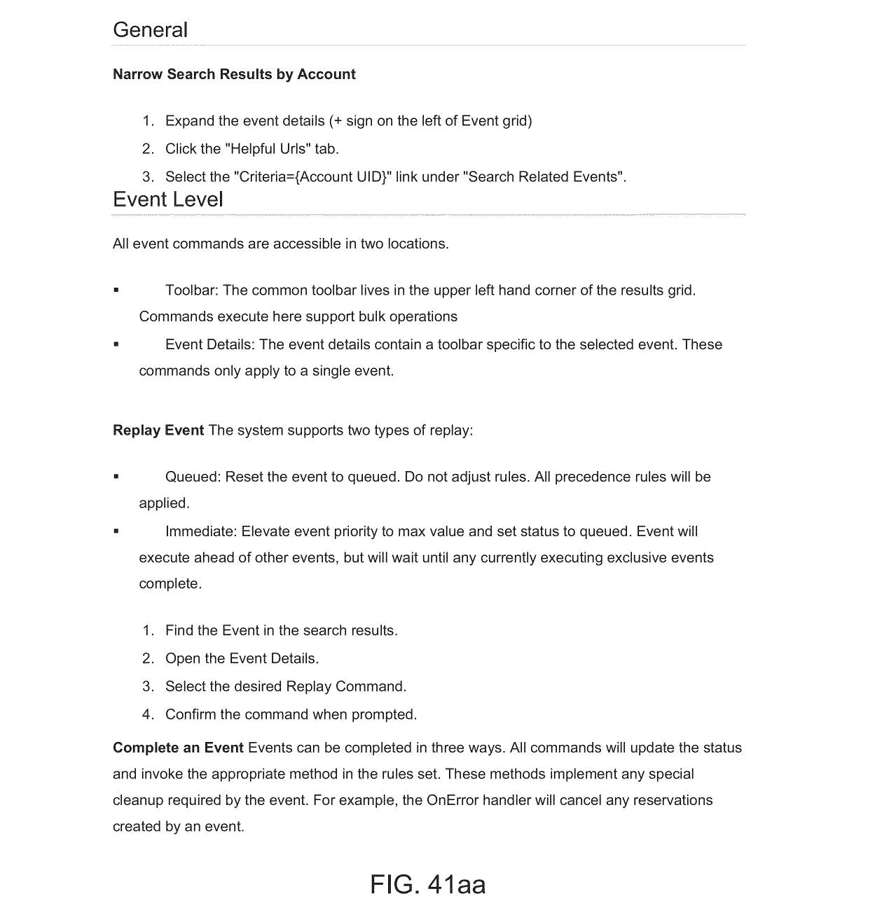

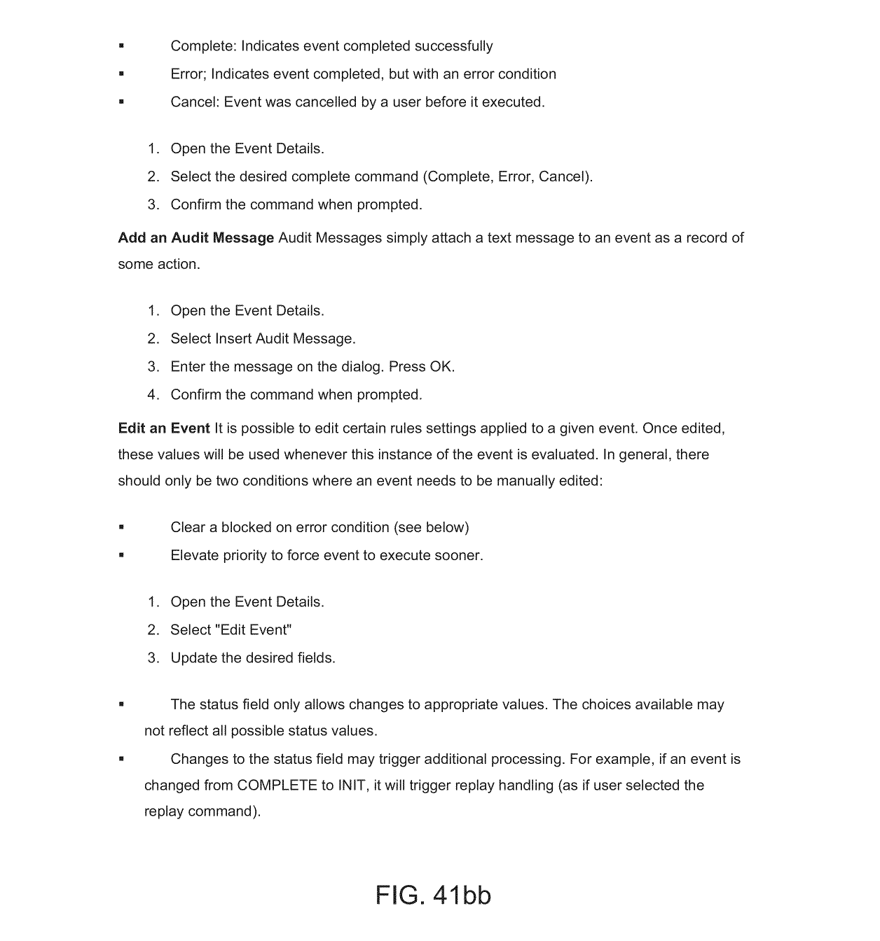

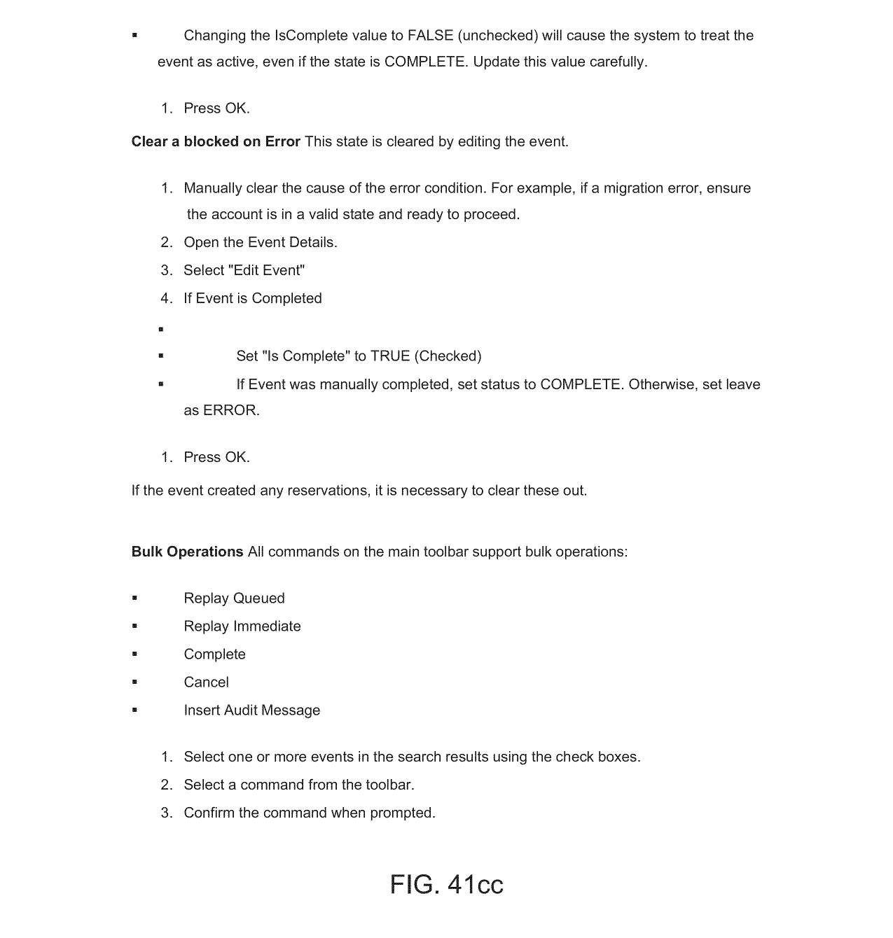

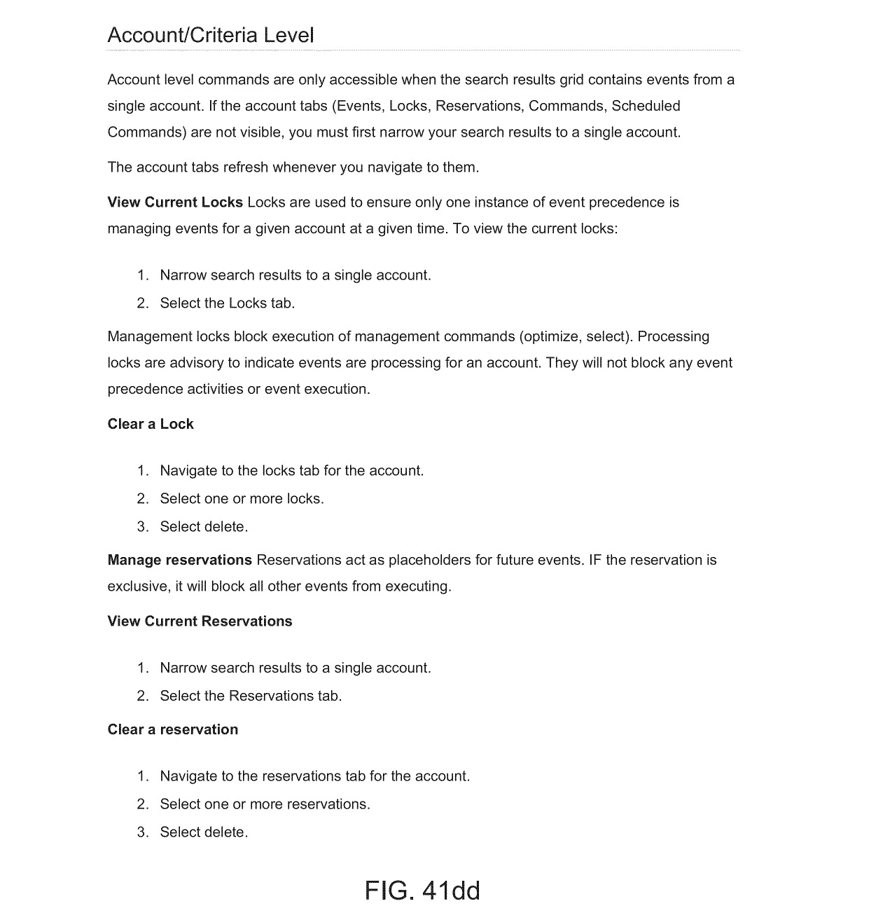

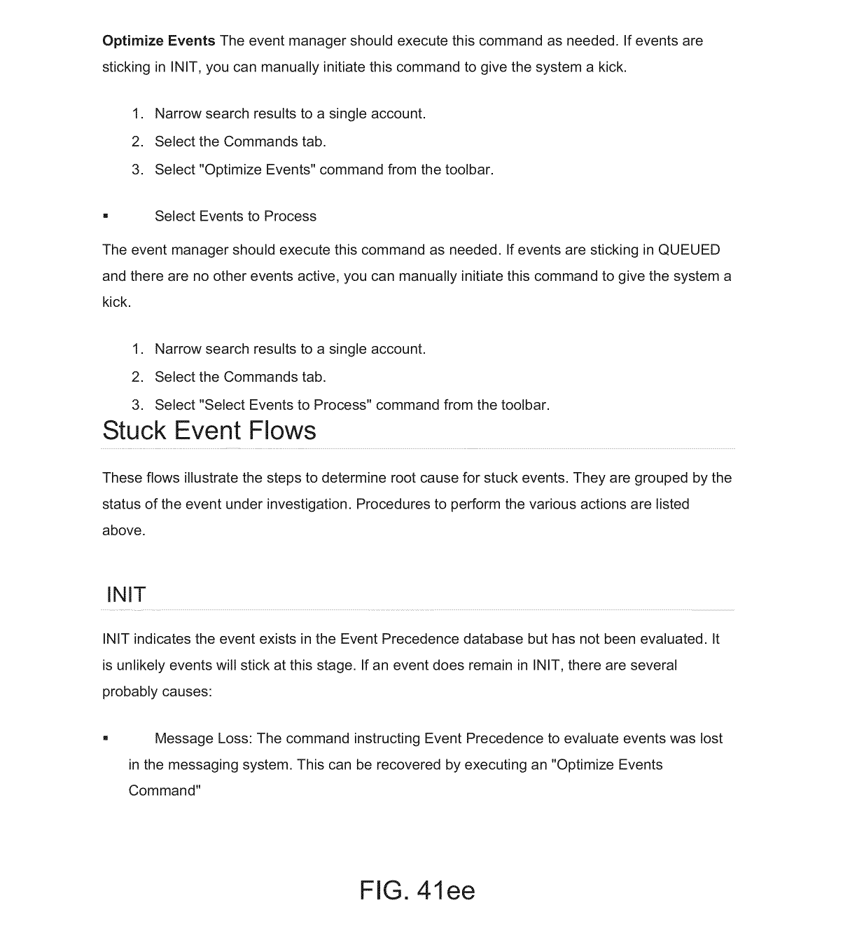

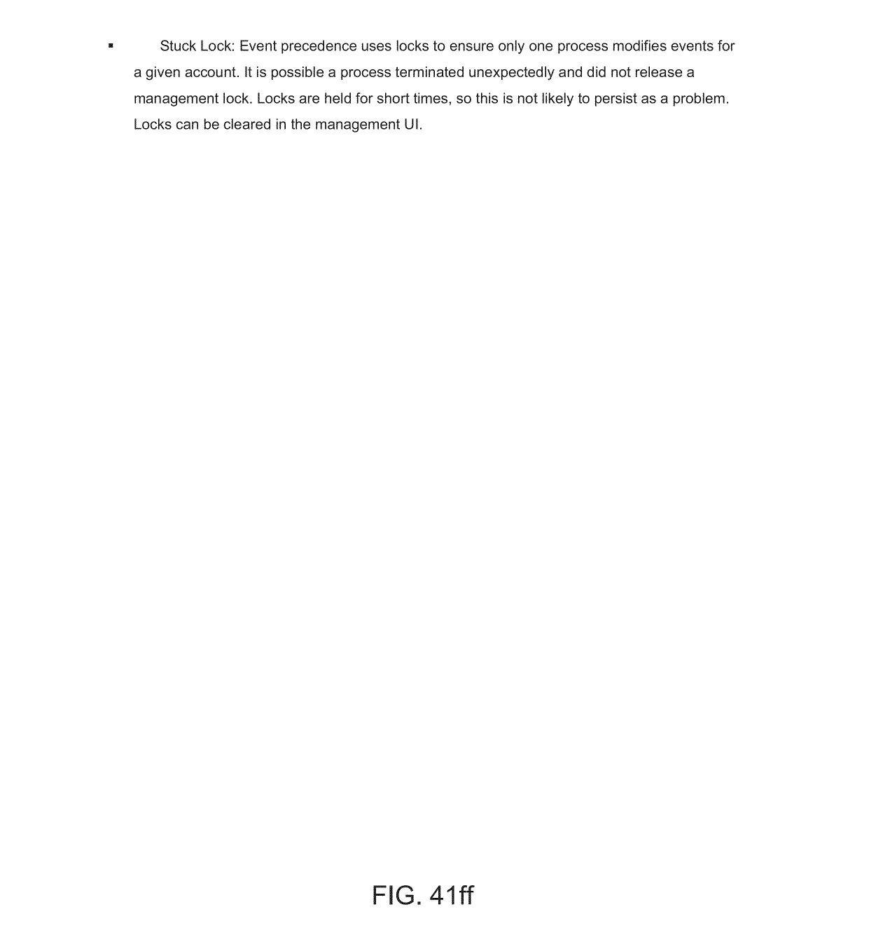

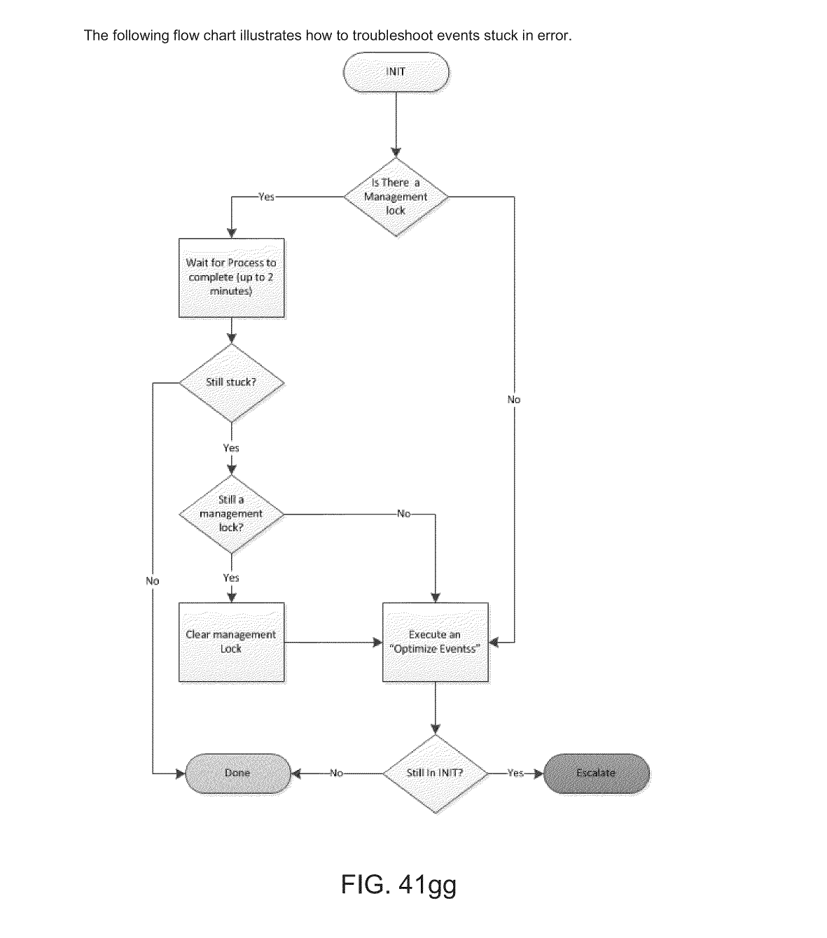

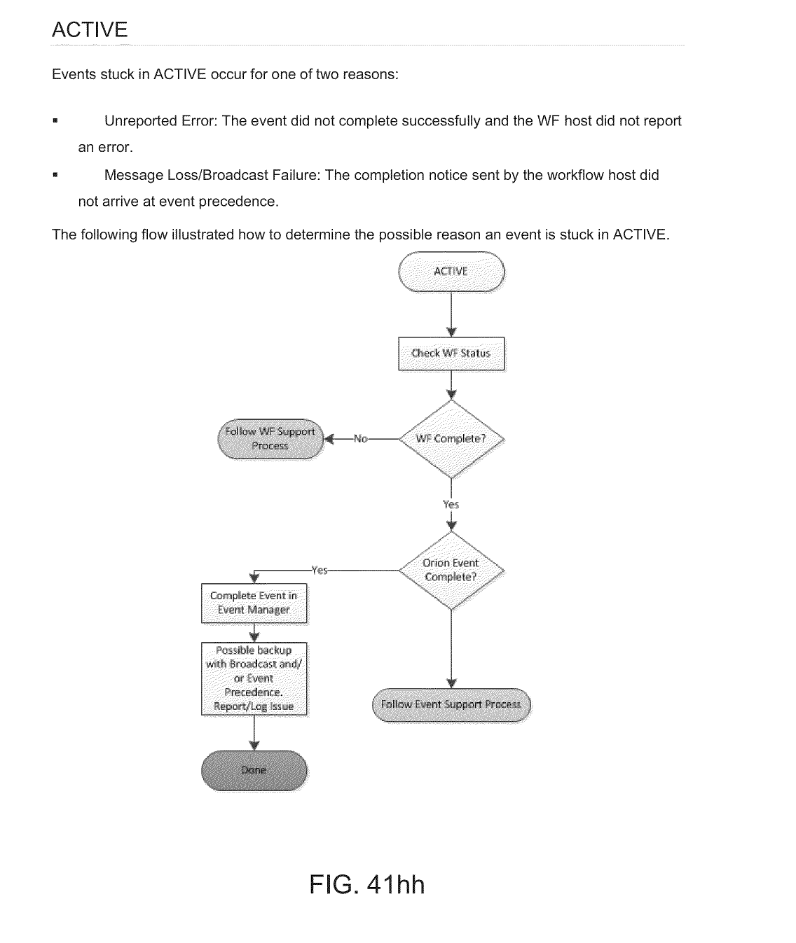

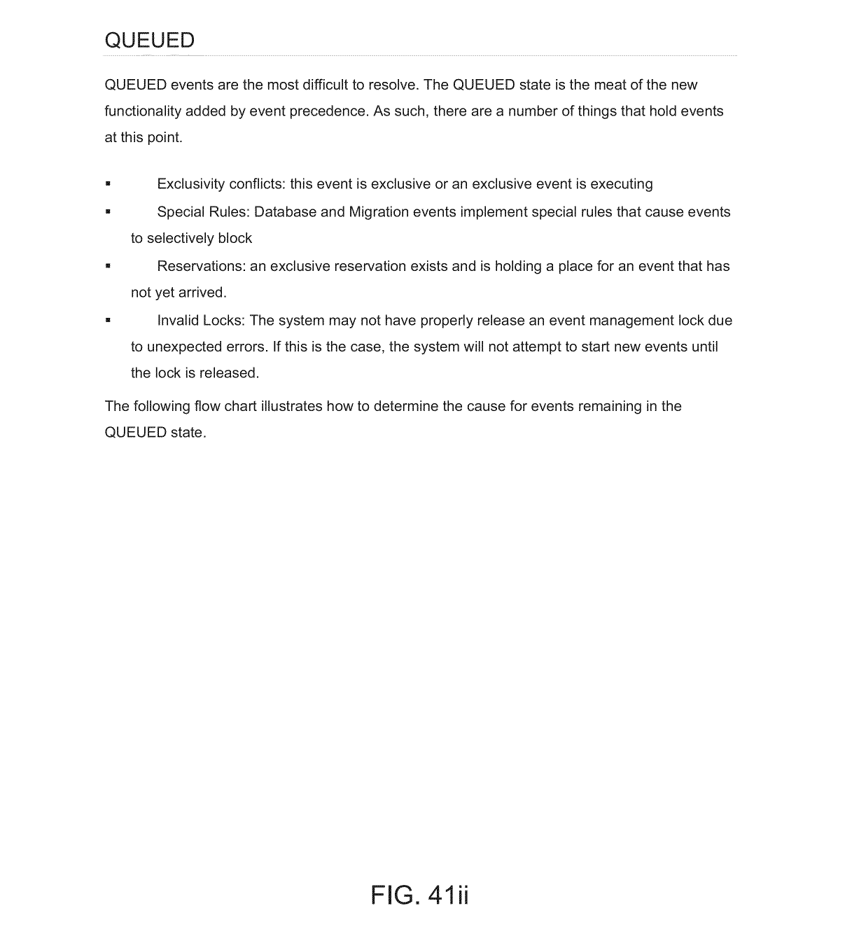

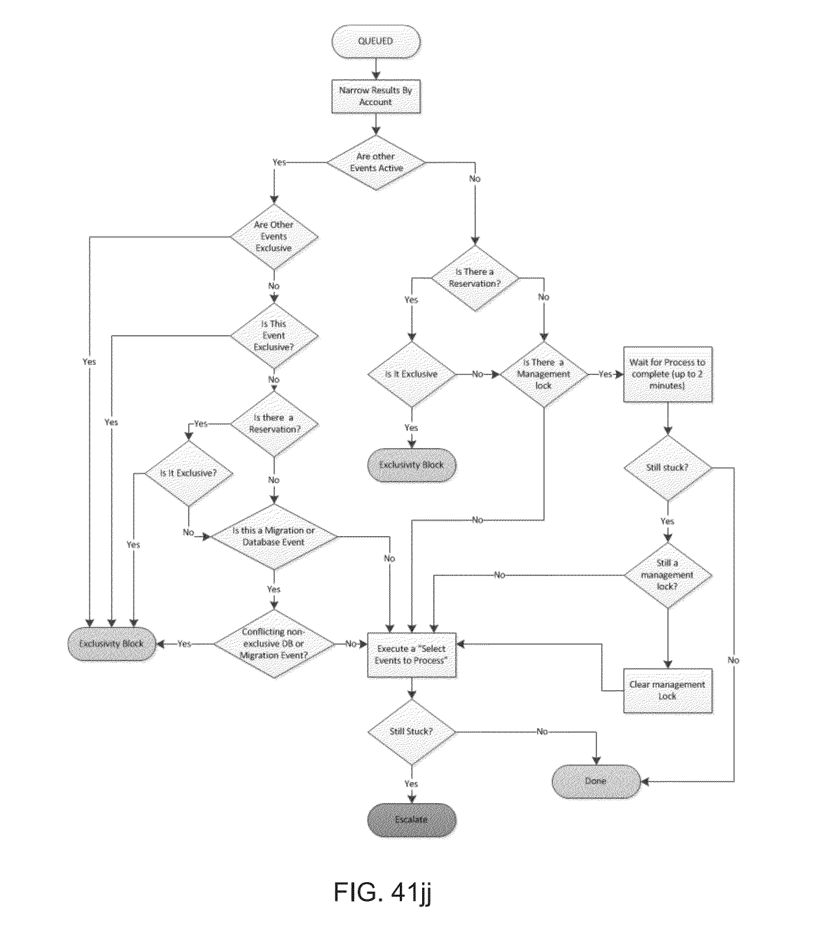

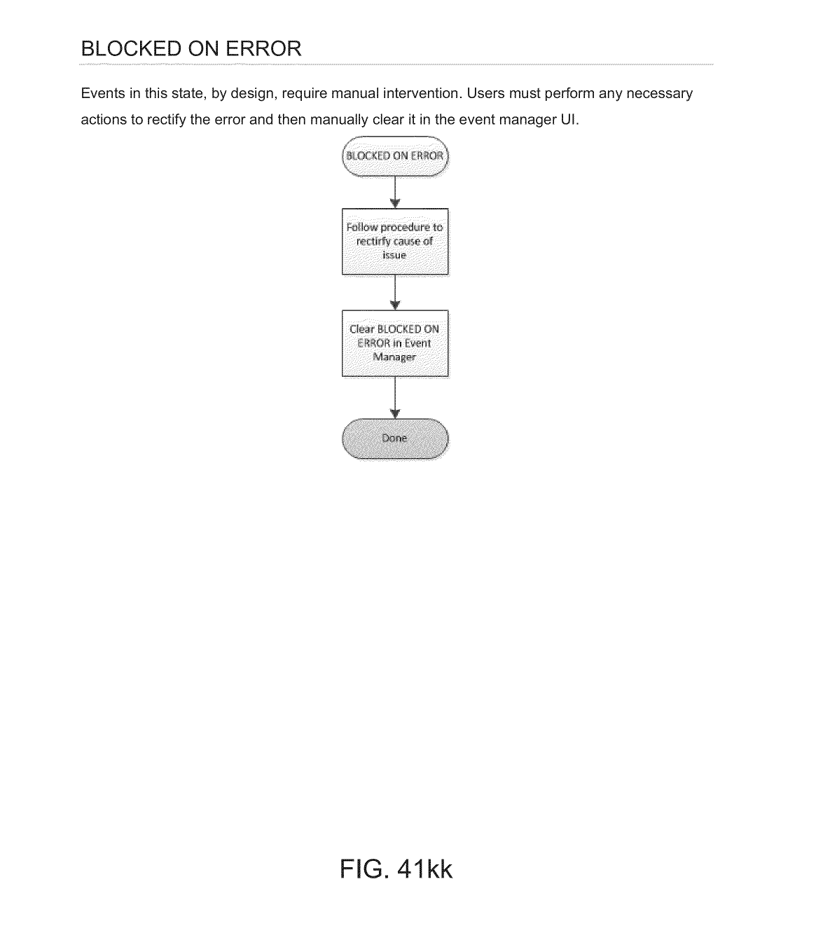

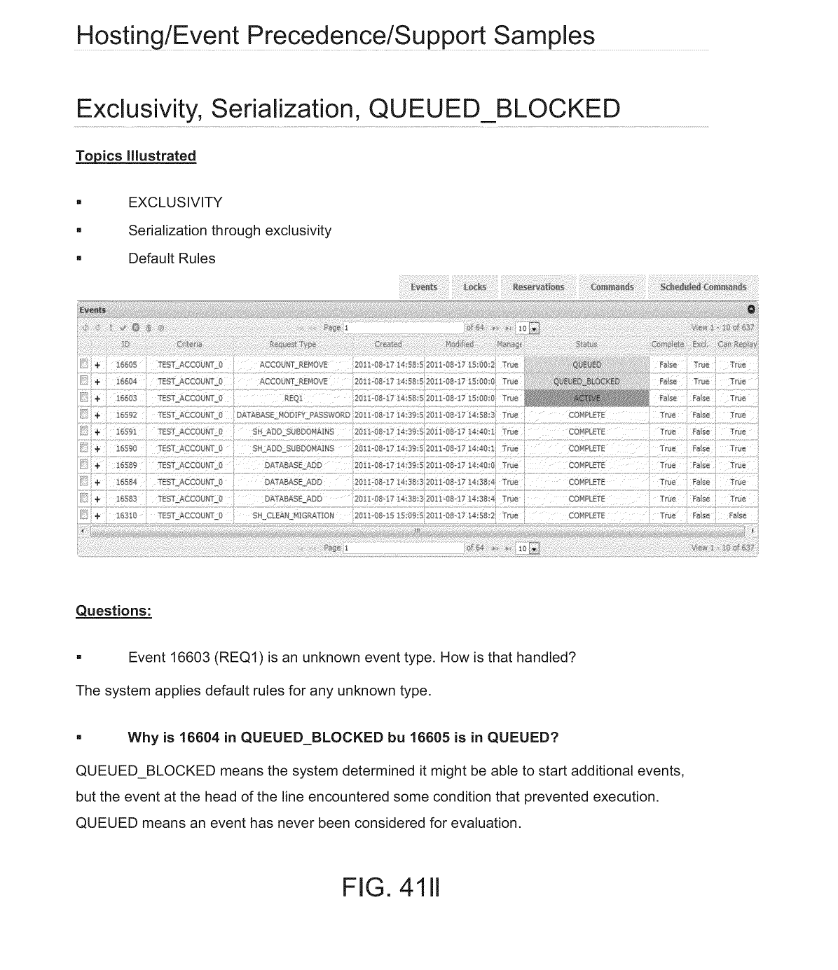

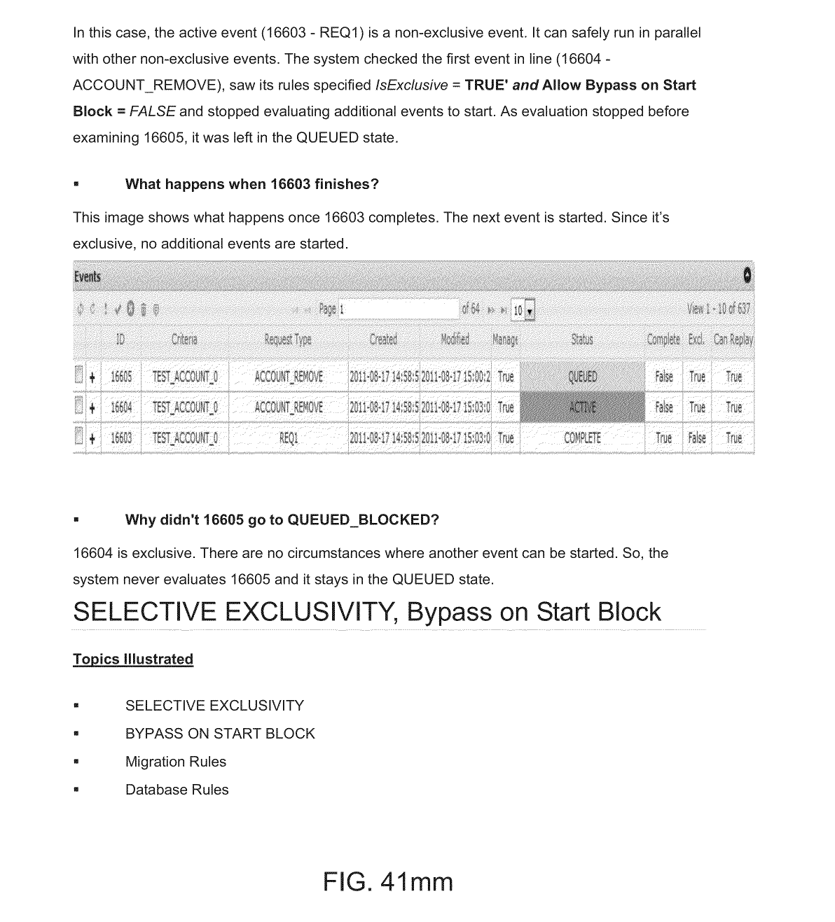

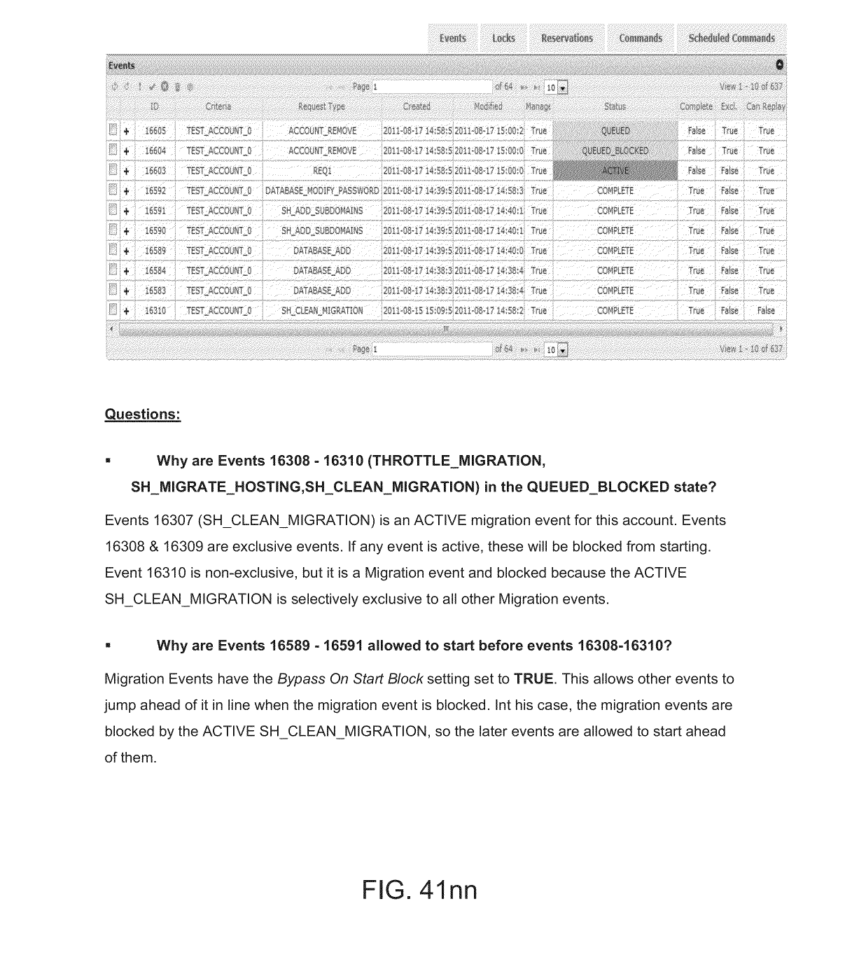

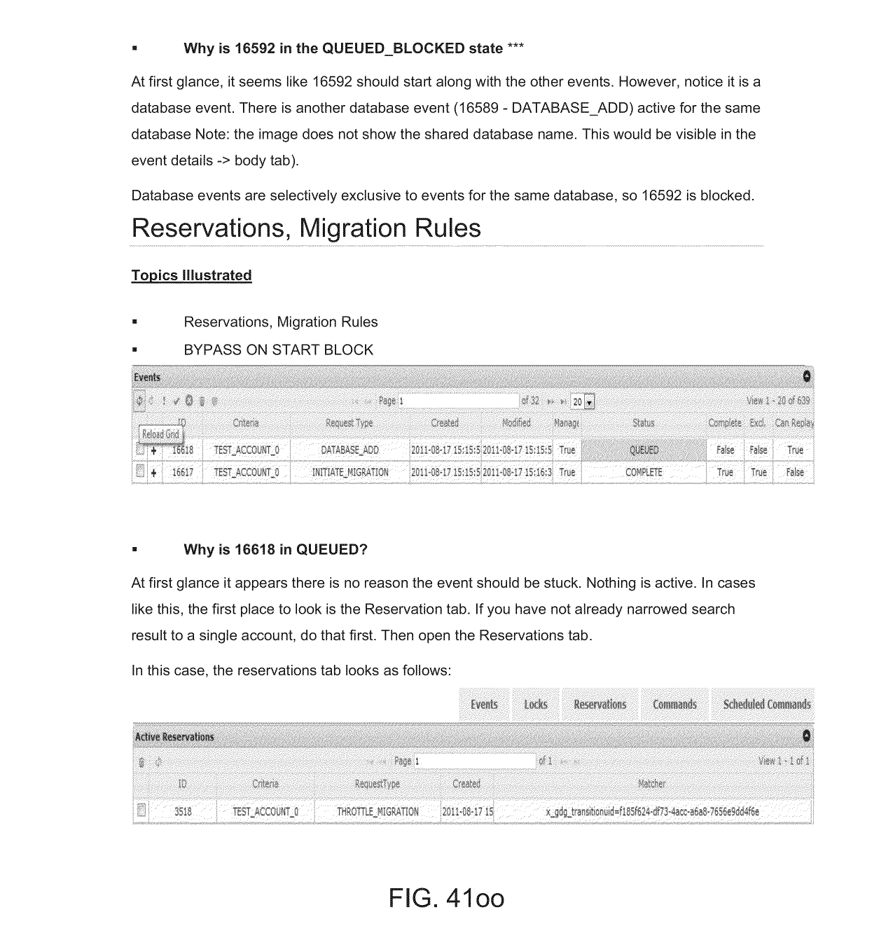

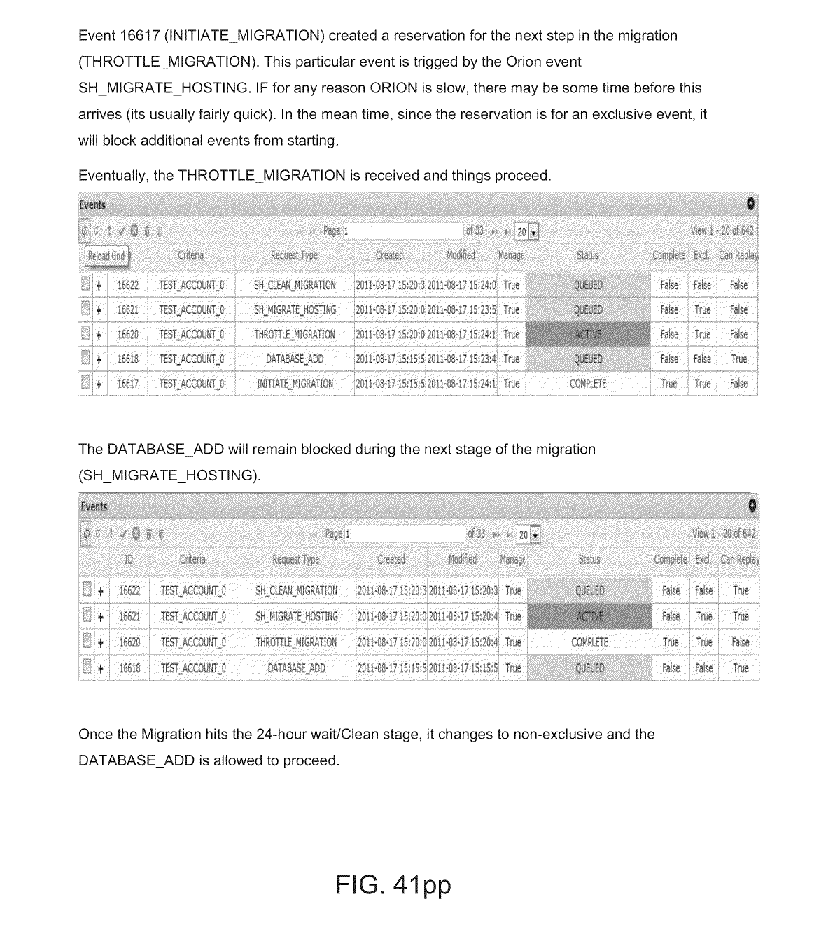

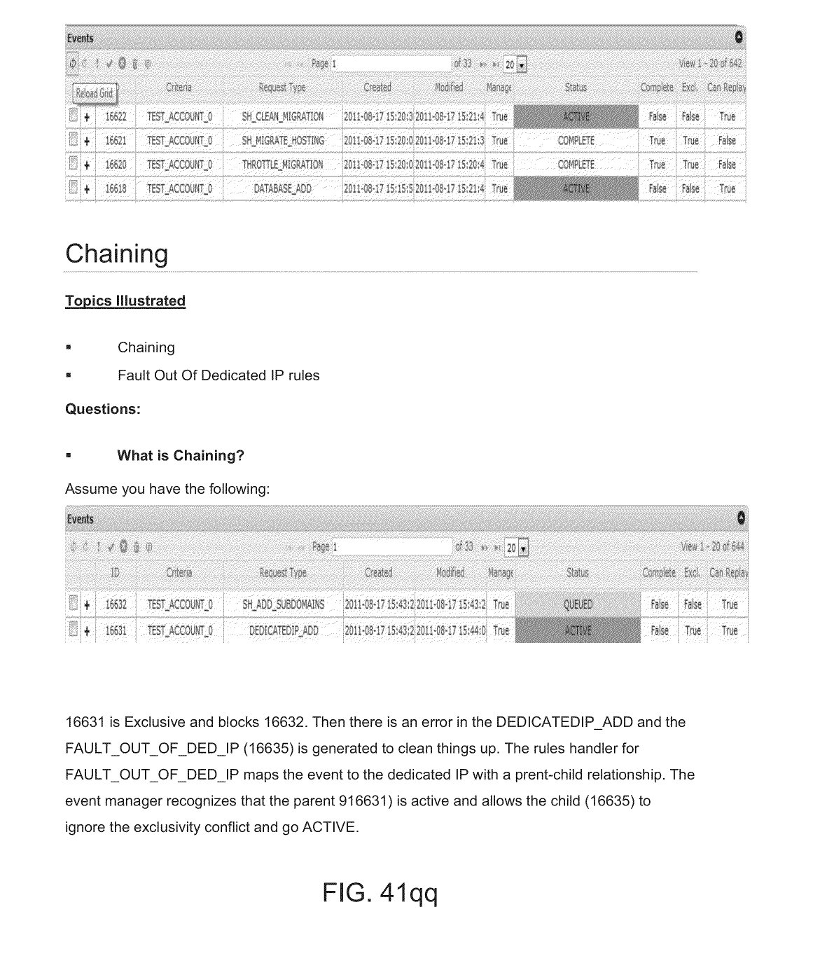

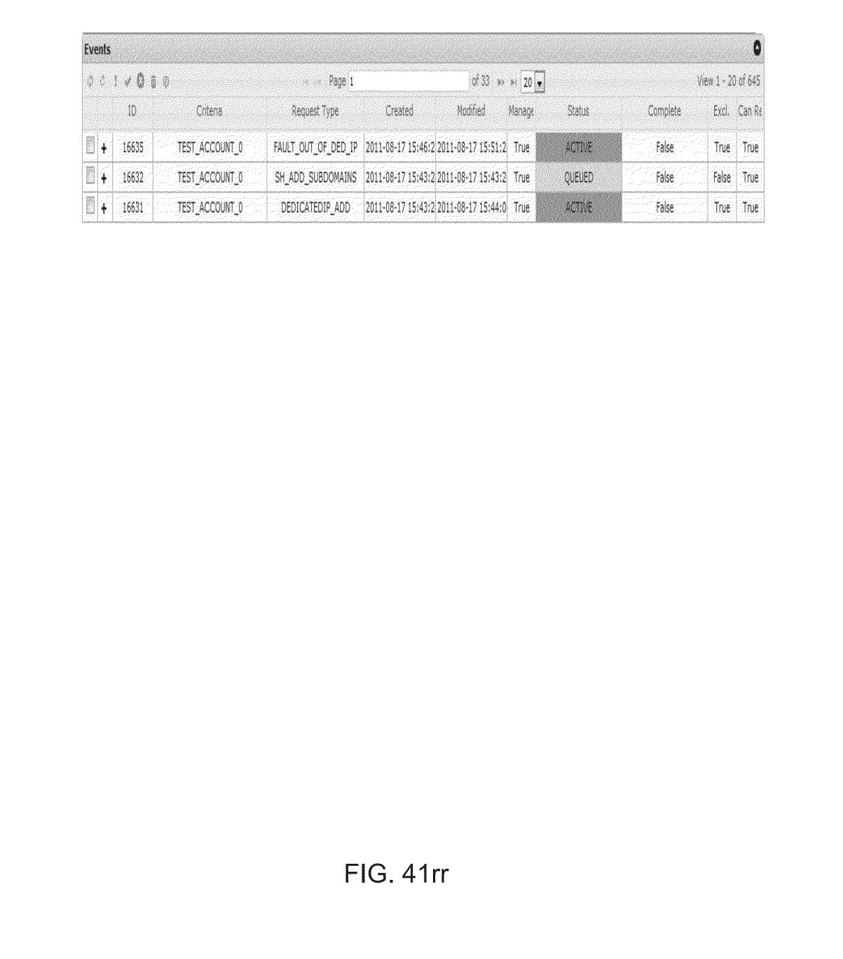

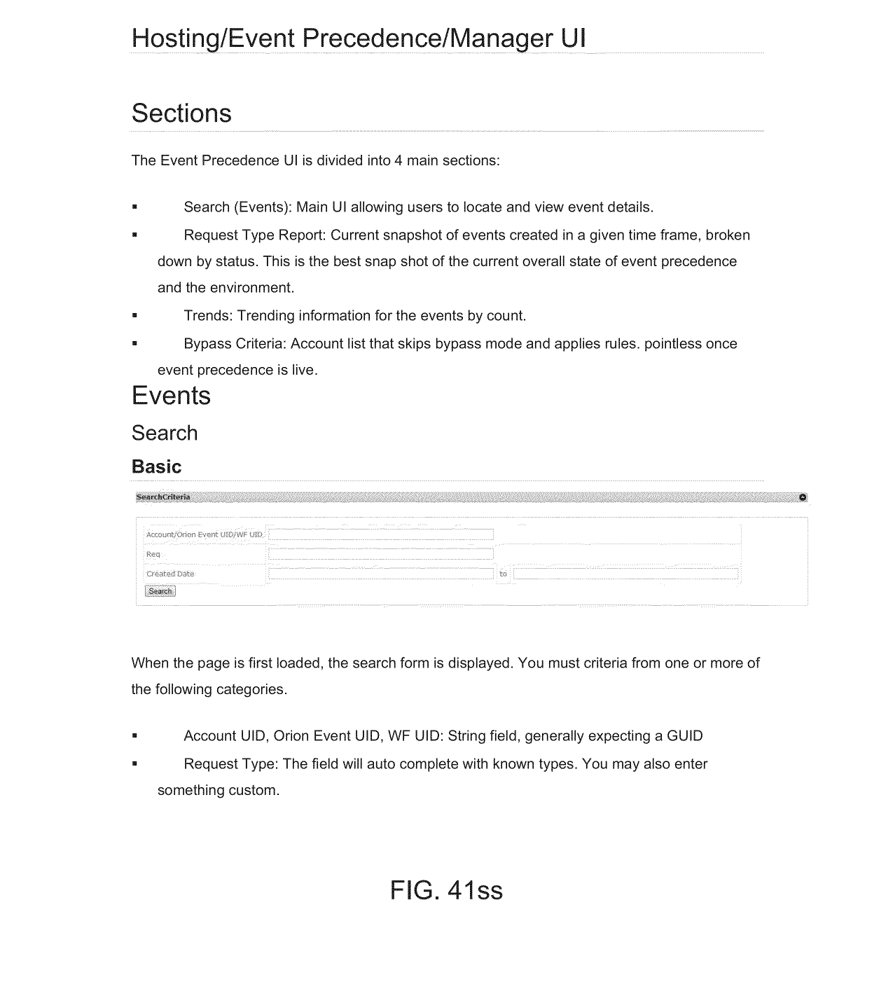

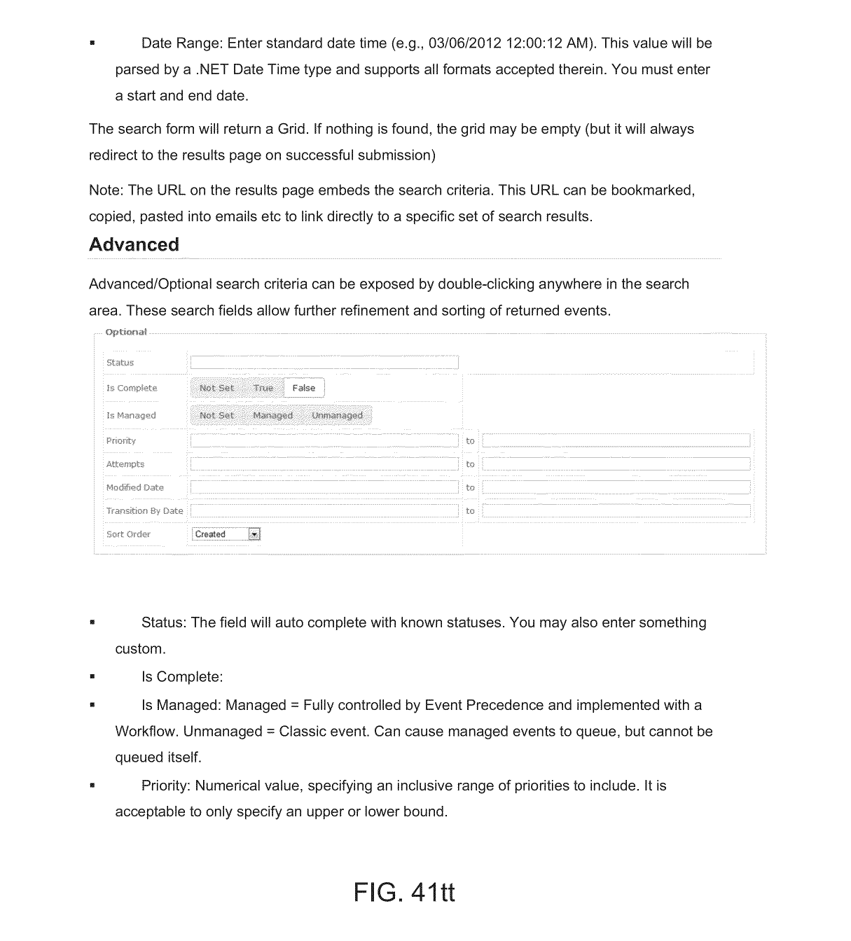

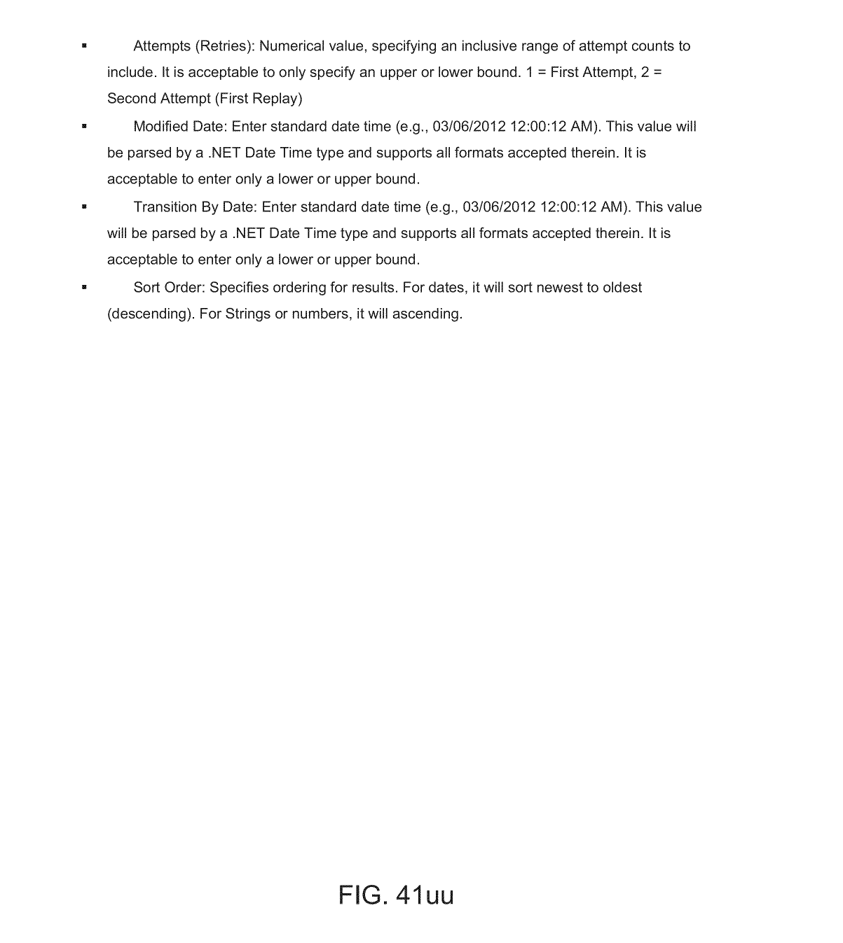

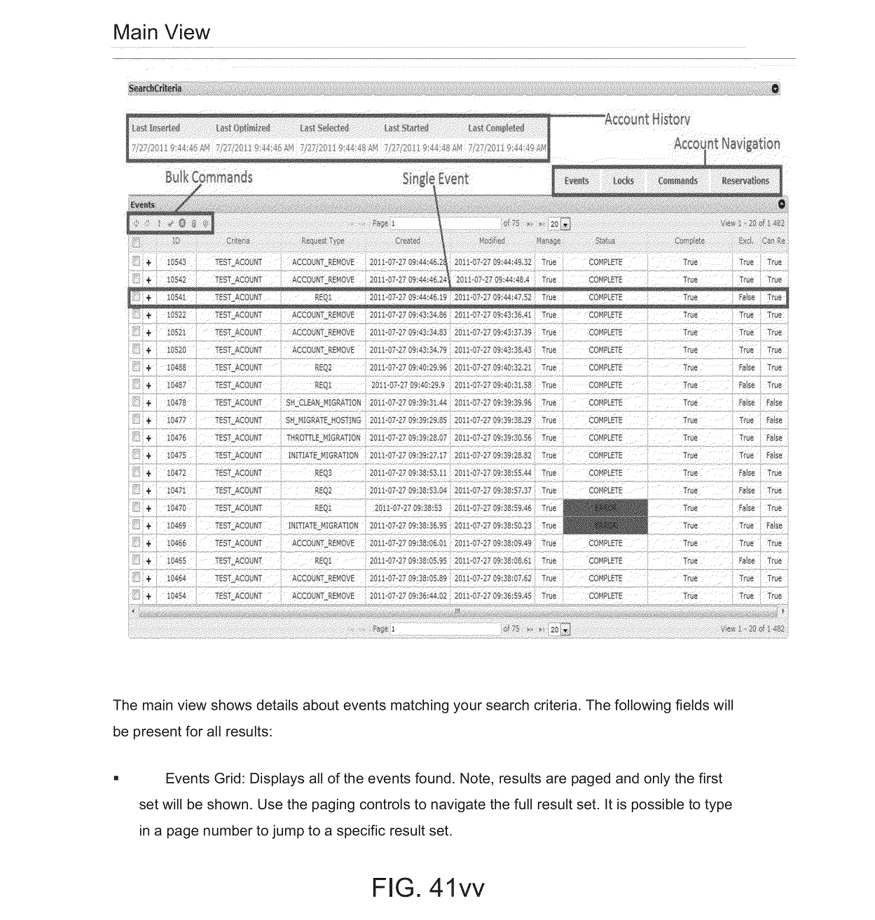

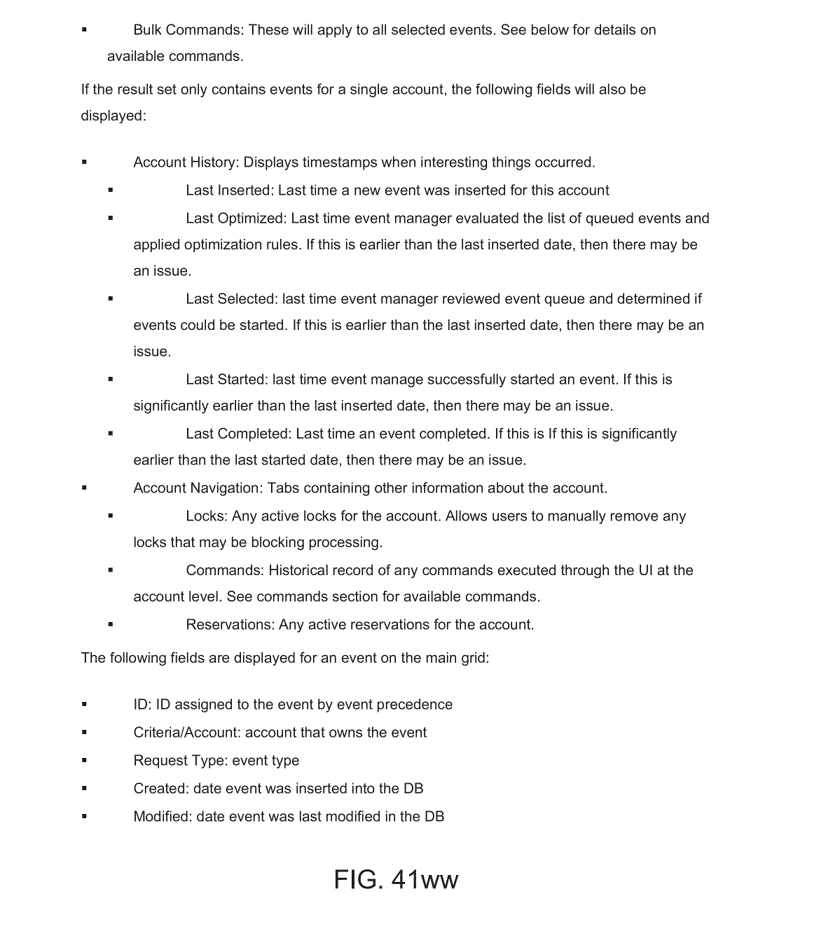

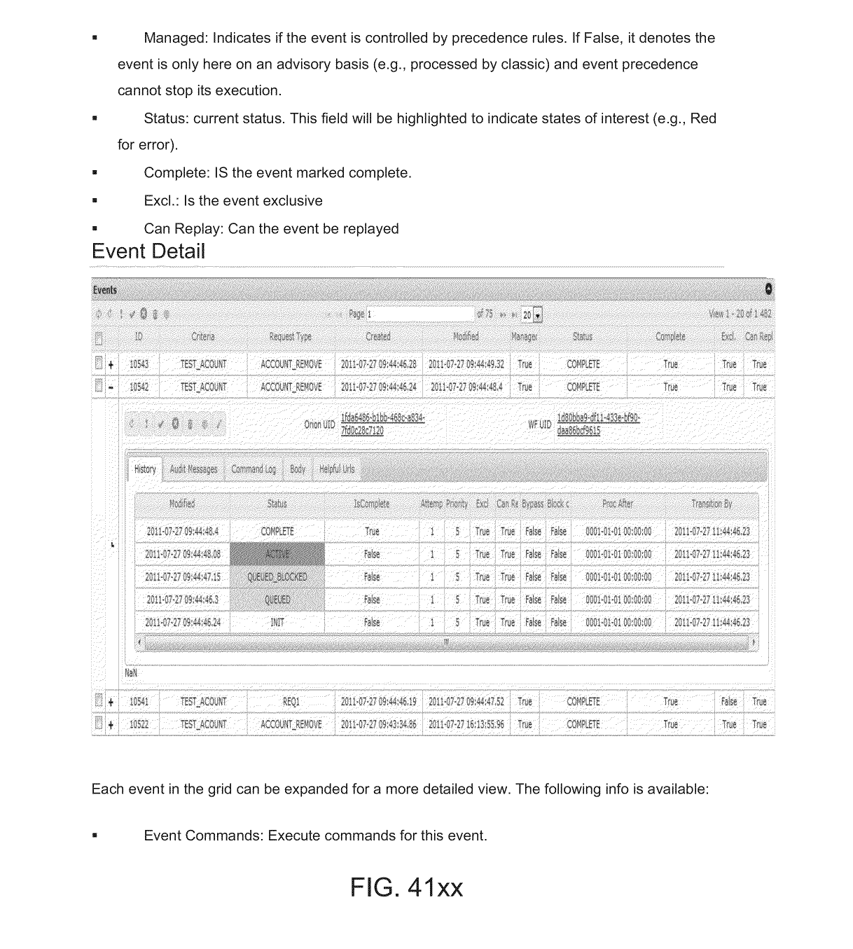

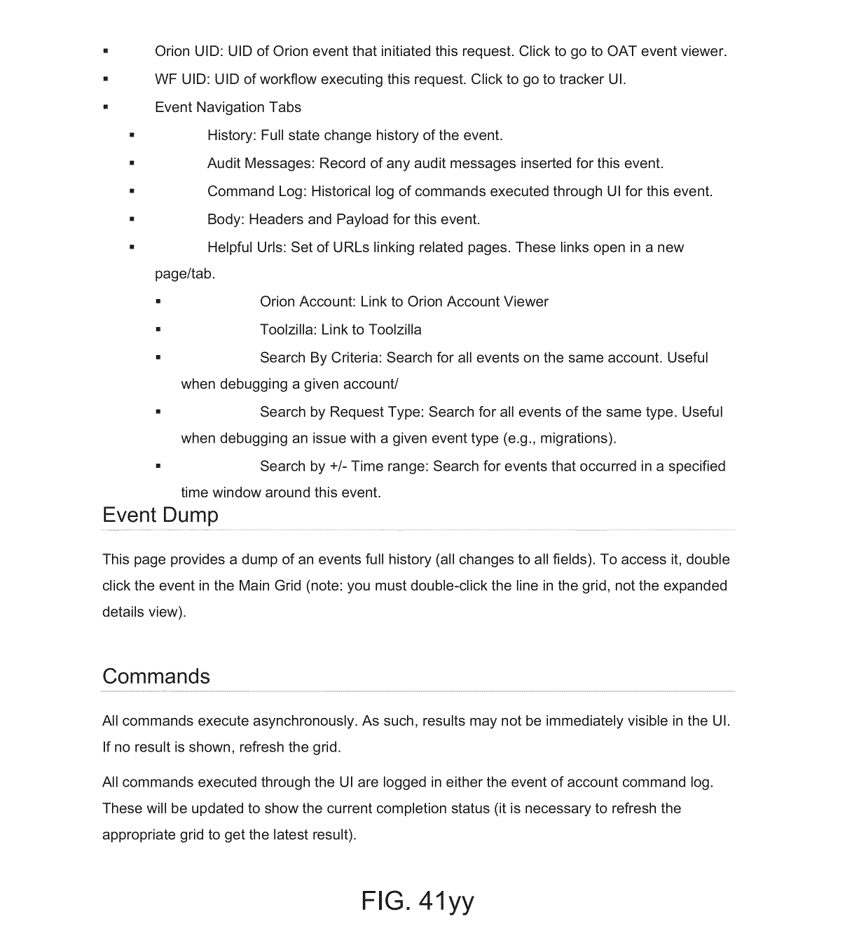

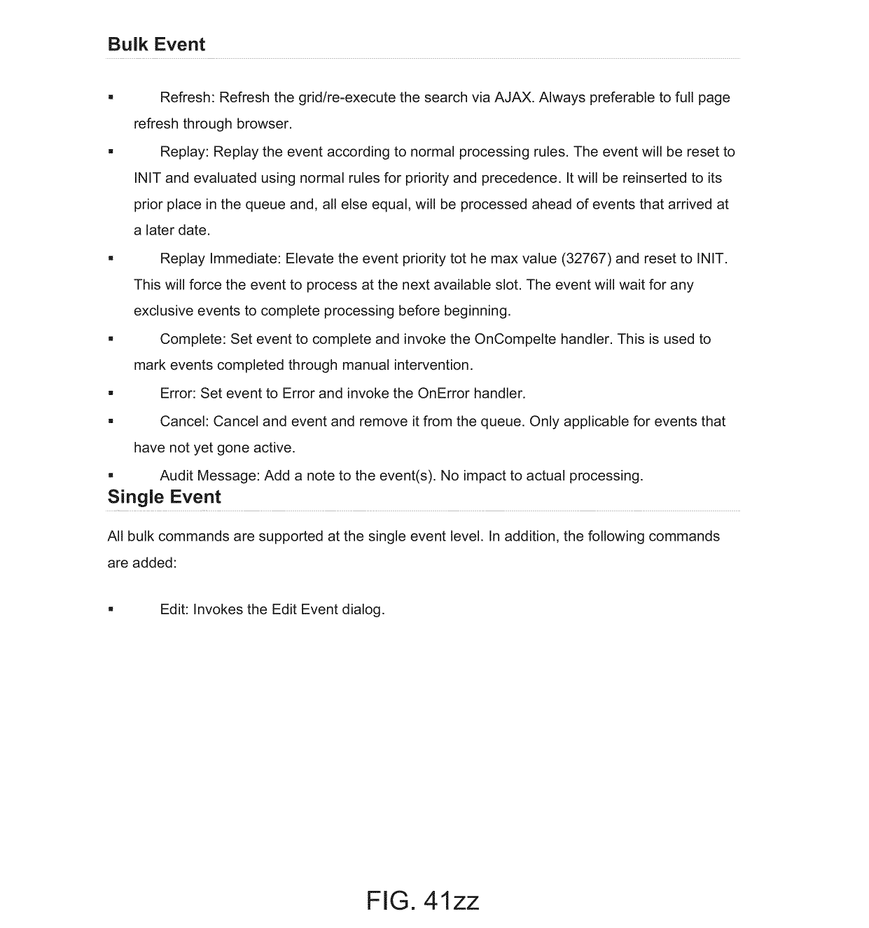

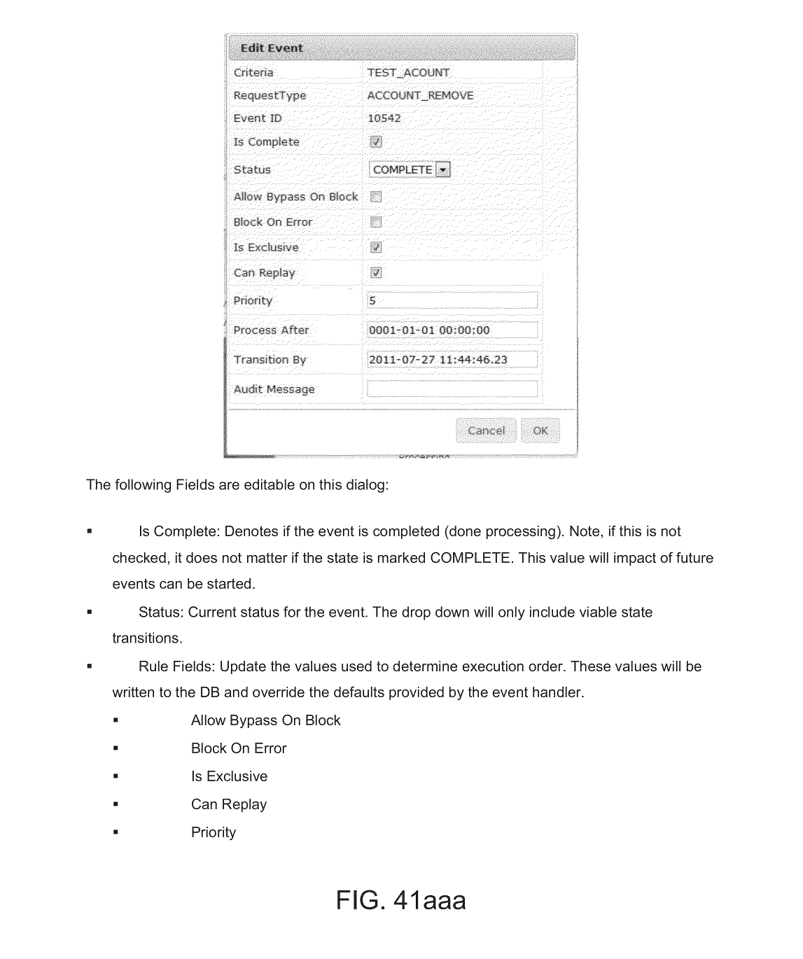

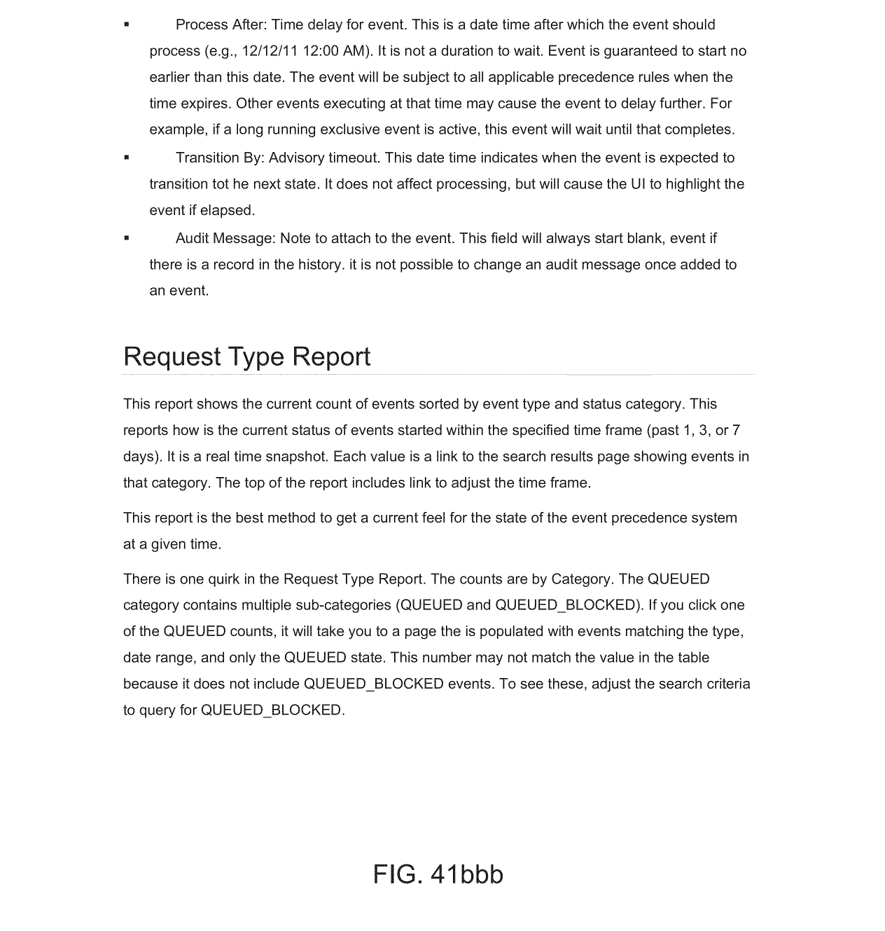

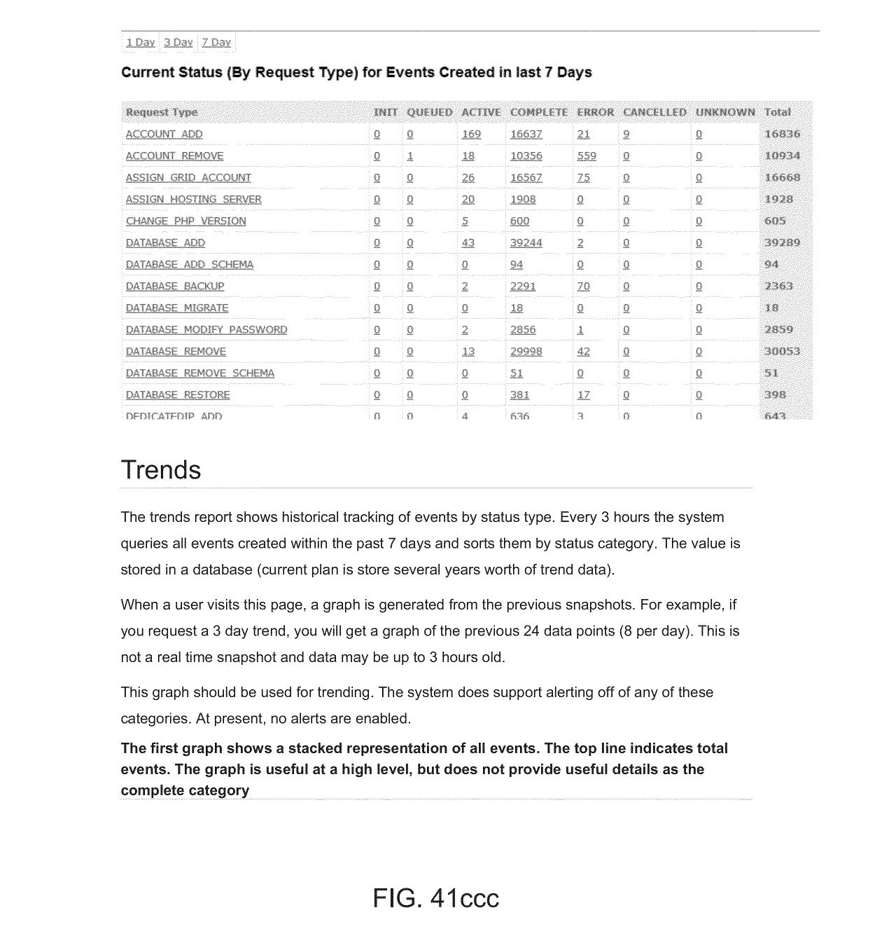

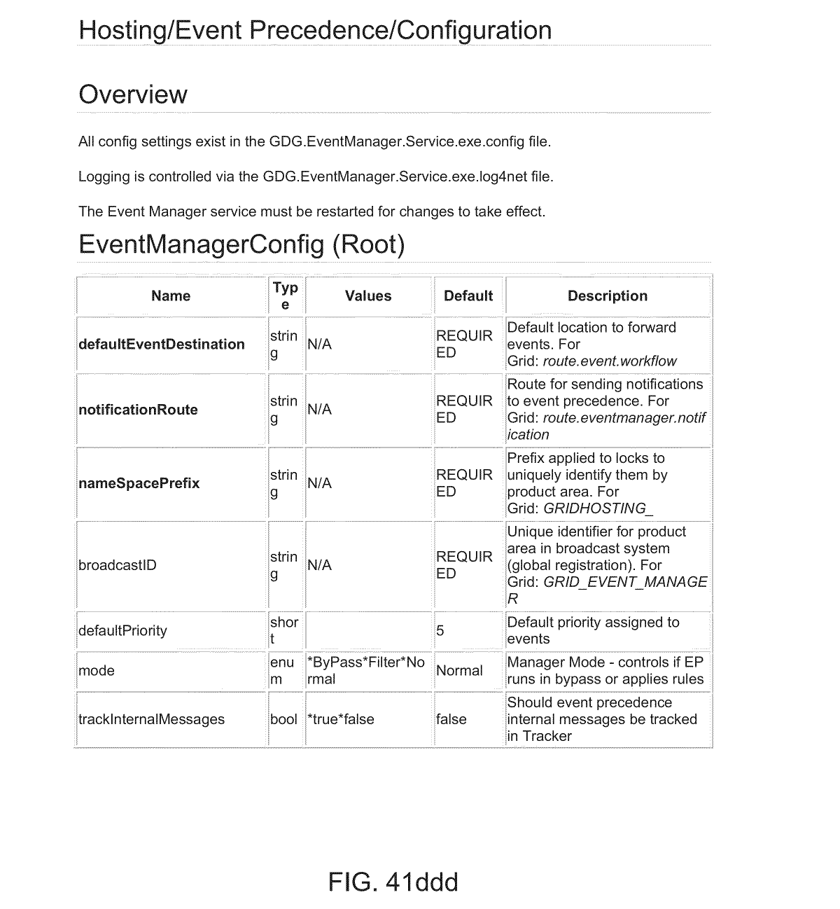

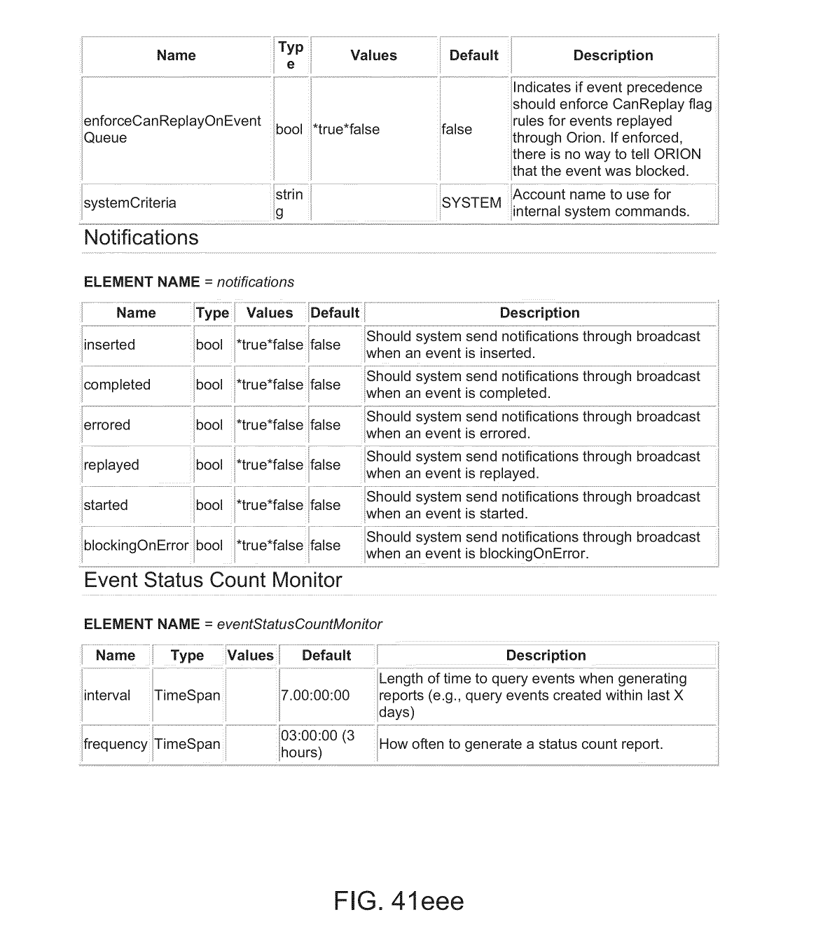

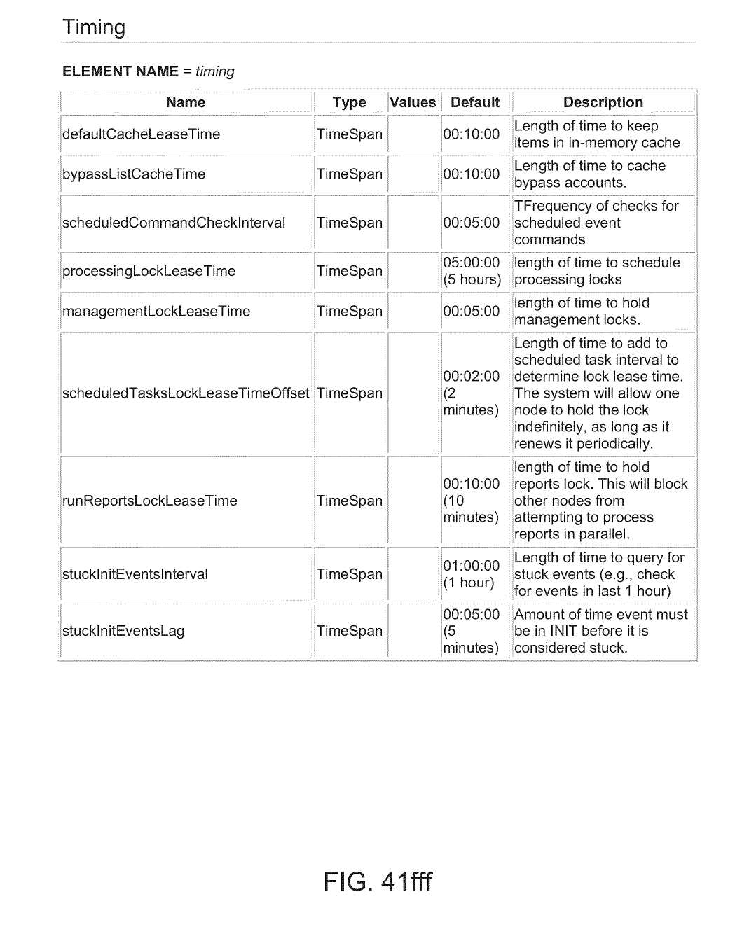

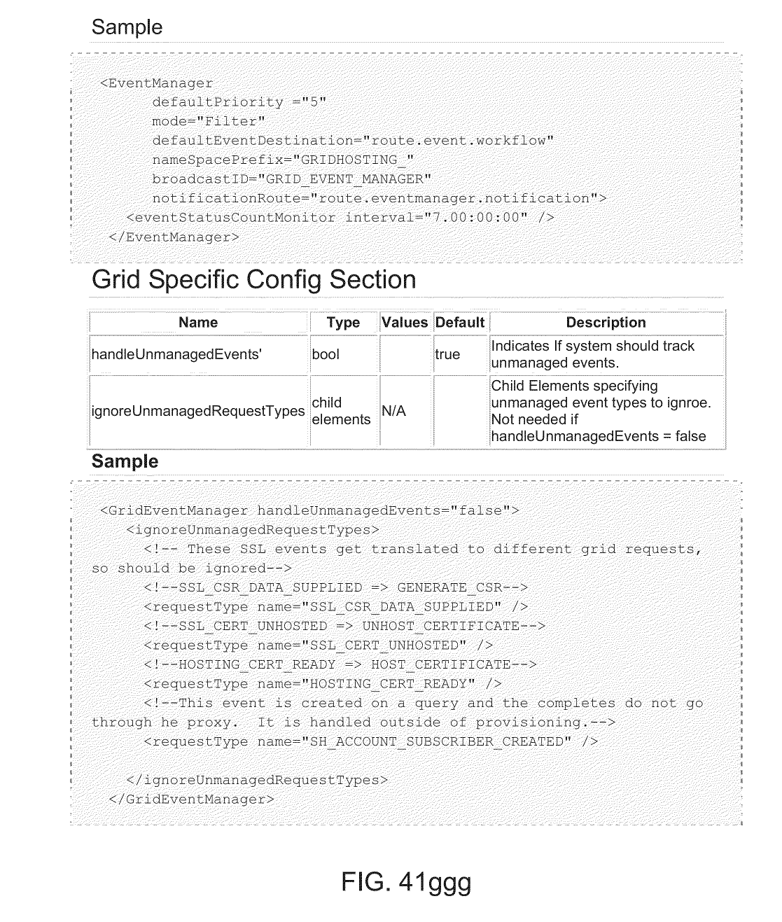

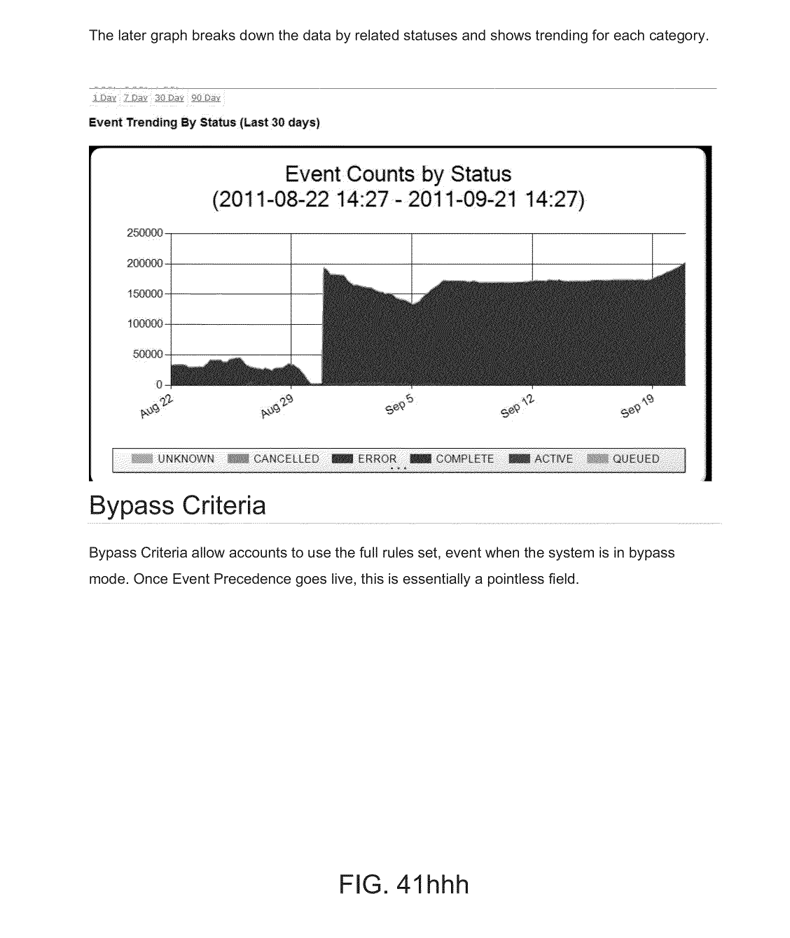

An alternative method for throttling event execution is shown in FIG. 26. The method comprises the steps of: retrieving, on one or more computing devices operated by a hosting provider and connected to a computer network, from an incoming events queue a first set of events for one or more hosting accounts over a time interval t1 (Step 2605), retrieving, on the one or more computing devices operated by the hosting provider and connected to the computer network, from the incoming events queue a second set of events for the one or more hosting accounts over a time interval t2, wherein the time interval t2 is later than the time interval t1 (Step 2610), separating, on the one or more computing devices operated by the hosting provider and connected to the computer network, the first set of events for the one or more hosting accounts into a third set of events and a fourth set of events (Step 2615), entering, on the one or more computing devices operated by the hosting provider and connected to the computer network, the third set of events into an outgoing events queue over a time interval t3 (Step 2620), entering, on the one or more computing devices operated by the hosting provider and connected to the computer network, the second set of events into the outgoing events queue over a time interval t4, wherein the time interval t4 is later than the time interval t3 (Step 2625), and entering, on the one or more computing devices operated by the hosting provider and connected to the computer network, the fourth set of events into the outgoing events queue over a time interval t5, wherein the time interval t5 is later than the time interval t4 (Step 2630).

The invention may be implemented on a variety of computer networks. This may include a LAN (Local Area Network), WLAN (Wireless Local Area Network), WAN (Wide Area Network), MAN (Metropolitan Area Network), a global network, etc. The Internet is a widely-used global computer network. The computer networks may support a variety of a network layer protocols, such as, DHCP (Dynamic Host Configuration Protocol), DVMRP (Distance Vector Multicast Routing Protocol), ICMP/ICMPv6 (Internet Control Message Protocol), IGMP (Internet Group Management Protocol), IP (Internet Protocol version 4), IPv6 (Internet Protocol version 6), MARS (Multicast Address Resolution Server), PIM and PIM-SM (Protocol Independent Multicast-Sparse Mode), RIP2 (Routing Information Protocol), RIPng for IPv6 (Routing Information Protocol for IPv6), RSVP (Resource ReSerVation setup Protocol), VRRP (Virtual Router Redundancy Protocol), etc. Further, the computer networks may support a variety of a transport layer protocols, such as, ISTP (Internet Signaling Transport Protocol), Mobile IP (Mobile IP Protocol), RUDP (Reliable UDP), TALI (Transport Adapter Layer Interface), TCP (Transmission Control Protocol), UDP (User Datagram Protocol), Van Jacobson (compressed TCP), XOT (X.25 over TCP), etc. In addition, the computer network may support a variety of an application layer protocols, such as, COPS (Common Open Policy Service), FANP (Flow Attribute Notification Protocol), Finger (User Information Protocol), FTP (File Transfer Protocol), HTTP (Hypertext Transfer Protocol), IMAP and IMAP4 (Internet Message Access Protocol, rev 4), IMPPpre (Instant Messaging Presence Protocol), IMPPmes (Instant Messaging Protocol), IPDC (IP Device Control), IRC (Internet Relay Chat Protocol), ISAKMP (Internet Message Access Protocol version 4rev1), ISP, NTP (Network Time Protocol), POP and POP3 (Post Office Protocol, version 3), Radius (Remote Authentication Dial In User Service), RLOGIN (Remote Login), RTSP (Real-time Streaming Protocol), SCTP (Stream Control Transmission Protocol), S-HTTP or HTTPS (Secure Hypertext Transfer Protocol), SLP (Service Location Protocol), SMTP (Simple Mail Transfer Protocol), SNMP (Simple Network Management Protocol), SOCKS (Socket Secure Server), TACACS+ (Terminal Access Controller Access Control System), TELNET (TCP/IP Terminal Emulation Protocol), TFTP (Trivial File Transfer Protocol), WCCP (Web Cache Coordination Protocol), X-Window (X Window), etc.

The communication links between the computers on the network may include telephone line, copper twisted pair, power-line, fiber-optic, cellular, satellite, dial-up, Ethernet, DSL, ISDN, T-1, DS-1, Wi-Fi, etc.

A variety of programming languages and scripts may be used to implement the present invention, such as, Java, JavaScript, Perl, PHP, ASP, ASP.NET, Visual J++, J#, C, C++, C#, Visual Basic, VB.Net, VBScript, SQL, etc.

The computers utilized in the present invention may run a variety of operating systems, such as, MICROSOFT WINDOWS, APPLE MAC OS X, UNIX, LINUX, GNU, BSD, FreeBSD, SUN SOLARIS, NOVELL NETWARE, OS/2, TPF, eCS (eComStation), VMS, Digital VMS, OpenVMS, AIX, z/OS, HP-UX, OS-400, etc. The computers utilized in the present invention can be based on a variety of hardware platforms, such as, x86, x64, INTEL, ITANIUM, IA64, AMD, SUN SPARC, IBM, HP, etc.

The databases used in the present invention may include: CLARION, DBASE, ENTERPRISEDB, EXTREMEDB, FILEMAKER PRO, FIREBIRD, FRONTBASE, HELIX, SQLDB, IBM DB2, INFORMIX, INGRES, INTERBASE, MICROSOFT ACCESS, MICROSOFT SQL SERVER, MICROSOFT VISUAL FOXPRO, MSQL, MYSQL, OPENBASE, OPENOFFICE.ORG BASE, ORACLE, PANORAMA, PERVASIVE, POSTGRESQL, SQLBASE, SQLITE, SYBASE, TERADATA, UNISYS, and many others.

A computer listing is submitted to the USPTO with the present specification. The computer listing contains programming scripts and code with the Applicant's best mode implementation of the present invention. In the implementation Applicant uses the term “Orion” to refer to the database containing incoming events (an incoming events queue) and the term “Workflow” (WF) to refer an event consumer or executor.

The means of the embodiments disclosed in the present specification can be substituted with machines, apparatuses, and devices described or listed in this specification or equivalents thereof. As a non-limiting example, the means of the embodiments may be substituted with a computing device, a computer-readable code, a computer-executable code, or any combination thereof.

All embodiments of the present invention may further be limited and implemented with any and all limitations disclosed in this specification or in the documents incorporated in this patent application by reference.

Applicant does not consider any step, element, or limitation being required or essential. The methods and systems of the present invention may be implemented without some of the disclosed steps, elements, or limitations.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. A method for updating events, comprising the steps of:
a) obtaining, on one or more computing devices operated by a hosting provider and connected to a computer network, from one or more event generators a first event for one or more hosting accounts with a first content and a second event for said one or more hosting accounts with a second content,
b) changing, on said one or more computing devices operated by said hosting provider and connected to said computer network, said second content of said second event for said one or more hosting accounts as a function of said first content of said first event for said one or more hosting accounts, and
c) executing, on said one or more computing devices operated by said hosting provider and connected to said computer network, said first event and said second event.

2. A method for updating events, comprising the steps of:
a) retrieving, on one or more computing devices operated by a hosting provider and connected to a computer network, from an incoming events queue a first event for one or more hosting accounts with a first content and a second event for said one or more hosting accounts with a second content,
b) changing, on said one or more computing devices operated by said hosting provider and connected to said computer network, said second content of said second event for said one or more hosting accounts as a function of said first content of said first event for said one or more hosting accounts, and
c) entering, on said one or more computing devices operated by said hosting provider and connected to said computer network, said first event and said second event into an outgoing events queue.

3. A method for consolidating events, comprising the steps of:
a) obtaining, on one or more computing devices operated by a hosting provider and connected to a computer network, from one or more event generators a first event for one or more hosting accounts with a first content and a second event for said one or more hosting accounts with a second content,
b) consolidating, on said one or more computing devices operated by said hosting provider and connected to said computer network, said second content of said second event for said one or more hosting accounts and said first content of said first event for said one or more hosting accounts into a third content,
c) replacing, on said one or more computing devices operated by said hosting provider and connected to said computer network, said first content with said third content in said first event, and
d) executing, on said one or more computing devices operated by said hosting provider and connected to said computer network, said first event with said third content.

4. A method for consolidating events, comprising the steps of:
a) retrieving, on one or more computing devices operated by a hosting provider and connected to a computer network, from an incoming events queue a first event for one or more hosting accounts with a first content and a second event for said one or more hosting accounts with a second content,
b) consolidating, on said one or more computing devices operated by said hosting provider and connected to said computer network, said second content of said second event for said one or more hosting accounts and said first content of said first event for said one or more hosting accounts into a third content,
c) replacing, on said one or more computing devices operated by said hosting provider and connected to said computer network, said first content with said third content in said first event, and
d) entering, on said one or more computing devices operated by said hosting provider and connected to said computer network, said first event with said third content into an outgoing events queue.
